(19) United States
(12) Patent Application Publication
(10) Pub. No.: US 2025/0010202 A1
(43) Pub. Date: Jan. 9, 2025

(54) NON-TRANSITORY COMPUTER READABLE MEDIUM, INFORMATION PROCESSING METHOD, AND INFORMATION PROCESSING SYSTEM

(71) Applicant: SYGAMES, INC., Tokyo (JP)

(72) Inventors: Toshio Kuroda, Tokyo (JP); Mitsuharu Isojima, Tokyo (JP); Reo Takahashi, Tokyo (JP)

(73) Assignee: SYGAMES, INC., Tokyo (JP)

(21) Appl. No.: 18/896,474

(22) Filed: Sep. 25, 2024

Related U.S. Application Data
(63) Continuation of application No. PCT/JP2023/012175, filed on Mar. 27, 2023.

(30) Foreign Application Priority Data
Mar. 29, 2022 (JP) 2022-053832

(51) Int. Cl. A63F 13/69

(52) U.S. Cl. CPC A63F 13/69

(57) ABSTRACT

A non-transitory computer readable medium stores a program causing a computer to execute: a process for tying possession information to a game medium that satisfies a possession condition, among at least one game medium for use in a predetermined game; a process for executing a target game in which any of the at least one game medium is set as a specific game medium; a process for extracting, as at least one target game medium, a game medium that is set as the specific game medium in the target game and to which the possession information is tied; a process for deciding an applicable effect value on the basis of the at least one extracted target game medium; and a process for granting a reward to a player on the basis of the applicable effect value when the target game is executed.

### CROSS REFERENCE TO RELATED APPLICATIONS

This application is a continuation application of International Application No. PCT/JP2023/012175, filed on Mar. 27, 2023, which claims priority to Japanese Patent Application No. 2022-053832, filed on Mar. 29, 2022, the entire contents of which are incorporated by reference herein.

### BACKGROUND ART

### Technical Field

The present invention relates to an information processing program, an information processing method, and an information processing system.

Nurturing games indicated in, for example, Non-Patent Literature 1 are well known. In a nurturing game, it is possible to nurture a nurturing-target character selected by a player. The player can also organize support cards into a deck at the time the nurturing game is started. The player can advantageously proceed with the nurturing of the nurturing-target character due to the support cards organized in the deck.

Furthermore, a time-limited event is held in the nurturing game disclosed in Non-Patent Literature 1. While an event is being held, the player can earn event points by playing a nurturing game. Depending on the cumulative total value of the earned event points, rewards, such as items, are granted to the player.

Also, a plurality of characters are set as special effectiveness characters in the event. In the case where the nurturing-target character and a support card organized in the deck correspond to special effectiveness characters, bonus points are calculated. Due to bonus points, the event points granted to the player in one nurturing game are increased.

### CITATION LIST

### Non-Patent Literature

Non-Patent Literature 1: Full-force strategies for non-paying game players [retrieved on 25 Mar. 2022], Internet <URL: http://www.mukakin-blog.com/article/485719755.html>

### SUMMARY OF INVENTION

### Technical Problem

In the aforementioned nurturing game, while an event is being held, the player needs to organize many special effectiveness characters into the deck in order to earn a larger number of event points in a short period of time. This leads to a problem in that the player's range of choices is narrowed and the player is thus discouraged from playing the game.

An object of the present invention is to provide an information processing program, an information processing method, and an information processing system capable of further encouraging a player to play a game.

### Solution to Problem

In order to solve the aforementioned problem, an information processing program causes a computer to execute:
a process for tying possession information to a game medium that satisfies a possession condition set in advance, among at least one game medium for use in a predetermined game;
a process for executing a target game in which any of the at least one game medium is set as a specific game medium;
a process for extracting, as at least one target game medium, the game medium that is set as the specific game medium in the target game and to which the possession information is tied;
a process for deciding an applicable effect value on the basis of the at least one extracted target game medium; and
a process for granting a reward to a player on the basis of the applicable effect value when the target game is executed.

In the process for deciding an applicable effect value, an effect value may be identified for each of the at least one target game medium, and the applicable effect value may be decided on the basis of the effect value identified for each of the at least one target game medium.

The target game may be the predetermined game that uses the at least one game medium, the at least one game medium may be classified as any one of a plurality of types including a first type and a second type, and the process for executing a target game may include a process for setting, on the basis of a player operation, a game medium of each of the first type and the second type used in the target game and a process for proceeding with the target game on the basis of the set game medium of each of the first type and the second type.

In order to solve the aforementioned problem, an information processing method is executed by at least one computer that executes:
a process for tying possession information to a game medium that satisfies a possession condition set in advance, among at least one game medium for use in a predetermined game;
a process for executing a target game in which any of the at least one game medium is set as a specific game medium;
a process for extracting, as at least one target game medium, the game medium that is set as the specific game medium in the target game and to which the possession information is tied;
a process for deciding an applicable effect value on the basis of the at least one extracted target game medium; and
a process for granting a reward to a player on the basis of the applicable effect value when the target game is executed.

In order to solve the aforementioned problem, an information processing system comprises at least one computer that executes:
a process for tying possession information to a game medium that satisfies a possession condition set in advance, among at least one game medium for use in a predetermined game;
a process for executing a target game in which any of the at least one game medium is set as a specific game medium;
a process for extracting, as at least one target game medium, the game medium that is set as the specific game medium in the target game and to which the possession information is tied;
a process for deciding an applicable effect value on the basis of the at least one extracted target game medium; and
a process for granting a reward to a player on the basis of the applicable effect value when the target game is executed.

### Effects of Disclosure

According to the present invention, it is possible to further encourage a player to play a game.

### BRIEF DESCRIPTION OF DRAWINGS

FIG. 1 is an illustration showing the schematic configuration of an information processing system.

FIG. 2A is a drawing for illustrating the hardware configuration of a player terminal. FIG. 2B is a drawing for illustrating the hardware configuration of a server.

FIG. 3A is a drawing for illustrating an example of a home screen. FIG. 3B is a drawing for illustrating an example of an option setting screen. FIG. 3C is a drawing for illustrating an example of a profile setting screen. FIG. 3D is a drawing for illustrating an example of a home setting screen.

FIG. 4 is a drawing for illustrating a general flow of proceeding of a nurturing game.

FIG. 5A is a drawing for illustrating a nurturing-target-character selection screen. FIG. 5B is a first drawing for illustrating a character details screen. FIG. 5C is a second drawing for illustrating the character details screen.

FIG. 6A is a drawing for illustrating an ability parameter (initial value) table. FIG. 6B is a drawing for illustrating an aptitude parameter (initial value) table.

FIG. 6C is a drawing for illustrating a skill table. FIG. 6D is a drawing for illustrating a character-possessed-event table.

FIG. 7A is a first drawing for illustrating an inheritance character selection screen. FIG. 7B is a first drawing for illustrating a nurtured character list screen.

FIG. 7C is a second drawing for illustrating the inheritance character selection screen. FIG. 7D is a third drawing for illustrating the inheritance character selection screen.

FIG. 8 is a drawing for illustrating an inheritance line of descent.

FIG. 9 is a drawing for illustrating factor information.

FIG. 10A is a drawing for illustrating compatibility determination combinations, and FIG. 10B is a drawing for illustrating compatibility determination features.

FIG. 11A is a drawing for illustrating sort conditions.

FIG. 11B is a drawing for illustrating refining conditions.

FIG. 12 is a first drawing for illustrating a character details dialog.

FIG. 13 is a second drawing for illustrating the character details dialog.

FIG. 14 is a third drawing for illustrating the character details dialog.

FIG. 15 is a drawing for illustrating a skill display dialog.

FIG. 16A is a first drawing for illustrating a support card organization screen. FIG. 16B is a drawing for illustrating a support card selection screen. FIG. 16C is a second drawing for illustrating the support card organization screen.

FIG. 17A is a drawing for illustrating a support card table. FIG. 17B is a drawing for illustrating a support effect table. FIG. 17C is a drawing for illustrating a possessed skill table. FIG. 17D is a drawing for illustrating a support event table.

FIG. 18A is a drawing for illustrating a final confirmation screen. FIG. 18B is a drawing for illustrating a preset selection screen.

FIG. 19 is a drawing for illustrating an elective table.

FIG. 20A is a drawing for illustrating a game screen.

FIG. 20B is a drawing for illustrating a special race screen.

FIG. 21A is a first drawing for illustrating a training screen.

FIG. 21B is a second drawing for illustrating the training screen.

FIG. 21C is a drawing for illustrating a training result report screen.

FIG. 21D is a drawing for illustrating an event screen.

FIG. 22A is a first drawing for illustrating an inheritance event. FIG. 22B is a second drawing for illustrating the inheritance event. FIG. 22C is a third drawing for illustrating the inheritance event. FIG. 22D is a fourth drawing for illustrating the inheritance event.

FIG. 23A is a first drawing for illustrating a skill screen.

FIG. 23B is a second drawing for illustrating the skill screen.

FIG. 24A is a first drawing for illustrating a going-out screen.

FIG. 24B is a drawing for illustrating a friend going-out event screen.

FIG. 25 is a drawing for illustrating execution patterns of a friend going-out event.

FIG. 26A is a second drawing for illustrating the going-out screen.

FIG. 26B is a third drawing for illustrating the going-out screen.

FIG. 26C is a fourth drawing for illustrating the going-out screen.

FIG. 27A is a first drawing for illustrating a belonging-character-specific event screen.

FIG. 27B is a second drawing for illustrating the belonging-character-specific event screen.

FIG. 27C is a first drawing for illustrating an all-belonging-character event screen.

FIG. 27D is a second drawing for illustrating the all-belonging-character event screen.

FIG. 28 is a drawing for illustrating execution patterns of belonging-character-specific events and an all-belonging-character event.

FIG. 29A is a first drawing for illustrating an individual race selection screen.

FIG. 29B is a drawing for illustrating an individual race start screen.

FIG. 29C is a first drawing for illustrating an individual race result screen.

FIG. 29D is a second drawing for illustrating the individual race result screen.

FIG. 30 is a drawing for illustrating an example of an item exchange screen.

FIG. 31 is a drawing for illustrating the general flow of a turn-at-start process.

FIG. 32 is a drawing for illustrating a placement probability table.

FIG. 33A is a drawing for illustrating a training level table.

FIG. 33B is a drawing for illustrating an increase-fixed value (speed) table.

FIG. 33C is a drawing for illustrating an increase-fixed value table (power).

FIG. 33D is a drawing for illustrating bonus addition rates.

FIG. 34 is a drawing for illustrating a second event table.

FIG. 35 is a drawing for illustrating events tied to a group support card.

FIG. 36 is a drawing for illustrating a privilege zone.

FIG. 37A is a drawing for illustrating a placement character icon of a group support card.

FIG. 37B is a drawing for illustrating a privilege presentation.

FIG. 38 is a drawing for illustrating a placement probability table.

FIG. 39A is a drawing for illustrating the reporting of placement of a rival character on the game screen.

FIG. 39B is a drawing for illustrating the reporting of placement of a rival character on the individual race selection screen.

FIG. 40A is a first drawing for illustrating a nurturing completion screen.

FIG. 40B is a second drawing for illustrating the nurturing completion screen.

FIG. 40C is a third drawing for illustrating the nurturing completion screen.

FIG. 41 is a drawing for illustrating special effectiveness information.

FIG. 42 is a drawing for illustrating character cards.

FIG. 43 is a drawing for illustrating support cards.

FIG. 44 is a drawing for illustrating effect values set for character cards.

FIG. 45 is a drawing for illustrating effect values set for support cards.

FIG. 46 is a drawing for illustrating a method for identifying effect values.

FIG. 47A is a first drawing for illustrating a final confirmation screen while a time-limited event is being held.

FIG. 47B is a second drawing for illustrating a final confirmation screen while a time-limited event is being held.

FIG. 48 is a drawing for illustrating a bonus points details screen.

FIG. 49 is a drawing for illustrating the configuration of a memory in the player terminal and functions of the player terminal as a computer.

FIG. 50 is a drawing for illustrating the configuration of a memory in the server and functions of the server as a computer.

FIG. 51 is a sequence diagram for illustrating processes of the player terminal and the server related to a nurturing game.

FIG. 52 is a first flowchart for illustrating a preparatory-stage process at the player terminal.

FIG. 53 is a second flowchart for illustrating the preparatory-stage process at the player terminal.

FIG. 54 is a flowchart for illustrating a final confirmation screen display process at the player terminal.

FIG. 55 is a third flowchart for illustrating the preparatory-stage process at the player terminal.

FIG. 56 is a flowchart for illustrating a nurturing-stage process at the server.

FIG. 57 is a flowchart for illustrating the turn-at-start process at the server.

FIG. 58 is a flowchart for illustrating a friendship training determination process at the server.

FIG. 59 is a flowchart for illustrating the nurturing-stage process at the player terminal.

FIG. 60 is a flowchart for illustrating the turn-at-start process at the player terminal.

FIG. 61 is a flowchart for illustrating the in-turn process at the server.

FIG. 62 is a flowchart for illustrating a going-out selection process at the server.

FIG. 63 is a flowchart for illustrating a going-out-related event execution process at the server.

FIG. 64 is a flowchart for illustrating a privilege zone setting process at the server.

FIG. 65 is a flowchart for illustrating the in-turn process at the player terminal.

FIG. 66 is a flowchart for illustrating a nurturing game end process at the server.

### DESCRIPTION OF EMBODIMENTS

An aspect of an embodiment of the present invention will be described below in detail with reference to the accompanying drawings. Numerical values, etc. given in this embodiment are merely examples for facilitating understanding, and do not limit the present invention unless otherwise specifically mentioned. In this description and the drawings, the same reference signs are attached to elements having substantially the same functions and configurations, omitting repeated descriptions thereof, and elements that are not directly related to the present invention are not shown.

### (Overall Configuration of Information Processing System S)

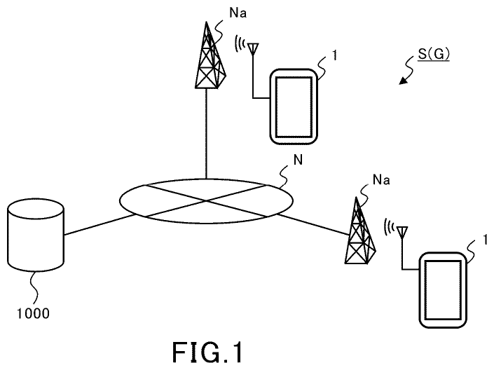

FIG. 1 is an illustration showing the schematic configuration of an information processing system S. The information processing system S is what is called a client-server system, including player terminals 1 functioning as clients (i.e., game terminals), a server 1000, and a communication network N having communication base stations Na.

In the information processing system S according to this embodiment, the player terminals 1 and the server 1000 each function as a game device G. The player terminals 1 and the server 1000 individually have assigned thereto roles for controlling the proceeding of the game such that it is possible to proceed with the game through cooperation between the player terminals 1 and the server 1000.

Each of the player terminals 1 can establish communication with the server 1000 via the communication network N. The player terminals 1 widely include electronic appliances that can be communicatively connected to the server 1000 by wire or wirelessly. Examples of the player terminals 1 include smartphones, mobile phones, tablet devices, personal computers, and game devices. This embodiment will be described by way of an example where each of the player terminals 1 is a smartphone.

The server 1000 is communicatively connected to the plurality of player terminals 1. The server 1000 accumulates various kinds of information for each player who plays a game. Furthermore, mainly on the basis of operations input from the player terminals 1, the server 1000 executes processes, such as updating the accumulated information and causing the player terminals 1 to download images and various kinds of information.

The communication base stations Na are connected to the communication network N, and transmit information to and receive information from the player terminals 1 wirelessly. The communication network N is configured of a mobile phone network, the Internet, a local area network (LAN), a dedicated circuit, or the like, and realizes wired or wireless communicative connection between the player terminals 1 and the server 1000.

### (Hardware Configuration of Player Terminal 1 and Server 1000)

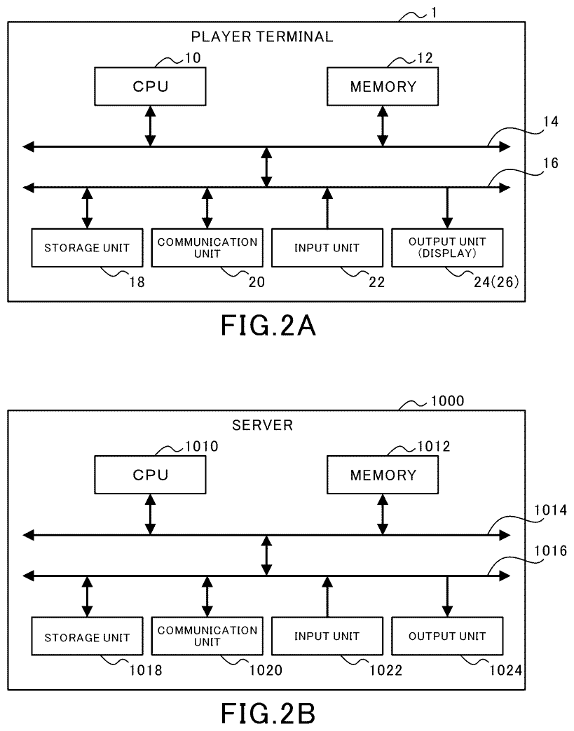

FIG. 2A is a drawing for illustrating the hardware configuration of a player terminal 1. In addition, FIG. 2B is a drawing for illustrating the hardware configuration of the server 1000. As shown in FIG. 2A, the player terminal 1 is configured to include a central processing unit (CPU) 10, a memory 12, a bus 14, an input/output interface 16, a storage unit 18, a communication unit 20, an input unit 22, and an output unit 24.

Furthermore, as shown in FIG. 2B, the server 1000 is configured to include a CPU 1010, a memory 1012, a bus 1014, an input/output interface 1016, a storage unit 1018, a communication unit 1020, an input unit 1022, and an output unit 1024.

Note that the configurations and functions of the CPU 1010, the memory 1012, the bus 1014, the input/output interface 1016, the storage unit 1018, the communication unit 1020, the input unit 1022, and the output unit 1024 of the server 1000 are substantially the same as those of the CPU 10, the memory 12, the bus 14, the input/output interface 16, the storage unit 18, the communication unit 20, the input unit 22, and the output unit 24, respectively, of the player terminal 1. Thus, a description of the hardware configuration of the player terminal 1 will be given below, and a description of the server 1000 will be omitted.

The CPU 10 runs programs stored in the memory 12 to control the proceeding of the game. The memory 12 is configured of a read only memory (ROM) or a random access memory (RAM), and stores the programs and various kinds of data needed for controlling the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory, such as a dynamic random access memory (DRAM), and stores various kinds of programs and data. At the player terminal 1, the programs and data stored in the storage unit 18 are loaded into the memory 12 (RAM) by the CPU 10.

The communication unit 20 is communicatively connected to a communication base station Na wirelessly, and transmits/receives information, such as various kinds of data and programs, to/from the server 1000 via the communication network N. At the player terminal 1, the programs, etc. received from the server 1000 are stored in the memory 12 or the storage unit 18.

The input unit 22 is configured of, for example, a touchscreen, buttons, a keyboard, a mouse, a cross key, or an analog controller with which player operations are input (operations are accepted). Alternatively, the input unit 22 may be a special controller provided in the player terminal 1 or connected (externally attached) to the player terminal 1. Alternatively, the input unit 22 may be configured of an acceleration sensor that detects tilting or movement of the player terminal 1 or a microphone that detects speech of the player. That is, the input unit 22 widely includes devices that enable the player to input his/her intents in distinguishable manners.

The output unit 24 is configured to include a display device and a speaker. The output unit 24 may be a device connected (externally attached) to the player terminal 1. In this embodiment, the player terminal 1 is provided with a display 26 as the output unit 24 and is provided with a touchscreen as the input unit 22, wherein the touchscreen is overlaid on the display 26.

### (Game Content)

Next, a game provided by the information processing system S and a game device G according to this embodiment will be described. A player can possess character cards earned by lottery, which is a so-called gacha, and character cards distributed by the game administrator. Furthermore, the player can possess support cards earned by lottery and support cards distributed by the game administrator.

Although described below in detail, a nurturing game is provided in the game according to this embodiment. In the nurturing game, the player can nurture the character tied to a character card possessed by the player. In addition, the nurturing game according to this embodiment has gameplay in which the player nurtures a character by having the character run in a race simulating a horse race.

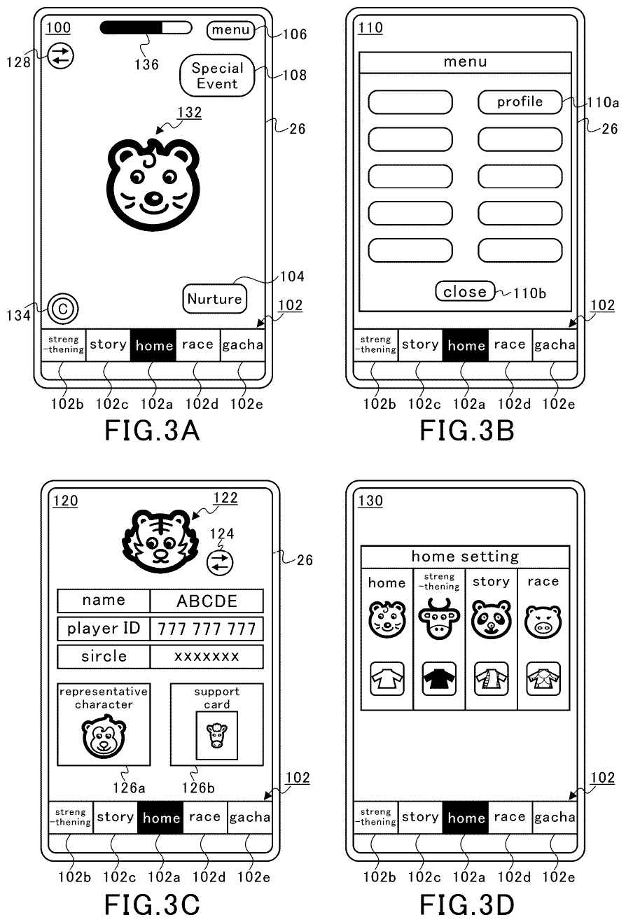

FIG. 3A is a drawing for illustrating an example of a home screen 100. When the game application is started at the player terminal 1, the home screen 100 is displayed on the display 26. In the lower section of the home screen 100, a menu bar 102 is displayed. A plurality of operation sections that can be operated (tapped) by the player are provided in the menu bar 102.

Here, a home screen selection operation section 102a, a strengthening screen selection operation section 102b, a story screen selection operation section 102c, a race game selection operation section 102d, and a gacha screen selection operation section 102e are provided in the menu bar 102. Note that in the menu bar 102, the operation section corresponding to the screen being displayed on the display 26 is highlighted so that the screen being displayed can be identified.

When the home screen selection operation section 102a is tapped, the home screen 100 shown in FIG. 3A is displayed on the display 26.

When the strengthening screen selection operation section 102b is tapped, a strengthening screen (not shown in the figure) is displayed. On the strengthening screen, it is possible to strengthen character cards and support cards possessed by the player. The player can increase the levels set for character cards and support cards by strengthening the character cards and the support cards. Character cards and support cards have various kinds of parameters set therefor, and the parameters increase as the levels increase. As a result of parameters of character cards and support cards increasing, the player can nurture a character having more powerful statuses in the nurturing game.

When the story screen selection operation section 102c is tapped, a story screen (not shown in the figure) is displayed. Here, a story image is provided for each of the characters appearing in the game. The player can select a character and the story image and view a story on the story screen.

When the race game selection operation section 102d is tapped, a race game selection screen (not shown in the figure) is displayed. This embodiment provides various race games in which a nurtured character that has been nurtured in a nurturing game (described below) can be made to run. On the race game selection screen, the player can select a race game in which a nurtured character is made to run. Race games include a team competition game in which a team organized with a plurality of nurtured characters is made to compete against a team organized by another player selected by the computer. The team competition game has gameplay in which the player competes against other players for rankings.

When the gacha screen selection operation section 102e is tapped, a gacha screen (not shown in the figure) is displayed. On the gacha screen, the player can draw a so-called gacha lottery, in which a character card and a support card can be earned by lottery, by consuming in-game currency.

In addition, on the home screen 100, a nurturing game operation section 104 is provided above the menu bar 102. When the nurturing game operation section 104 is tapped, a nurturing game screen is displayed, whereby a nurturing game (described below) is started. The nurturing game is roughly classified into a preparatory stage and a nurturing stage, and the player first selects one of the character cards possessed by himself/herself in the preparatory stage. A character card has one character tied thereto. The character tied to a character card is set as a nurturing-target character. Hereinafter, a character card or the character tied to the character card may be referred to simply as a character.

In the preparatory stage, the player also sets a deck to be used when nurturing the nurturing-target character. A deck is organized with a plurality of inheritance characters and a plurality of support cards (described below in detail). Therefore, in the nurturing game, the inheritance characters and the support cards organized in the deck are used.

When setting the nurturing-target character and the deck (inheritance characters and support cards) is completed, the preparatory stage transitions to the nurturing stage, whereby a game for nurturing the nurturing-target character is started. In the nurturing game, parameters of the nurturing-target character can be changed. The nurturing-target character whose nurturing has been completed in the nurturing game becomes a nurtured character. The player can possess a plurality of nurtured characters. As described above, the player can organize nurtured characters possessed by himself/herself into a team for use in a team competition game, etc.

Thus, the main objects of the game according to this embodiment are to create a nurtured character in a nurturing game and increase the ranking in a team competition game by using nurtured characters.

In addition, in this embodiment, a function for sharing a nurtured character or a support card among players and a function for sharing information among a plurality of players are provided. The player can set a nurtured character and a support card that can be used by other players in nurturing games. More specifically, as shown in FIG. 3A, a setting operation section 106 is provided in the upper right section of the home screen 100. When the setting operation section 106 is tapped, an option setting screen 110 is displayed.

FIG. 3B is a drawing for illustrating an example of the option setting screen 110. The option setting screen 110 is a screen that allows various kinds of information to be confirmed and set. A plurality of operation sections are provided on the option setting screen 110, so that when an operation section is tapped, information corresponding to the operation section can be confirmed and set.

The operation sections on the option setting screen 110 include a profile setting operation section 110a and a close operation section 110b. When the close operation section 110b is tapped, the option setting screen 110 is closed, and the home screen 100 is displayed. When the profile setting operation section 110a is tapped, a profile setting screen 120 is displayed.

FIG. 3C is a drawing for illustrating an example of the profile setting screen 120. On the profile setting screen 120, the player can confirm and set his/her own profile information. The profile information includes a profile character, a player name, a player ID, a circle to which the player belongs, a representative character, and a rental card.

The profile character functions as a character that is displayed when information concerning the player is viewed by another player. For example, the profile character is displayed when a circle function, which is a place for sharing information with other players, is used. On the profile setting screen 120, a currently set profile character image 122 is displayed. A change button 124 is provided near the profile character image 122. When the change button 124 is tapped, a profile character change screen (not shown in the figure) is displayed. On the profile character change screen, the player can change the profile character.

The player name set by the player, the player ID assigned to the player, and the name of the circle to which the player belongs are also displayed on the profile setting screen 120. In addition, a representative character setting operation section 126a and a rental card setting operation section 126b are provided on the profile setting screen 120.

When the representative character setting operation section 126a is tapped, a representative character setting screen (not shown in the figure) is displayed. On the representative character setting screen, the player can set, as a representative character, any one of the nurtured characters nurtured by himself/herself. In the representative character setting operation section 126a, an icon image indicating the currently set representative character is displayed. Although described below in detail, the representative character can be organized as an inheritance character in the deck in a nurturing game played by another player.

When the rental card setting operation section 126b is tapped, a rental card setting screen (not shown in the figure) is displayed. On the rental card setting screen, the player can set, as a rental card, any one of the support cards possessed by himself/herself. In the rental card setting operation section 126b, an icon image indicating the currently set rental card is displayed. Note that, as described above, the support card set as a rental card can be organized by another player in a deck and is used in a nurturing game played by the other player.

Although not described in detail, when a setting of the profile information is changed on the profile setting screen 120, setting change information is transmitted to the server 1000. In the server 1000, profile information for each player is saved.

As shown in FIG. 3A, a setting icon 128 is displayed on the home screen 100. When the setting icon 128 is tapped, a home setting screen 130 is displayed.

FIG. 3D is a drawing for illustrating an example of the home setting screen 130. On the home setting screen 130, the player can set home screen setting characters 132 to be displayed on the home screen 100. The player can set four home screen setting characters 132 to be displayed on the home screen 100.

Although not shown in the figure, when a leftward/rightward flick operation is input on the home screen 100, the screen displayed on the display 26, i.e., the display of the home screen 100, is switched. The four currently set home screen setting characters 132 are displayed on the home screen 100. The home screen setting characters 132 are assigned functions as respective operation sections displayed in the menu bar 102. Therefore, when a home screen setting character 132 displayed on the home screen 100 is tapped, the screen is switched in the same manner as when an operation section in the menu bar 102 is tapped.

On the home setting screen 130, character images corresponding to the four respective home screen setting characters 132 that are currently set, as well as corresponding operation sections, are displayed so as to be identifiable. When a character image displayed on the home setting screen 130 is tapped, a character selection screen (not shown in the figure) is displayed. The player can select a home screen setting character 132 on the character selection screen. Also, the player can set costumes for the home screen setting characters 132 on the home setting screen 130.

As shown in FIG. 3A, a circle icon 134 is displayed on the home screen 100. When the circle icon 134 is tapped, a circle screen is displayed. On the circle screen, the player can exchange information with other players belonging to the same circle.

In addition, various time-limited events are held irregularly in this embodiment. While a time-limited event is being held, a time-limited-event icon 108 is displayed on the home screen 100. When the time-limited-event icon 108 is tapped, a time-limited-event screen (not shown in the figure) is displayed. On the time-limited-event screen, the player, for example, can exchange event points, which are offered only during a limited time, for various rewards.

When the nurturing game operation section 104 is tapped on the home screen 100, the nurturing game screen is displayed, and a nurturing game is started. Note that the player can play a nurturing game by consuming game points. A predetermined value (e.g., +1) of game points is granted to the player every predetermined time period (e.g., 10 minutes). There is an upper limit (e.g., 100) set on the number of game points the player can have, and the player can have game points within the range up to the upper limit. In the upper section of the home screen 100, a game point indication bar 136 is provided to visually indicate the percentage of currently possessed game points relative to the upper limit.

The game points are decreased by a predetermined value (e.g., −30) at the time a nurturing game is started. Therefore, the player cannot start a nurturing game in the case where he/she does not have a required number of game points. It should be noted, however, that the player can possess an item that restores game points and can use the item to restore game points. This item can be granted, for example, as a reward for a nurturing game or a team competition game or can be earned by consuming in-game currency. The nurturing game will be described below in detail.

### (Nurturing Game)

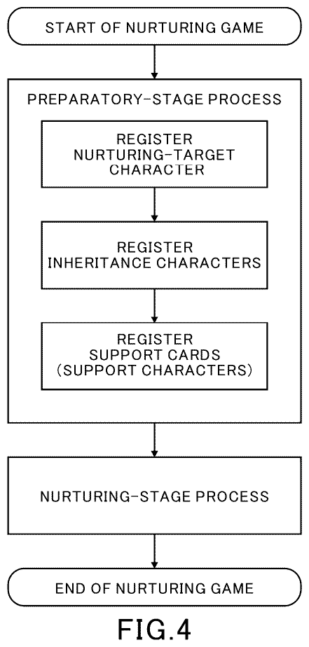

FIG. 4 is a drawing for illustrating a general flow of the nurturing game. The nurturing game is roughly classified into a setting game and a nurturing main game. Although described below in detail, the nurturing main game is a game in which one nurturing-target character selected from among the characters possessed by the player is nurtured.

In addition, the setting game allows the player to register a nurturing-target character and a deck (inheritance characters and support cards) and corresponds to the preparatory stage of the nurturing game. Hereafter, the processes executed in the setting game are referred to as a preparatory-stage process, and the processes executed in the nurturing main game are referred to as a nurturing-stage process. Here, for the sake of ease of understanding, the general flow of the preparatory-stage process and the nurturing-stage process will be described first.

### <Preparatory-Stage Process>

In the preparatory-stage process, a nurturing-target character and a deck (inheritance characters and support cards) are mainly registered. Note that support cards are used to assist in nurturing the nurturing-target character. Each of the support cards always has at least one character tied thereto, and the characters tied to the support cards that have been registered in the preparatory-stage process assist in nurturing the nurturing-target character. Hereafter, the character tied to a support card is referred to as a support character.

### <Registration of Nurturing-Target Character>

When the nurturing game operation section 104 is tapped by the player on the home screen 100, a scenario selection screen (not shown in the figure) is displayed. In this embodiment, a plurality of scenarios for the nurturing main game are provided. In each of the scenarios for the nurturing main game, a final goal, mid-game goals, etc. are set, and the player needs to clear the set goals one after another. Each of the scenarios has different goals and different time periods in which those goals are to be achieved. The player can select one of the plurality of scenarios on the scenario selection screen. Here, a case where a predetermined scenario is selected will be described.

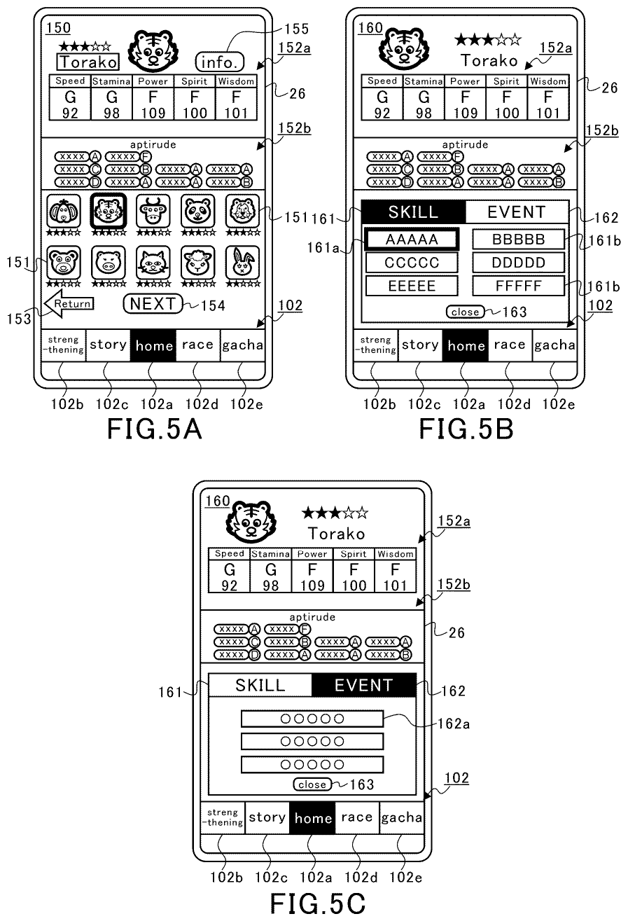

FIG. 5A is a drawing for illustrating a nurturing-target-character selection screen 150. In the center of the nurturing-target-character selection screen 150, a plurality of character icons 151 are displayed, showing a list of the characters tied to character cards possessed by the player (hereinafter, referred to simply as characters). In addition, in the upper section of the nurturing-target-character selection screen 150, an ability parameter display section 152a and an aptitude parameter display section 152b are displayed. A return operation section 153 captioned “Return” and a next operation section 154 captioned “NEXT” are also displayed in the lower section of the nurturing-target-character selection screen 150.

In this embodiment, initial values of ability parameters are set for each character, and the initial values of the ability parameters of the character corresponding to a character icon 151 selected by the player are displayed as numerical values in the ability parameter display section 152a. In this embodiment, the larger the numerical value of an ability parameter, the higher the ability.

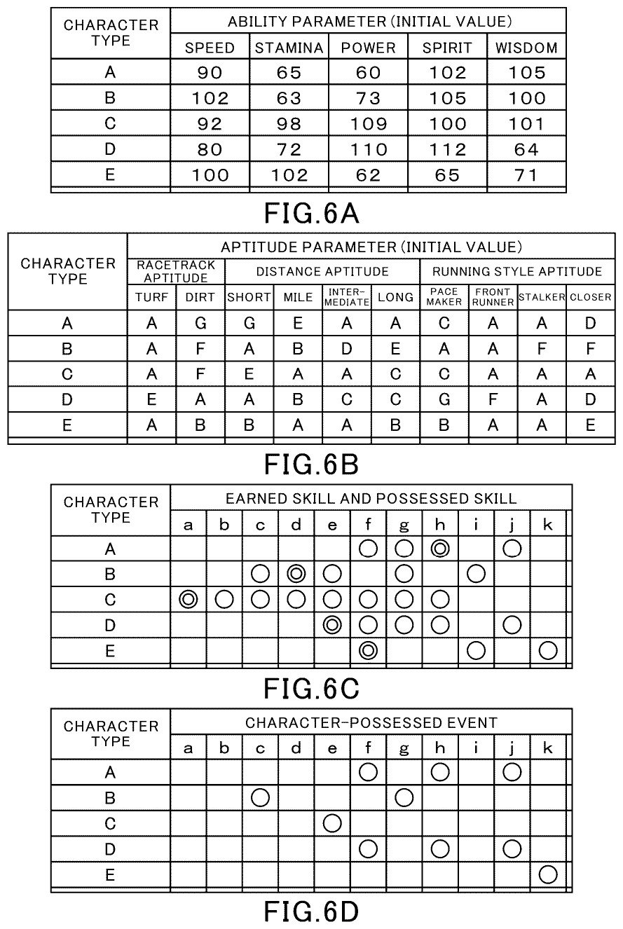

FIG. 6A is a drawing for illustrating an ability parameter (initial value) table. In this embodiment, as shown in FIG. 6A, the initial values of the ability parameters for each character are stored in the ability parameter (initial value) table. Also, on the basis of the initial values of the ability parameters stored in the ability parameter (initial value) table, the initial values of the ability parameters are displayed in the ability parameter display section 152a.

In this embodiment, the initial values of a plurality of kinds of ability parameters indicating the respective abilities are set for each character. More specifically, there are five kinds of ability parameters, including speed, stamina, power, spirit, and wisdom, that are captioned “Speed”, “Stamina”, “Power”, “Spirit”, and “Wisdom”, respectively, in the ability parameter display section 152a.

Note that the initial values of the ability parameters for each character are increased via a player operation, etc. For example, each character has five levels, so that the player can increase the level of the character by consuming in-game currency or predetermined items. In this case, the initial values of the ability parameters increase as the level of the character increases. FIG. 6A shows initial values in the case where the characters have a predetermined level. Note that the player can increase the values of ability parameters in the nurturing main game. Namely, an object of the nurturing main game is to nurture a character with larger numerical values of the ability parameters.

In addition, aptitude parameters (initial values) are set for each character in this embodiment. Initial values of the aptitude parameters of the character corresponding to the character icon 151 selected by the player are displayed as letters in the aptitude parameter display section 152b, as shown in FIG. 5A.

FIG. 6B is a drawing for illustrating an aptitude parameter (initial value) table. In this embodiment, the initial values of the aptitude parameters for each character are stored in the aptitude parameter (initial value) table, as shown in FIG. 6B. The initial value of each of the aptitude parameters is set as one of seven stages from letters A to G. Note that the initial value A of an aptitude parameter indicates the highest aptitude, and the initial value G of the aptitude parameter indicates the lowest aptitude. The initial values of the aptitude parameters are displayed in the aptitude parameter display section 152b on the basis of the initial values of the aptitude parameters stored in the aptitude parameter (initial value) table.

In this embodiment, the initial values of a plurality of kinds of aptitude parameters indicating the respective aptitudes are set for each character. More specifically, the aptitude parameters include: aptitude parameters related to a racetrack aptitude (turf track and dirt track); aptitude parameters related to a distance aptitude (short distance, mile, intermediate distance, and long distance); and aptitude parameters related to a running style aptitude (pace maker, front runner, stalker, and closer).

In the nurturing game, the player can allow the nurturing-target character to run in various races. At this time, the higher the aptitude of the nurturing-target character matching the race content is, the more advantageously the race proceeds.

It is also acceptable that the initial values of the aptitude parameters for each character can be increased by consuming in-game currency. In addition, the value of an aptitude parameter may change in the nurturing main game. In addition, there may be some cases where an aptitude parameter is set as S, which indicates a higher aptitude than A, in the nurturing main game.

FIG. 5B is a first drawing for illustrating a character details screen 160. In addition, FIG. 5C is a second drawing for illustrating the character details screen 160. When a character icon 151 on the nurturing-target-character selection screen 150 is pressed and held, the character details screen 160 is displayed on the display 26. On the character details screen 160, details of the abilities of the character corresponding to the character icon 151 that was pressed and held on the nurturing-target-character selection screen 150 are displayed.

In the center of the character details screen 160, a skill operation section 161 and an event operation section 162 are displayed. As shown in FIG. 5B, when the character details screen 160 is displayed, the skill operation section 161 is initially highlighted, and skills provided for the character are displayed. A skill is an ability that may be invoked in the case where a predetermined condition is satisfied while an individual race (described below) is being executed. When a skill is invoked, the race proceeds advantageously to each character.

FIG. 6C is a drawing for illustrating a skill table. As shown in FIG. 6C, skills for each of the characters possessed by the player are stored in the skill table. Also, skills are displayed on the character details screen 160, as shown in FIG. 5B, on the basis of the skills stored in the skill table. Note that merely possessing a skill does not allow the skill to be invoked-a skill can be invoked only after it has been earned. Hereinafter, a skill that is ready to be invoked by a character is referred to as an earned skill.

One earned skill is set for a character from the beginning of the nurturing main game. In addition, a plurality of possessed skills are set for the character, besides the one earned skill. A possessed skill is a skill that can be earned by consuming skill points (described below) after the start of the nurturing main game. That is, a possessed skill can become an earned skill in exchange for skill points.

In this embodiment, the skill indicated with a double circle in the skill table shown in FIG. 6C is displayed as the earned skill on the character details screen 160 in FIG. 5B. In addition, the skills indicated with a circle in the skill table shown in FIG. 6C are displayed as the possessed skills on the character details screen 160 in FIG. 5B. In this embodiment, the earned skill is highlighted so that it can be easily distinguished from the possessed skills, as shown on the character details screen 160 in FIG. 5B.

Although FIG. 5B is shown by way of an example where one earned skill and seven possessed skills are displayed in an earned-skill display field 161a and possessed-skill display fields 161b, respectively, as the skills provided for each character, the present invention is not limited to this example. For example, the number of earned skills and the number of possessed skills may differ for each character. Also, for example, the number of earned skills or possessed skills for each character may increase with an increase in the level of the character, consumption of in-game currency or items, etc.

In addition, when the player taps the event operation section 162 on the character details screen 160, the content of the character details screen 160 is switched to display character-possessed-event display fields 162a indicating character-possessed events provided for the character, as shown in FIG. 5C. In this case, the event operation section 162 is highlighted, as shown in FIG. 5C. A character-possessed event occurs in the case where a predetermined condition is satisfied in the nurturing main game, and displays a story related to a character appearing in the nurturing game or changes the value of an ability parameter.

FIG. 6D is a drawing for illustrating a character-possessed-event table. As shown in FIG. 6D, character-possessed events for each of the characters possessed by the player are stored in the character-possessed-event table. Also, on the basis of the character-possessed events stored in the character-possessed-event table, the character-possessed events are displayed on the character details screen 160, as shown in FIG. 5C. Note that the character-possessed events may include a hint event that enables possession or earning of a skill, an ability event that increases or decreases the numerical values of ability parameters of the character, etc.

Regarding the character-possessed events displayed on the character details screen 160 shown in FIG. 5C, all of the character-possessed events may be allowed to occur during execution of the nurturing main game, at least some of the character-possessed events may be allowed to occur during execution of the nurturing main game, or none of the character-possessed events may be allowed to occur during execution of the nurturing main game in the case where the predetermined condition is not satisfied. Also, for example, the number of character-possessed events provided for each character may increase with an increase in the level of the character, consumption of in-game currency or items, etc. It is also acceptable that in the case where a predetermined condition is satisfied, a character-possessed event that is not displayed as a character-possessed event is executed during the nurturing main game.

In addition, as shown in FIGS. 5B and 5C, a close operation section 163 captioned “close” is displayed in the lower section of the character details screen 160. In the case where the close operation section 163 on the character details screen 160 is tapped, the character details screen 160 disappears, and the nurturing-target-character selection screen 150 is displayed on the display 26.

In addition, when the return operation section 153 is tapped on the nurturing-target-character selection screen 150 shown in FIG. 5A, the home screen 100 shown in FIG. 3A is displayed on the display 26. A nurturing information display button 155 is also provided on the nurturing-target-character selection screen 150. When the nurturing information display button 155 is tapped, a nurturing information display screen (not shown in the figure) is displayed. On the nurturing information display screen, the player can confirm information concerning the character selected on the nurturing-target-character selection screen 150.

A clearance goal tab is provided on the nurturing information display screen. Although described below in detail, a nurturing main game is composed of a plurality of turns, and the player needs to make the nurturing-target character do training and run in a race in each of the turns.

Also, each of the characters has a plurality of clearance goals set therefor. When the clearance goal tab is tapped, the clearance goals set for the currently selected character are listed on the nurturing information display screen. In each of the turns, a race that allows the nurturing-target character to run therein is defined in advance.

Also, when the nurturing-target character that will be nurtured is made to run in a race, the nurturing-target character can earn fans, victory points, and special currency. In each of the races, the number of base earnings of fans, victory points, and special currency are defined for each finish place, and the higher the finish place, the larger the number of earned fans and the larger the numerical values of earned victory points and special currency.

Races also have difficulty levels set therefor, and the higher the difficulty level of a race, the more fans, victory points, and special currency the player can earn in the race. For example, some races are called high-stakes races, having GI, GII, and GIII grades. The grade becomes higher in the order of GIII, GII, and GI. The higher the grade of a race, the higher the difficulty level of the race, and the more fans, victory points, and special currency the player can earn in the race.

Here, the number of fans the player can earn by participating in a race is calculated by adding the number of bonus earnings to the number of base earnings defined for each finish place. More specifically, a correction value is decided on the basis of a race result, and the number of base earnings is multiplied by the correction value to calculate the number of bonus earnings. The sum of this number of bonus earnings and the number of base earnings is the number of fans earned by the nurturing-target character. In the case where the race result indicates, for example, the first place, the larger the difference between the nurturing-target character and the character that has won the second place, the larger the correction value. Also, in the case where the race result indicates one of the second to fifth places, the smaller the difference between the nurturing-target character and the character that has won the first place, the larger the correction value.

In addition, the nurturing-target character invokes a skill at a predetermined probability during a race. At this time, the larger the number of invoked skills, the larger the correction value. Thus, a condition for adding the number of fans is defined in each of the races, and the number of earned fans increases depending on various race results other than the finish place and a midway state of the race. It should be noted, however, that the number of fans earned by the nurturing-target character is at least the number of base earnings corresponding to the finish place.

Note that a certain number of fans are specified as a race-participating condition in some races. In the case where the number of fans earned by the nurturing-target character is less than the number of fans specified as a race-participating condition, the player cannot allow the nurturing-target character to run in the race. The higher the difficulty level of a race, the larger the number of fans required to allow the nurturing-target character to run in the race.

Thus, each of the characters has a plurality of clearance goals set therefor. The player can continue the nurturing main game until the last turn by achieving the clearance goals. On the other hand, in the case where the player fails to achieve a clearance goal, the nurturing main game ends at the turn.

Thus, the player can select a nurturing-target character while confirming various items of information concerning each of the characters on the nurturing-target-character selection screen 150 shown in FIG. 5A. Also, when the next operation section 154 is tapped on the nurturing-target-character selection screen 150, the currently selected character is set as a nurturing-target character, and an inheritance character selection screen 170 is displayed on the display 26.

### <Registration of Inheritance Characters>

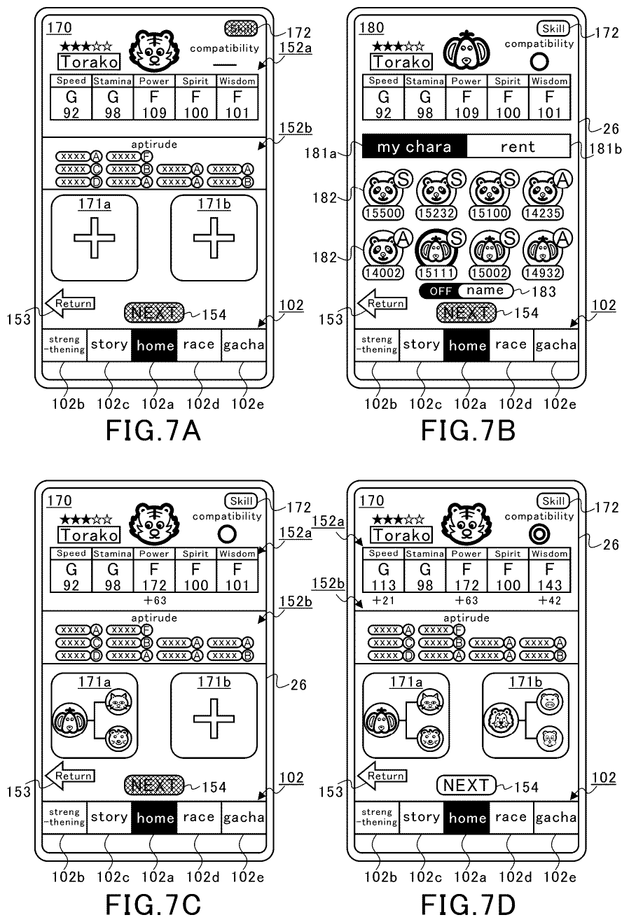

FIG. 7A is a first drawing for illustrating the inheritance character selection screen 170. FIG. 7B is a first drawing for illustrating a nurtured character list screen 180. FIG. 7C is a second drawing for illustrating the inheritance character selection screen 170. FIG. 7D is a third drawing for illustrating the inheritance character selection screen 170. The inheritance character selection screen 170 is a screen for the player to register inheritance characters.

An inheritance character is a character from which the nurturing-target character inherits ability values, skills, etc. The player can select two inheritance characters from among the nurtured characters possessed by himself/herself, as well as from among the representative characters of other players extracted according to a predetermined extraction condition, such as the representative characters of friends typified by followers, thereby organizing and registering the selected inheritance characters in a deck. Note that at most only one representative character of another player can be organized as an inheritance character in the deck in one nurturing game.

The ability parameter display section 152a, the aptitude parameter display section 152b, a first inheritance character selection region 171a, and a second inheritance character selection region 171b are provided on the inheritance character selection screen 170. When the screen transitions from the nurturing-target-character selection screen 150 to the inheritance character selection screen 170, the first inheritance character selection region 171a and the second inheritance character selection region 171b are displayed blank, as shown in FIG. 7A.

When the first inheritance character selection region 171a or the second inheritance character selection region 171b is tapped, the nurtured character list screen 180 shown in FIG. 7B is displayed. A my character tab 181a and a rental tab 181b are provided on the nurtured character list screen 180. In addition, a nurtured character list display region is provided below the my character tab 181a and the rental tab 181b. Nurtured character icons 182 are displayed in the nurtured character list display region.

While the my character tab 181a is selected, the nurtured character icons 182 corresponding to the nurtured characters possessed by the player himself/herself are displayed, as shown in FIG. 7B. Also, although not shown in the figure, the nurtured character icons 182 corresponding to the representative characters of friends, i.e., nurtured characters that have been nurtured by the friends, are displayed while the rental tab 181b is selected.

In addition, when a nurtured character icon 182 is tapped, the nurtured character corresponding to the nurtured character icon 182 is temporarily selected. When the nurtured character icon 182 is tapped, the inheritance character selection screen 170 is also displayed, as shown in FIG. 7C. At this time, for example, if the nurtured character list screen 180 is displayed as a result of the first inheritance character selection region 171a being tapped and a nurtured character icon 182 is tapped on the nurtured character list screen 180, then an image indicating the nurtured character that has been temporarily selected is displayed in the first inheritance character selection region 171a.

In this state, for example, if the nurtured character list screen 180 is displayed as a result of the second inheritance character selection region 171b being tapped and a nurtured character icon 182 is tapped on the nurtured character list screen 180, then an image indicating the nurtured character that has been temporarily selected is displayed in the second inheritance character selection region 171b, as shown in FIG. 7D.

In addition, information concerning the inheritance characters used when a nurtured character was nurtured is stored in such a way as to be tied to the nurtured character. In the first inheritance character selection region 171a, information concerning the inheritance characters used when the nurtured character was nurtured is displayed.

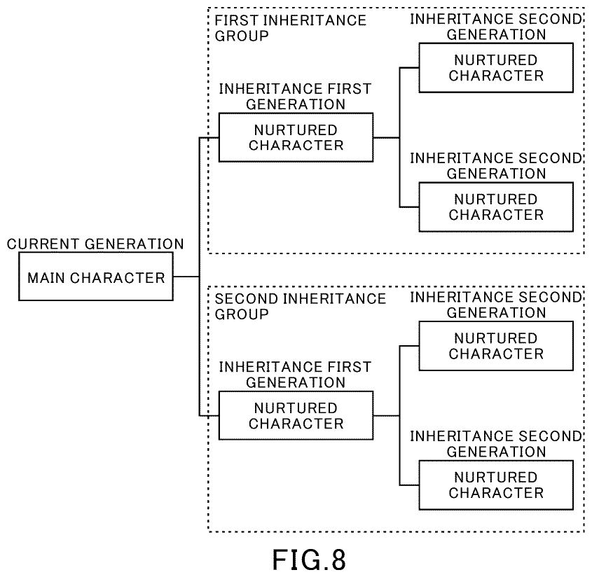

FIG. 8 is a drawing for illustrating an inheritance line of descent. In a nurturing game, various kinds of effectiveness are achieved on the basis of factor information possessed by the inheritance characters, such as an increase in the values of ability parameters and aptitude parameters of the nurturing-target character. Here, two inheritance characters are set for one nurturing-target character, and these inheritance characters are nurtured characters created before. Therefore, when a nurtured character set as an inheritance character was created, the nurtured character also had two inheritance characters set therefor.

As shown in FIG. 8, the nurturing-target character to be nurtured in the nurturing main game that will be started from now is assumed to be the current generation. In addition, two nurtured characters set as inheritance characters for the nurturing-target character of the current generation are assumed to be the inheritance first generation. Furthermore, when nurturing of each of the nurtured characters of the inheritance first generation was started, two nurtured characters were set as inheritance characters. The two nurtured characters set as inheritance characters when each of the nurtured characters of the inheritance first generation was created are assumed to be the inheritance second generation.

In this case, the nurtured characters of the inheritance first generation and the inheritance second generation achieve effectiveness on the nurturing-target character of the current generation, as shown in FIG. 8. As described above, because two inheritance characters (inheritance first generation) are set for one nurturing-target character, a total of six nurtured characters achieve effectiveness on the one nurturing-target character.

For example, a first inheritance group is composed of one of the two nurtured characters of the inheritance first generation and the two nurtured characters of the inheritance second generation serving as the inheritance characters of this nurtured character. Similarly, a second inheritance group is composed of the other of the two nurtured characters of the inheritance first generation and the two nurtured characters of the inheritance second generation serving as the inheritance characters of this nurtured character.

As shown in FIG. 7D, the first inheritance character selection region 171a contains icons corresponding to the one nurtured character of the inheritance first generation and the two nurtured characters of the inheritance second generation, respectively, that constitute the first inheritance group. Similarly, the second inheritance character selection region 171b contains icons corresponding to the one nurtured character of the inheritance first generation and the two nurtured characters of the inheritance second generation, respectively, that constitute the second inheritance group.

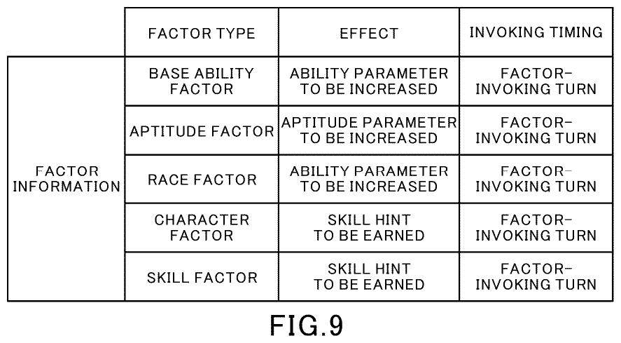

FIG. 9 is a drawing for illustrating factor information. Although described below in detail, when the nurturing game is completed, the nurturing-target character that has been nurtured is registered as a nurtured character, and at this time, factor information is stored so as to be tied to the nurtured character. More specifically, when nurturing of the nurtured character is completed, factors to be earned by the nurtured character are decided by lottery. Also, factor information indicating the factors won by lottery is tied to the nurtured character. In other words, when the nurturing game is completed, the nurtured character can earn the factors won by lottery.

It should be noted, however, that the factors earned by the nurtured character do not affect the abilities themselves of the nurtured character. For example, the nurtured character can be made to run in a race game, such as a team competition game. At this time, in the race, simulation, i.e., computation for deciding the finish places and race proceeding is executed on the basis of the ability parameters, aptitude parameters, earned skills, etc. of all nurtured characters running in the race. Factors possessed by the nurtured characters are not used for computation, and even if a nurtured character has many factors, the race does not proceed advantageously to the nurtured character.

Factors possessed by a nurtured character affect only the nurturing-target character that will be nurtured in the case where the nurtured character is set as an inheritance character. Factors that can be earned by a nurtured character are classified into a plurality of types. FIG. 9 shows factor types: a base ability factor, an aptitude factor, a race factor, a character factor, and a skill factor. One of a plurality of stages is set for each of the factors. Here, three stages of factor level, including level 1, level 2, and level 3, are provided as factor stages.

Note that the factor level is decided by lottery. At this time, after factors to be earned by the nurtured character are decided, a factor level may be decided by lottery for each of the earned factors. Alternatively, a winning rate may be set for each of the combination patterns of factors and factor levels, so that any of the combination patterns can be decided on the basis of the set winning rate. In this case, factors to be earned and factor levels are decided simultaneously.

The factor level has level 3 as the most effective level and level 1 as the least effective level. In a lottery for deciding a factor level, level 3 is set to have the lowest winning probability, and level 1 is set to have the highest winning probability. It should be noted, however, that the winning probability of a factor to be earned and the winning probability of a factor level may change depending on the result of the nurturing game. In this case, a factor level may be decided so that, for example, the higher an ability parameter and an evaluation score of the nurtured character, the higher the factor level.

The base ability factor increases an ability parameter of the nurturing-target character. The base ability factor has five factors: a speed factor, a stamina factor, a power factor, a spirit factor, and a wisdom factor. A nurtured character always earns one of the five base ability factors. The five base ability factors correspond to the five ability parameters: speed, stamina, power, spirit, and wisdom, respectively. In the case where a nurtured character of the inheritance first generation or the inheritance second generation has, for example, a speed factor, the speed ability parameter of the nurturing-target character increases.

At this time, the increase value of the speed ability parameter differs depending on the factor level of the speed factor. For example, the speed ability parameter of the nurturing-target character increases by “7” in the case where the factor level of the speed factor is level 1, the ability parameter increases by “13” in the case where the factor level of the speed factor is level 2, and the ability parameter increases by “21” in the case where the factor level of the speed factor is level 3. Therefore, in the case where a total of six nurtured characters, including the two nurtured characters of the inheritance first generation and the four nurtured characters of the inheritance second generation, have a speed factor of level 3, the speed ability parameter of the nurturing-target character increases by a maximum of 126 (increase value 21×six characters).

It should be noted, however, that each of the factors has an invoking timing and an invoking condition set therefor. Therefore, even if an inheritance character has a factor, no effectiveness is achieved on the nurturing-target character in the case where the invoking condition is not satisfied at the invoking timing.

As described above, a nurturing main game is composed of a plurality of turns, and predetermined turns among those turns are set as factor-invoking turns. Suppose that three turns of the nurturing main game, e.g., the first turn, the 30th turn, and the 54th turn, are set as factor-invoking turns. In these factor-invoking turns, it is decided whether or not to invoke each of the factors, and in the case where it is decided to invoke a factor, the invoking condition of that factor is satisfied, thus achieving effectiveness corresponding to the factor.

Note that whether or not to invoke a base ability factor is decided by lottery. At this time, the probability of winning a lottery for deciding whether or not to invoke a base ability factor, i.e., the probability of invoking the base ability factor (hereinafter, referred to as an invoking probability) may differ among the three factor-invoking turns. Here, in the first turn, the invoking probability of a base ability factor is set to 100%, regardless of the factor level. In addition, in the 30th turn and the 54th turn, the invoking probability of a base ability factor differs depending on the factor level. As an example, in the 30th turn and the 54th turn, the invoking probability of a base ability factor of level 3 is set to 100%, the invoking probability of a base ability factor of level 2 is set to 90%, and the invoking probability of a base ability factor of level 1 is set to 80%.

On the inheritance character selection screen 170, an increase value by which an ability parameter increases in the first turn is displayed. For example, one inheritance character constituting the first inheritance group is temporarily selected in FIG. 7C. In this case, the kind of an ability parameter that increases in the first turn due to the one inheritance character that is temporarily selected, as well as an increase value of the ability parameter, is displayed. Here, “+63” is displayed below the power ability parameter, indicating that the power ability parameter increases by 63 points in the first turn. In addition, the ability parameter display section 152a shows a value resulting from the increase value in the first turn being added.

In addition, two inheritance characters constituting the first inheritance group and the second inheritance group are temporarily selected in FIG. 7D. In this case, the kinds of ability parameters that increase in the first turn due to the two inheritance characters that are temporarily selected, as well as increase values of the ability parameters, are displayed. Here, “+21”, “+63”, and “+42” are displayed below the speed, power, and wisdom ability parameters, respectively, indicating that the speed, power, and wisdom ability parameters increase by 21 points, 63 points, and 42 points, respectively, in the first turn.

Note that on the inheritance character selection screen 170, an increase value of the ability parameter that increases due to the inheritance character constituting the first inheritance group and increase values of the ability parameters that increase due to the inheritance character constituting the second inheritance group are displayed identifiably. For example, in FIG. 7D, the “+63” indication displayed below the power ability parameter and the “+21” and “+42” indications displayed below the speed ability parameter and the wisdom ability parameter are differentiated by color.

The aptitude factor shown in FIG. 9 increases an aptitude parameter of the nurturing-target character. The aptitude factor has six factors: a turf factor, a dirt factor, a short distance factor, a mile factor, an intermediate distance factor, and a long distance factor. A nurtured character always earns one of the six aptitude factors. The six aptitude factors correspond to a turf aptitude, a dirt aptitude, a short distance aptitude, a mile aptitude, an intermediate distance aptitude, and a long distance aptitude, respectively. In the case where the nurtured characters of the inheritance first generation or the inheritance second generation include a nurtured character having, for example, a turf factor, the aptitude parameter of the turf aptitude of the nurturing-target character increases.

It should be noted, however, that each of the aptitude factors also has an invoking timing and an invoking condition set therefor, and it is decided whether or not to invoke each of the aptitude factors in the same factor-invoking turns as those for the base ability factor. In the case where it is decided to invoke an aptitude factor, the corresponding aptitude parameter increases in one stage. As an example, the invoking probability of an aptitude factor is set to 100% in the first turn, regardless of the factor level.

Suppose that, for example, the aptitude factors of the three nurtured characters belonging to the first inheritance group are the turf factor, the short distance factor, and the mile factor, respectively, and that the aptitude factors of the three nurtured characters belonging to the second inheritance group are the turf factor, the short distance factor, and the intermediate distance factor, respectively. In this case, the turf aptitude and the short distance aptitude of the nurturing-target character each increase in two stages, and the mile aptitude and the intermediate distance aptitude each increase in one stage.

Also, suppose that, for example, all aptitude factors of the three nurtured characters belonging to the first inheritance group are the turf factor and that all aptitude factors of the three nurtured characters belonging to the second inheritance group are the short distance factor. In this case, the turf aptitude and the short distance aptitude of the nurturing-target character each increase in three stages. As still another example, suppose that all aptitude factors of the three nurtured characters belonging to the first inheritance group are the turf factor and that the aptitude factors of the three nurtured characters belonging to the second inheritance group are the turf factor, the short distance factor, and the mile factor, respectively. In this case, the turf aptitude of the nurturing-target character increases in four stages, and the short distance aptitude and the mile aptitude each increase in one stage.

It should be noted, however, that a limit is set on the increase values of aptitude parameters in the first turn. More specifically, the upper limits of all aptitude parameters are set to A in the first turn. Therefore, in the case where the initial value of the turf aptitude of the nurturing-target character is A, the turf aptitude does not increase in the first turn even if an inheritance character has the turf factor.

In contrast, in the 30th turn and the 54th turn, a lottery for deciding whether or not to invoke each of the aptitude factors is drawn on the basis of the factor level thereof. As an example, in the 30th turn and the 54th turn, the invoking probability of an aptitude factor of level 3 is set to 5%, the invoking probability of an aptitude factor of level 2 is set to 3%, and the invoking probability of an aptitude factor of level 1 is set to 1%. In the 30th turn or the 54th turn, when it is decided to invoke an aptitude factor by lottery, the aptitude parameter corresponding to the aptitude factor increases. Note that in the 30th turn and the 54th turn, the upper limit of each of the aptitudes is raised from A to S. Therefore, in the 30th turn and the 54th turn, the value of each of the aptitude parameters can be increased up to S by invoking an aptitude factor.

Note that the values of the aptitude parameters that have increased in the first turn are displayed in the aptitude parameter display section 152b of the inheritance character selection screen 170.

The race factor increases an ability parameter of the nurturing-target character. A race factor is provided for each of the races with a high difficulty level (hereinafter, referred to as a factor-target race), such as GI, among the races of the nurturing main game in which the nurturing-target character can run. When the nurturing game is completed, a lottery for deciding whether or not to earn a race factor is drawn for each of the factor-target races in which the nurturing-target character won the first place. The nurtured character can earn a race factor by winning this lottery.

Note that a factor level is provided for each of the race factors, and a factor level is decided by lottery for each of the race factors that have been decided to be earned. Here, there are no upper limits on the number of race factors that can be earned by one nurtured character, so that one nurtured character can earn a plurality of race factors.

Each of the race factors has set therefor in advance an ability parameter that is increased when the race factor is invoked and the increase value thereof. For example, race factors include a race factor for increasing the speed ability parameter and a race factor for increasing the power ability parameter. At this time, the higher the factor level, the larger the increase value of the ability parameter.

In addition, each of the race factors also has an invoking timing and an invoking condition set therefor, and it is decided whether or not to invoke each of the race factors in the factor-invoking turns. In the case where it is decided to invoke a race factor, the ability parameter corresponding to the race factor increases. Note that the factor-invoking turns for invoking a race factor are limited to the 30th turn and the 54th turn. In addition, the invoking probability of a race factor in a factor-invoking turn differs depending on the factor level, and the higher the factor level, the higher the invoking probability.

The character factor is a factor specific to a character. For example, only in the case where a character that has been strengthened up to a predetermined level is nurtured as a nurturing-target character, the character factor set for the character is always granted to the nurtured character when the nurturing game is completed. Note that because only one character factor is set for one character, one nurtured character can earn up to one character factor. Also, in the case where a nurtured character is created on the basis of a character that has not been strengthened to the predetermined level, the nurtured character cannot earn the character factor.

In addition, a character factor can be invoked in a factor-invoking turn set in advance and is invoked when a lottery drawn in the factor-invoking turn is won. When a character factor is invoked, a hint event set for the character factor occurs, allowing the player to earn a hint for a skill, as described above.

The skill factor is granted on the basis of earned skills earned by the nurtured character. More specifically, when the nurturing game is completed, a lottery for deciding whether or not to earn a skill factor is drawn for each of the earned skills earned by the nurtured character. A skill factor is granted to the nurtured character when this lottery is won. In short, the nurtured character can earn some or all of the skill factors corresponding to the earned skills. Note that when it is decided that a skill factor is to be earned, the factor level of that skill factor is decided by lottery.

In addition, a skill factor can be invoked in a factor-invoking turn set in advance and is invoked when a lottery drawn in the factor-invoking turn is won. At this time, the higher the factor level, the higher the winning probability. When a skill factor is invoked, a hint event set for the skill factor occurs, allowing the player to earn a hint for a skill. Because of this, the nurturing-target character can earn a skill similar to an earned skill earned by an inheritance character, etc.

Thus, skill factors are earned within the range of earned skills earned by the nurtured character. Therefore, the larger the number of earned skills earned by a nurtured character, the higher the probability that the nurtured character earns a skill factor. It should be noted, however, that because whether or not to earn a skill factor is decided by lottery, no skill factors may be earned in some cases, irrespective of whether many skills are earned.

Here, the present embodiment has been described by way of an example where the nurtured character earns a skill factor besides an earned skill. However, instead of providing skill factors, a skill that can be earned by the nurturing-target character may be decided on the basis of earned skills possessed by the nurtured characters serving as inheritance characters.

As described above, ability parameters of the nurturing-target character greatly change depending on the inheritance characters organized in the deck. In addition, a nurtured character with a high ability is not necessarily suitable as an inheritance character because whether or not to earn a factor is decided by lottery, regardless of the high ability of the nurtured character itself. On the other hand, even in the case where a nurtured character itself does not have a high ability, the nurtured character may function as an effective inheritance character by earning many factors with a high factor level. Thus, allowing an inheritance character to be organized in a deck brings about pleasure in that not only is a powerful nurtured character nurtured but also a nurtured character effective as an inheritance character is nurtured.

Furthermore, in this embodiment, compatibility among the nurturing-target character, the nurtured characters of the inheritance first generation, and the nurtured characters of the inheritance second generation is determined. Also, in the case of a combination of characters with good compatibility, the factor invoking condition becomes favorable.

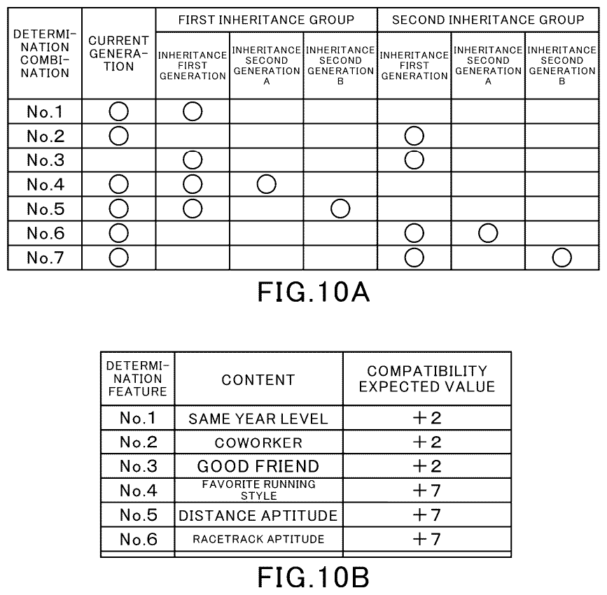

FIG. 10A is a drawing for illustrating compatibility determination combinations, and FIG. 10B is a drawing for illustrating compatibility determination features. As shown in FIG. 10A, seven determination combinations from No. 1 to No. 7 are provided in this embodiment. The first determination combination (No. 1) is the combination of the nurturing-target character of the current generation and the nurtured character of the inheritance first generation in the first inheritance group. The second determination combination (No. 2) is the combination of the nurturing-target character of the current generation and the nurtured character of the inheritance first generation in the second inheritance group.

The third determination combination (No. 3) is the combination of the nurtured character of the inheritance first generation in the first inheritance group and the nurtured character of the inheritance first generation in the second inheritance group. The fourth determination combination (No. 4) is the combination of the nurturing-target character of the current generation, the nurtured character of the inheritance first generation in the first inheritance group, and one (nurtured character A) of the nurtured characters of the inheritance second generation in the first inheritance group. The fifth determination combination (No. 5) is the combination of the nurturing-target character of the current generation, the nurtured character of the inheritance first generation in the first inheritance group, and the other (nurtured character B) of the nurtured characters of the inheritance second generation in the first inheritance group.

The sixth determination combination (No. 6) is the combination of the nurturing-target character of the current generation, the nurtured character of the inheritance first generation in the second inheritance group, and one (nurtured character A) of the nurtured characters of the inheritance second generation in the second inheritance group. The seventh determination combination (No. 7) is the combination of the nurturing-target character of the current generation, the nurtured character of the inheritance first generation in the second inheritance group, and the other (nurtured character B) of the nurtured characters of the inheritance second generation in the second inheritance group.

It is determined whether or not a condition is satisfied for each of the aforementioned determination combinations with respect to each of a plurality of determination features. FIG. 10B shows an example of determination features. In this embodiment, the game world is set up such that the characters that can be selected as a nurturing-target character are students, and each character does training at school.

Also, each character has pre-defined settings of year level, coworker, and good friend, as shown in FIG. 10B. The determination features include content, for example, as to whether the two or three characters constituting a determination combination are in the same year level, are coworkers, and are good friends. The determination features also include content as to whether the characters constituting a determination combination have in common a favorite running style, a favorite distance aptitude, and a favorite racetrack aptitude.

Also, a compatibility expected value is tied to each of the determination features, so that the compatibility expected values of the determination features that are satisfied among the characters constituting a determination combination are accumulated. Although the compatibility expected value differs depending on the determination feature here, the compatibility expected value may be common to all determination features.

For example, in order to determine compatibility, first it is determined whether or not each of the determination features is satisfied between the characters belonging to the first determination combination, i.e., between the nurturing-target character of the current generation and the nurtured character of the inheritance first generation in the first inheritance group. At this time, compatibility expected values tied to the satisfied determination features are accumulated and counted. In this manner, the compatibility expected values are counted sequentially from the first determination combination to the seventh determination combination, and invoking probabilities of factors are corrected on the basis of the finally calculated compatibility expected value. That is, the larger the compatibility expected value is, the higher the invoking probabilities of all factors are, and the smaller the compatibility expected value is, the lower the invoking probabilities of all factors are.

Note that the invoking probabilities may be calculated by using the calculated compatibility expected value as a correction value. In addition, for example, a correction value for correcting the invoking probabilities of factors may be set for each compatibility level, so that the compatibility level is decided by the calculated compatibility expected value.

Thus, because the invoking probabilities of factors differ depending on the compatibility between the nurturing-target character and an inheritance character or the compatibility between inheritance characters, the combination of two inheritance characters greatly affects nurturing of the nurturing-target character. That is, the compatibility between characters can be an important determination consideration in selecting an inheritance character.

In a state in which an inheritance character is selected, a compatibility mark indicating the level of compatibility is displayed in the upper right section of the inheritance character selection screen 170 and the nurtured character list screen 180, as shown in FIGS. 7B, 7C, and 7D. Here, the compatibility level based on the currently selected character is indicated with three compatibility marks: a double circle, a circle, and a triangle. Note that in a state in which no inheritance characters are selected, no compatibility marks are displayed, as shown in FIG. 7A.

In addition, a display switch button 183 is provided on the nurtured character list screen 180, as shown in FIG. 7B. When the display switch button 183 is operated, a display condition setting screen (not shown in the figure) is displayed. On the display condition setting screen, the player can make a setting for reordering or refining the nurtured character icons 182 displayed on the nurtured character list screen 180, i.e., the nurtured characters that can be selected as inheritance characters.

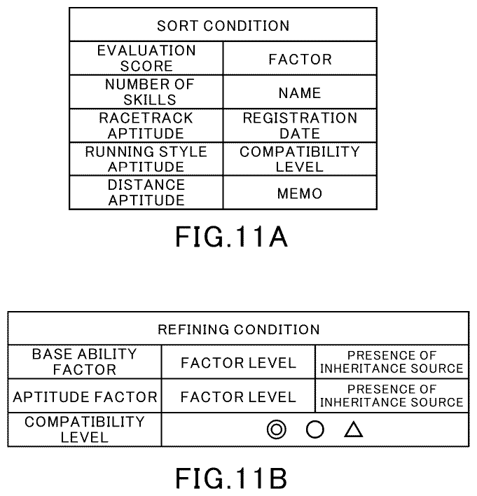

FIG. 11A is a drawing for illustrating sort conditions. FIG. 11B is a drawing for illustrating refining conditions. The player can select and set a sort condition shown in FIG. 11A on the display condition setting screen. Here, any of the evaluation score, factor, number of skills, name, racetrack aptitude, registration date, running style aptitude, compatibility level, distance aptitude, and memo can be selected and set as a sort condition. When a sort condition is set, the nurtured character list screen 180 is displayed. At this time, on the nurtured character list screen 180, the order in which the nurtured character icons 182 are displayed is changed according to the sort condition.

On the display condition setting screen, the player can also select and set a refining condition shown in FIG. 11B. Here, the base ability factor, aptitude factor, and compatibility level are provided as refining conditions. Note that when the base ability factor or the aptitude factor is set as a refining condition, only the nurtured characters having the factor selected by the player are displayed on the nurtured character list screen 180.

At this time, the player can set a factor level. In the case where the nurtured characters are refined with the factor level set to, for example, level 3, only the nurtured characters having factors that are identical to the factor selected by the player and that have a factor level of level 3 are displayed on the nurtured character list screen 180. Note that the player can refine the nurtured characters by selecting whether the nurtured character itself has the factor or inheritance characters of the nurtured character have the factor.

In addition, the player can refine the nurtured characters by compatibility level. Here, the player can refine nurtured characters with the compatibility indicated by a double circle, nurtured characters with the compatibility indicated by a circle, and nurtured characters with the compatibility indicated by a triangle. In this manner, sorting and refining are possible with various conditions, thereby enhancing convenience to the player.

Furthermore, when a nurtured character icon 182 is pressed and held on the nurtured character list screen 180 shown in FIG. 7B, detailed information concerning the nurtured character corresponding to the nurtured character icon 182 is displayed.

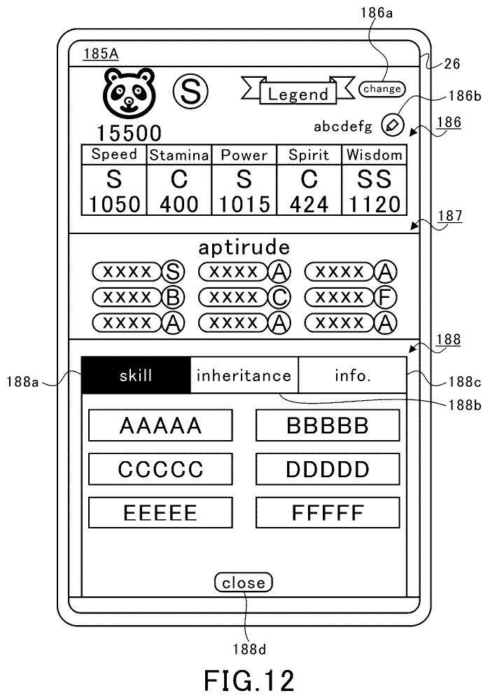

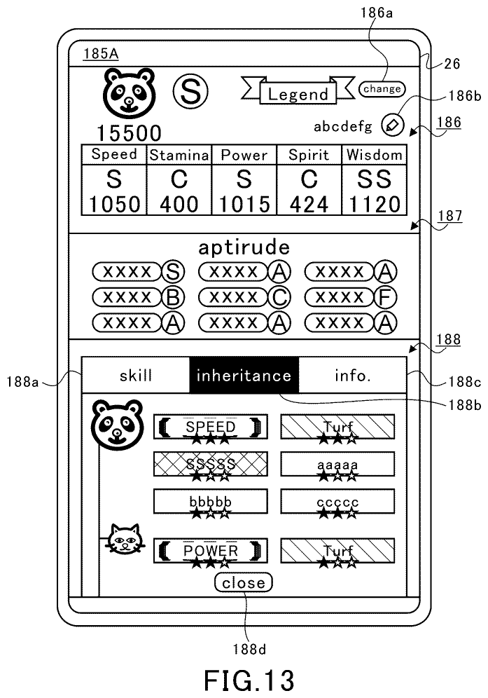

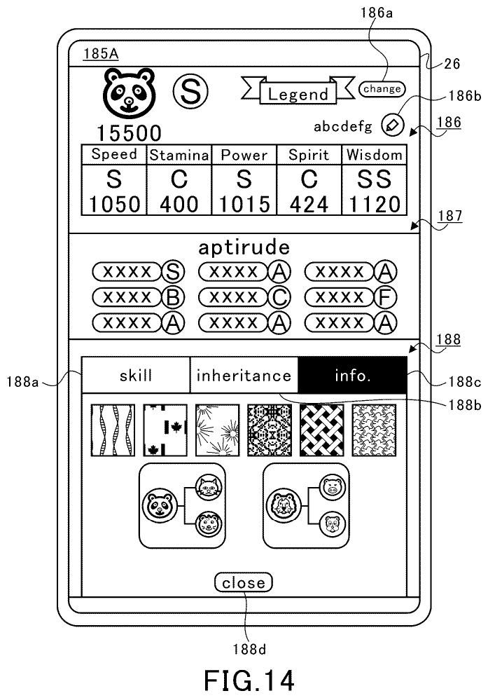

FIG. 12 is a first drawing for illustrating a character details dialog 185A. FIG. 13 is a second drawing for illustrating the character details dialog 185A. FIG. 14 is a third drawing for illustrating the character details dialog 185A. Detailed information concerning the nurtured character is displayed in the character details dialog 185A. An ability parameter display field 186 indicating the ability parameters of the nurtured character is displayed in the upper section of the character details dialog 185A.

In the upper left section of the ability parameter display field 186, an icon indicating the character on which the nurtured character is based, as well as an evaluation score and a nurturing rank of the nurtured character, is displayed. Also, in the upper right section of the ability parameter display field 186, a nickname change button 186a and a memo input button 186b are provided. When the nickname change button 186a is tapped, a nickname list screen (not shown in the figure) is displayed. The nicknames earned by the nurtured character are listed on the nickname list screen. Note that many nicknames are provided in the nurturing main game, and an earning condition is set for all nicknames.

In the nurturing main game, a nickname satisfying the earning condition thereof is granted to the nurtured character. The player can select any one of the nicknames earned by the nurtured character and set it for the nurtured character. The player can change the nickname set for the nurtured character on the nickname list screen. The currently set nickname (Legend, here) is displayed to the left of the nickname change button 186a.

Note that examples of the earning condition of a nickname include: the nurturing-target character earning a predetermined number of fans; an ability parameter or an aptitude parameter having a predetermined value or larger; a predetermined skill being earned; the number of wins in races reaching a predetermined number; and a predetermined finish place (e.g., first place) being won in a particular race.

In addition, when the memo input button 186b is tapped, a character input screen (not shown in the figure) is displayed. On the character input screen, up to nine characters can be input in, for example, hiragana, katakana, numeric characters, or Roman letters. The characters input on the character input screen are stored as a memo so as to be tied to the nurtured character. In the case where a memo is stored in the nurtured character, the memo (abcdefg, here) is displayed to the left of the memo input button 186b.

Note that the sort conditions of the nurtured character icons 182 on the nurtured character list screen 180 include the aforementioned memo. Therefore, by registering a memo so as to be tied to a nurtured character, the player can more easily find nurtured characters for use as inheritance characters.

In addition, an aptitude information display field 187 is displayed below the ability parameter display field 186. In the aptitude information display field 187, aptitude parameters related to the racetrack aptitudes (turf and dirt), aptitude parameters related to the distance aptitudes (short distance, mile, intermediate distance, and long distance), and aptitude parameters related to the running style aptitudes (pace maker, front runner, stalker, and closer) are displayed.

A various-kinds-of-information display field 188 is displayed below the aptitude information display field 187. A skill display tab 188a, an inheritance information display tab 188b, a nurturing information display tab 188c, and a close operation section 188d are provided in the various-kinds-of-information display field 188. When the skill display tab 188a is tapped, the earned skills of the nurtured character are displayed in the various-kinds-of-information display field 188, as shown in FIG. 12. In addition, when the inheritance information display tab 188b is tapped, inheritance information concerning the nurtured character is displayed, as shown in FIG. 13.

Note that the various-kinds-of-information display field 188 shows inheritance information on the basis of the nurtured character that can be set as an inheritance character and the inheritance characters used to nurture the nurtured characters. The inheritance information includes information concerning the inheritance characters used to nurture the nurtured character, factor information possessed by the nurtured character, and factor information possessed by the inheritance characters. Here, inheritance information is listed for each of the nurtured characters.

More specifically, factor information tied to the nurtured character and factor information tied to the inheritance characters of the nurtured character are displayed for each of the characters. Therefore, the player can confirm factor information possessed by each of the three characters by scrolling the various-kinds-of-information display field 188 in the up/down direction.

In the various-kinds-of-information display field 188, base ability factors, aptitude factors, and character factors are displayed in different colors. For example, the base ability factors are displayed in blue, the aptitude factors are displayed in red, and the character factors are displayed in green. Note that in the various-kinds-of-information display field 188, the race factors and the skill factors are displayed in white. In addition, stars indicating the factor level are displayed so as to be superimposed on the factor information.

Also, when the nurturing information display tab 188c is tapped, nurturing information concerning the nurtured character is displayed, as shown in FIG. 14. Note that the nurturing information includes support card types used to nurture the nurtured character, the characters of the inheritance first generation and the inheritance second generation, individual race records in the nurturing game, and furthermore the evaluation score.

Thus, the player can confirm various items of information concerning the nurtured character in the character details dialog 185A. Therefore, it becomes easier for the player to grasp information tied to the inheritance characters organized in the deck, thereby enhancing convenience to the player.

Note that when the close operation section 188d is tapped on the character details dialog 185A, the character details dialog 185A is closed, and the nurtured character list screen 180 is displayed on the display 26. In addition, as shown in FIGS. 7A, 7B, 7C, and 7D, a skill display button 172 is provided in the upper right section of the inheritance character selection screen 170 and the nurtured character list screen 180. When the skill display button 172 is tapped, the skills that may be earned due to the nurtured character temporarily selected as an inheritance character are listed.

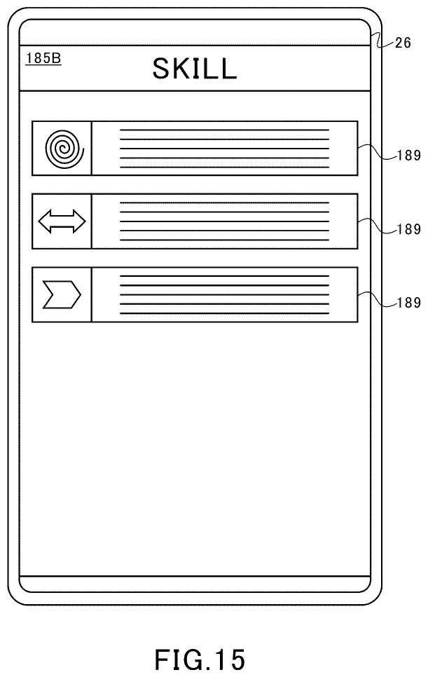

FIG. 15 is a drawing for illustrating a skill display dialog 185B. In the skill display dialog 185B, skill description display fields 189 indicating icons corresponding to skills and content of the skills are displayed. The skills listed in these skill description display fields 189 constitute all skills that may be earned by the nurturing-target character in the case where the currently selected nurtured character is used as an inheritance character.

Namely, the skill display dialog 185B lists information concerning skills tied to the character factor or skill factors possessed by the nurtured character. As shown in FIG. 7C, in the case where the skill display button 172 is tapped in a state in which one nurtured character is selected as an inheritance character, the skills tied to the character factor and race factors possessed by this one nurtured character (inheritance character) are displayed in the skill display dialog 185B.

On the other hand, in the case where the skill display button 172 is tapped in a state in which two nurtured characters are selected as inheritance characters, as shown in FIG. 7D, the skills tied to the character factor and race factors possessed by each of the two nurtured characters (inheritance characters) are displayed on the skill display dialog 185B.

As described above, in this embodiment, the character details dialog 185A lists inheritance information (factor information) for each of the nurtured characters that can be set as inheritance characters. The skill display dialog 185B also lists information (skills) tied to the inheritance information (factor information). At this time, the character details dialog 185A and the skill display dialog 185B are displayed on the basis of the nurtured character that can be set as an inheritance character and the inheritance characters used to create the nurtured character. Display of the character details dialog 185A and the skill display dialog 185B enhances convenience to the player.

Here, the present embodiment has been described by way of an example where skills that can be earned as a result of factors being invoked are displayed in the skill display dialog 185B. It should be noted, however, that factor information that allows a hint for a skill to be earned, instead of information concerning skills, may be displayed in the skill display dialog 185B. In any case, it is a good idea to classify inheritance information (factor information) into a plurality of types (factor types) and display inheritance information classified as predetermined types (character factor and race factors) or information tied to the inheritance information (information concerning skills) in the skill display dialog 185B. Thus, it can be said that an extracted portion of the inheritance information is displayed in the skill display dialog 185B.

Also, when two nurtured characters are temporarily selected, the next operation section 154 provided on the inheritance character selection screen 170 is enabled. When the enabled next operation section 154 is tapped, the temporarily selected nurtured characters are temporarily registered in the deck as inheritance characters, and a support card organization screen 190 (described below) is displayed.

Note that on the inheritance character selection screen 170, the player needs to select two nurtured characters as inheritance characters. In the case where two inheritance characters are not temporarily selected, the next operation section 154 is grayed out, as shown in FIGS. 7A and 7C, disabling a player operation from being accepted. In addition, the return operation section 153 is provided on the inheritance character selection screen 170, so that when the return operation section 153 is tapped, the nurturing-target-character selection screen 150 is displayed.

### <Registration of Support Cards>

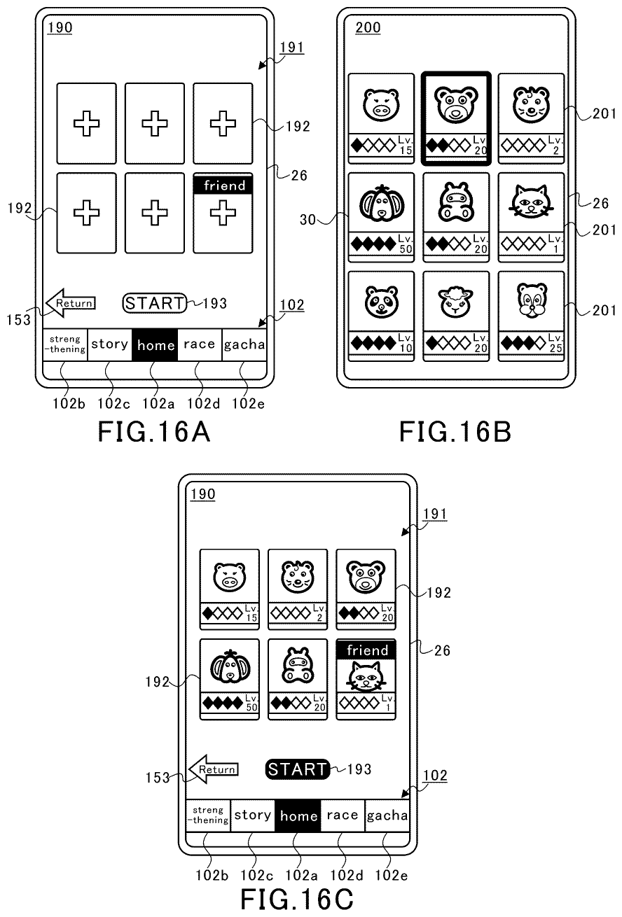

FIG. 16A is a first drawing for illustrating the support card organization screen 190. When two inheritance characters are registered on the inheritance character selection screen 170, the support card organization screen 190 shown in FIG. 16A is displayed. A support card display region 191 is provided in the center of the support card organization screen 190. The support card display region 191 includes a plurality of support card display frames 192. In addition, the return operation section 153 captioned “Return” and a start operation section 193 captioned “START” are displayed in the lower section of the support card organization screen 190.

The plurality of (six here) support card display frames 192 are displayed in the support card display region 191. The same number of support card display frames 192 as the number of support cards that can be set by the player are displayed. Note that in the initial display of the support card organization screen 190, the support card display frames 192 are displayed blank.

In this embodiment, the player can set six kinds of support cards in the deck. Note that some (e.g., five) of the six kinds of support cards that can be set by the player can be selected from among the support cards possessed by the player. In addition, some other (e.g., one) of the six kinds of support cards that can be set by the player can be selected from among the support cards that are set as rental cards by other players such as friends.

FIG. 16B is a drawing for illustrating a support card selection screen 200. When a support card display frame 192 (excluding the support card display frame 192 shown in the lower right section) is tapped on the support card organization screen 190 in FIG. 16A, the support card selection screen 200 shown in FIG. 16B is displayed on the display 26. Card icons 201 corresponding to the support cards possessed by the player are listed on the support card selection screen 200. The player can select a support card by tapping a card icon 201 displayed on the support card selection screen 200.

Although not shown in the figure, when the support card display frame 192 displayed in the lower right section of the support card organization screen 190 is tapped, support cards set as rental cards by friends or players extracted on the basis of a predetermined condition, such as a lottery, are displayed on the support card selection screen 200. At this time, the player can select one of the support cards of the friends by tapping a support card displayed on the support card selection screen 200. Thus, in the nurturing game, the player can use a support card possessed by another player.

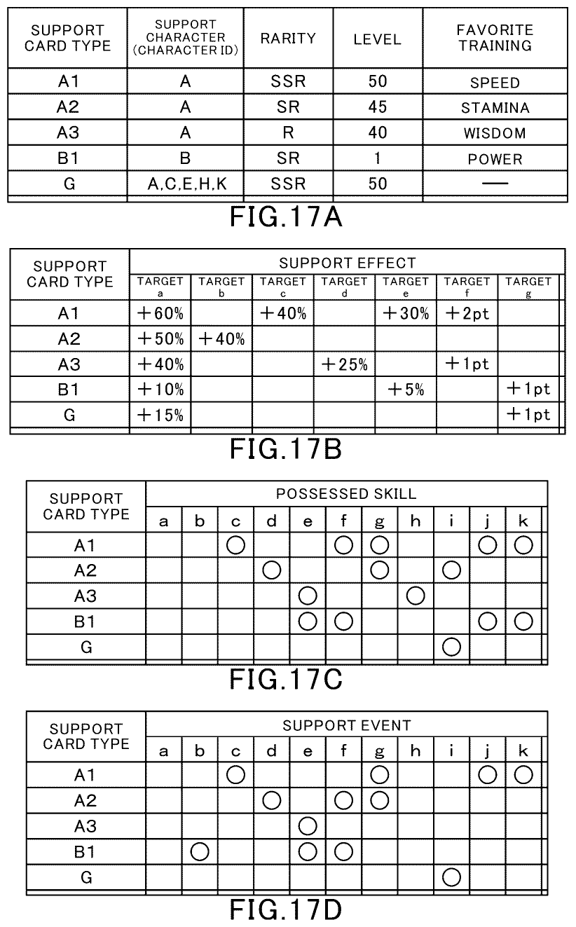

FIG. 17A is a drawing for illustrating a support card table. As shown in FIG. 17A, the support card table stores the kind of support character (i.e., character ID), rarity, level, and favorite training for each of the support card types (i.e., support card IDs) possessed by the player so as to be tied to the support card type.

Each of the support cards has at least one support character (character ID) tied thereto. In other words, at least one character ID is always tied to a support card ID. Here, a support card having one support character tied thereto and a support card having five support characters tied thereto are provided. Without limitation to this, however, a support card may have, for example, two to four or six or more support characters tied thereto.

As shown in FIG. 17A, each of the support cards of types A1, A2, and A3 has a character A tied thereto. Also, the support card of type G has five characters, i.e., characters A, C, E, H, and K, tied thereto. Hereinafter, a support card having a plurality of characters tied thereto, such as the support card of type G, may be referred to as a group support card. Here, no favorite training is set for a group support card. It should be noted, however, that a group support card may also have favorite training set therefor, just as other support cards do.

In this embodiment, a rarity is set for each of the support cards. There are three stages of rarity: R (rare), SR (super rare), and SSR (super special rare). Note that the rarity is set so that R is the lowest rarity and SSR is the highest rarity. In this embodiment, support cards with higher rarity tend to have more profound support effects, as described below. In addition, in this embodiment, support cards with higher rarity tend to have a larger number of possessed skills and support events described below.

There are 50 levels of a support card, from level 1 to level 50. The level of a support card can be increased by the player, and the level increased by the player is stored for each of the support cards. Note that the level of a support card can be increased by using in-game currency or items. Note that the maximum level of a support card is limited according to rarity.

For example, the maximum level of a support card with rarity R is defined as 20, the maximum level of a support card with rarity SR is defined as 25, and the maximum level of a support card with rarity SSR is defined as 30.

Note that the maximum level of a support card can be increased in a stepwise manner in the case where a predetermined condition is satisfied. For example, it is also acceptable that a support card with rarity R can have the maximum level thereof increased to 40, a support card with rarity SR can have the maximum level thereof increased to 45, and a support card with rarity SSR can have the maximum level thereof increased to 50.

FIG. 17B is a drawing for illustrating a support effect table. As shown in FIG. 17B, support effects for each of the support card types possessed by the player are stored in the support effect table.

Support effects work to increase various kinds of statuses in the nurturing main game. A plurality of support effect targets are provided in a support card. Examples of support effect targets include physical strength, speed, stamina, power, spirit, wisdom, etc.

FIG. 17C is a drawing for illustrating a possessed skill table. In the possessed skill table, possessed skills are set for each of the support cards possessed by the player, as shown in FIG. 17C. In this embodiment, each of the support cards has possessed skills set therefor, just as a character that can be set as a nurturing-target character has possessed skills. In the nurturing main game, the possessed skills set for each of the support cards can be possessed by the nurturing-target character when a hint event occurs.

FIG. 17D is a drawing for illustrating a support event table. As shown in FIG. 17D, support events that can occur for each of the support cards possessed by the player are stored in the support event table. A support event is an event that may occur during the execution of the nurturing main game. In the case where a support event occurs, the values of various kinds of statuses of the nurturing-target character may increase or decrease.

For example, a support event that will occur may be decided according to the turn number, or alternatively, a support event that will occur may be decided by a predetermined lottery. In addition, a plurality of support events that will occur may be selected in one turn. In any case, it suffices if a support event that will occur is decided by a predetermined decision method that has been set in advance.

Note that support events may include a first hint event that can occur when a turn is started in the nurturing game, a second hint event that can occur after the execution of training (described below) in the nurturing game, a first ability event that can occur when a turn is started in the nurturing game, a second ability event that can occur after the execution of training in the nurturing game, etc. The first hint event and the second hint event are events that enable a skill to be possessed or earned. In addition, the first ability event and the second ability event are events that increase or decrease the numerical values of ability parameters of the character. Hereinafter, the first hint event and the first ability event are collectively referred to as a first event, and the second hint event and the second ability event are collectively referred to as a second event.

FIG. 16C is a second drawing for illustrating the support card organization screen 190. In this embodiment, when all six support cards are selected, the start operation section 193 becomes enabled, as shown in FIG. 16C. On the other hand, in the case where not all six support cards have been selected, the start operation section 193 is disabled, as shown in FIG. 16A.

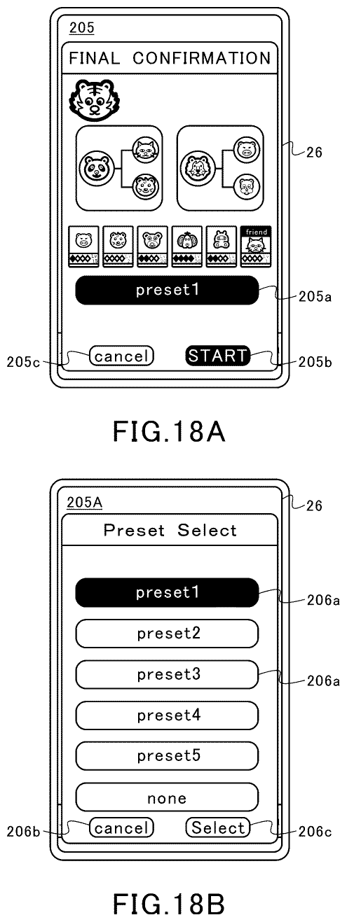

Note that when the return operation section 153 is operated on the support card organization screen 190, the inheritance character selection screen 170 shown in FIG. 7D is displayed on the display 26. Also, as shown in FIG. 16C, when the start operation section 193 is tapped on the support card organization screen 190, the support cards being selected are temporarily registered, and a final confirmation screen 205 (FIG. 18A) is displayed.

FIG. 18A is a drawing for illustrating the final confirmation screen 205. FIG. 18B is a drawing for illustrating a preset selection screen 205A. The nurturing-target character selected by the player, the nurtured characters constituting the first inheritance group, the nurtured characters constituting the second inheritance group, and the support cards are displayed on the final confirmation screen 205. A preset display section 205a is also displayed on the final confirmation screen 205. The number of the currently selected preset is indicated in the preset display section 205a.

Here, a preset is reservation information for a race in which the nurturing-target character is made to run in the nurturing main game. The player can select any race from among all races and generate a preset. The player can save a plurality of presets and can select one of the saved presets on the final confirmation screen 205. More specifically, when the preset display section 205a is tapped, the preset selection screen 205A shown in FIG. 18B is displayed.

On the preset selection screen 205A, preset reading buttons 206a corresponding to the saved presets are displayed. The player can set a preset by tapping any one of the preset reading buttons 206a and then tapping a select operation section 206c. Note that when the select operation section 206c is tapped, the preset selection screen 205A is closed, and the final confirmation screen 205 is displayed. In addition, when a cancel operation section 206b on the preset selection screen 205A is tapped, the preset selection screen 205A is displayed without changing the preset.

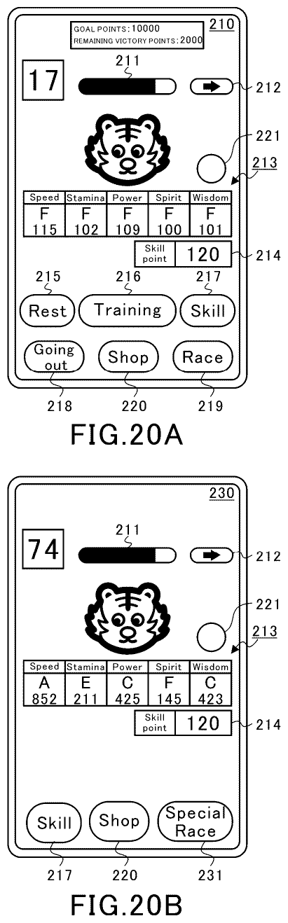

Note that when a cancel operation section 205c is tapped on the final confirmation screen 205, the support card organization screen 190 is displayed. On the other hand, when a start operation section 205b is tapped, a game screen 210 (FIG. 20A) is displayed on the display 26.

Note that this embodiment is restricted so that the character type set as the nurturing-target character and the character type set as a support character are not registered in duplicate when the support cards are registered. More specifically, characters that can be set as a nurturing-target character have character IDs tied thereto. Also, a support card always has the character ID of at least one character serving as a support character tied thereto.

Here, one nurturing-target character and six support cards are registered. In this case, no two character IDs must be the same among the character ID of the nurturing-target character, and the character IDs of the support characters. Therefore, the player cannot organize, into a deck, a support card to which the same character as the nurturing-target character is tied. Also, the player cannot organize, into a deck, a plurality of support cards having the same character tied thereto.

Furthermore, the plurality of character IDs tied to one group support card differ from one another such that no two character IDs are the same. In the case where a group support card is organized into a deck, no two of the character IDs tied to the group support card, the character ID tied to any other support card, and the character ID tied to the nurturing-target character should be the same. Thus, the player needs to organize a deck such that the character ID does not exist in duplicate among the nurturing-target character and the support characters and among the support characters.

Thus, when the nurturing-target character, inheritance characters, and support cards are registered, the preparatory-stage process ends.

### <Nurturing-Stage Process>

After the preparatory-stage process is completed, the nurturing-stage process starts. In the nurturing-stage process, the nurturing-target character can be nurtured. Note that for the sake of ease of understanding, the basic flow of the nurturing main game is described first.

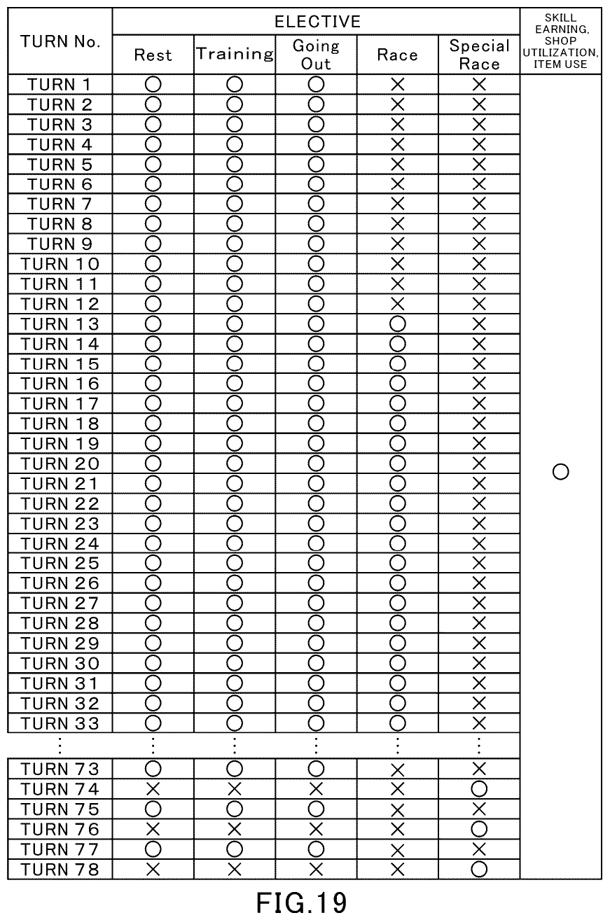

FIG. 19 is a drawing for illustrating an elective table. Note that here, a common elective table is used for all characters to be nurtured. It should be noted, however, that an elective table may be provided for each type of the nurturing-target character. As shown in FIG. 19, the nurturing game is composed of turns 1 through 78, and has gameplay in which various kinds of parameters are updated according to the results of selections made by the player in each of the turns. In addition, according to the elective table, the electives that can be selected by the player are set in advance for each of the turns.

FIG. 20A is a drawing for illustrating the game screen 210. FIG. 20B is a drawing for illustrating a special race screen 230. Upon transition to the nurturing-stage process, the game screen 210 shown in FIG. 20A is displayed on the display 26. In the upper section of the game screen 210, a physical strength display section 211 and a physical condition display section 212 are displayed. The nurturing-target character has a “physical strength” parameter. The “physical strength” parameter is mainly used to calculate a failure rate, which is the probability of failure in training, as described below. The physical strength display section 211 is displayed so that the current remaining amount of “physical strength” of the nurturing-target character can be visually grasped with respect to the upper limit of “physical strength”.

In addition, the nurturing-target character also has a “physical condition” parameter. The physical condition display section 212 is displayed so that the current “physical condition” of the nurturing-target character can be visually grasped at a plurality of stages (five stages: very bad shape, bad shape, normal, good shape, and great shape). The higher the “physical condition” parameter, the more advantageous to the nurturing-target character the proceeding of the race, and the larger the increase values of ability parameters due to training.

In addition, as shown in FIG. 20A, the image of the nurturing-target character, a status display section 213, and a skill point display section 214 are displayed in the center of the game screen 210. In the status display section 213, the current statuses of the nurturing-target character are indicated as numerical values and a plurality of ranks (16 ranks: G⁺, F, F⁺, E, E⁺, D, D⁺, C, C⁺, B, B⁺, A, A⁺, S, SS, and SS⁺). More specifically, the numerical values and ranks of the following ability parameters are displayed in this embodiment: “Speed”, “Stamina”, “Power”, “Spirit”, and “Wisdom”. In addition, the remaining amount of skill points possessed by the nurturing-target character in the nurturing game is indicated numerically in the skill point display section 214.

Also, as shown in FIG. 20A, in the lower section of the game screen 210, a rest operation section 215 captioned “Rest”, a training operation section 216 captioned “Training”, a skill operation section 217 captioned “Skill”, a going-out operation section 218 captioned “Going Out”, an individual race operation section 219 captioned “Race”, and a shop operation section 220 captioned “Shop” are displayed. In addition, the current turn number is also displayed in the upper section of the game screen 210. An item operation section 221 is also displayed in the center of the game screen 210.

As shown in FIG. 19, the player can select, in each of the turns, any of the electives including “Rest” (rest operation section 215), “Training” (training operation section 216), “Going Out” (going-out operation section 218), “Race” (individual race operation section 219), and “Special race” (special race operation section 231, described below). At this time, the electives that can be selected in each of the turns are set in advance, as shown in FIG. 19.

When the elective “Rest” is selected, the physical strength is recovered, and when the elective “Going Out” is selected, at least one of the physical strength and the physical condition increases. In addition, when the elective “Training” is selected, training (described below) can be executed, when the elective “Race” is selected, the nurturing-target character can be made to run in an individual race, and when the elective “Special race” is selected, the nurturing-target character can be made to run in a special race (described below). When these electives “Rest”, “Training”, “Going Out”, “Race”, and “Special race” are selected and game results are derived, the current turn ends and transitions to the next turn.

In this embodiment, some turns are set so as not to allow the selection of the electives corresponding to the rest operation section 215, training operation section 216, going-out operation section 218, and individual race operation section 219, as seen in the 74th turn, 76th turn, and 78th turn in FIG. 19. In these turns, the special race screen 230 is displayed on the display 26, as shown in FIG. 20B.

The special race operation section 231 captioned “Special race”, the skill operation section 217, the shop operation section 220, and the item operation section 221 are displayed on the special race screen 230, so that the player can select any of these operation sections. When the special race operation section 231 is selected, a special race, which differs from an individual race that is executed in the case where the individual race operation section 219 is selected, is executed. A total of three special races are executed, one in each of the 74th turn, 76th turn, and 78th turn, and a championship is decided on the basis of the cumulative total value of victory points (described below).

On the other hand, the skill operation section 217, the shop operation section 220, and the item operation section 221 are set so that they are always selectable in all turns. Although described below in detail, these turns do not end even if a skill is earned, a shop is used, and an item is used by operating the skill operation section 217, the shop operation section 220, and the item operation section 221, respectively.

In this embodiment, when an individual race or a special race is executed, the nurturing-target character can earn victory points and special currency according to the finish place in the race. The number of earnings of victory points and special currency for each finish place are defined in each of the races. The higher the finish place, the larger the numerical values of the victory points and the special currency to be earned.

In addition, the higher the difficulty level of a race, the more victory points and special currency the nurturing-target character can earn in the race. For example, in the grades GI, GII, and GIII, the higher the grade of a race, the more victory points and special currency the nurturing-target character can earn in the race.

In the nurturing game of this embodiment, goal points defined in advance are set for each specified turn segment. As described above, in this embodiment, a nurturing game is composed of the first turn through the 78th turn. Here, the first turn through the 24th turn are referred to as an initial turn segment, the 25th turn through the 48th turn are referred to as a mid-turn segment, the 49th turn through the 72nd turn are referred to as a late turn segment, and the 73rd turn through the 78th turn are referred to as an ending turn segment.

Goal points are set for each of the initial turn segment, mid-turn segment, and late turn segment. The goal points set for the turn segments may be the same or different. The player can proceed with the nurturing game to the ending turn segment by sequentially achieving the goal points in each of the turn segments by earning the cumulative total value of victory points.

Also, goal points are set on the basis of aptitude parameters related to the racetrack aptitude and aptitude parameters related to the distance aptitude of the nurturing-target character. For example, the goal points of a nurturing-target character having a turf aptitude parameter higher than the dirt aptitude parameter are set to be higher than the goal points of a nurturing-target character having a dirt aptitude parameter higher than the turf aptitude parameter. In addition, goal points that differ depending on, for example, the highest of the short distance, mile, intermediate distance, and long distance aptitude parameters may be set. Also, goal points that differ depending on the combination of aptitude parameters related to the racetrack aptitude and the distance aptitude may be set. Thus, the goal points set for each nurturing-target character may differ in some cases depending on aptitude parameters related to the racetrack aptitude and the distance aptitude. Note that the goal points may be set on the basis of aptitude parameters related to the running style aptitude, in addition to the racetrack aptitude and the distance aptitude, of the nurturing-target character.

In the upper section of the game screen 210 shown in FIG. 20A, goal points in the current turn segment and remaining victory points indicating the victory points that need to be earned until the goal points are reached are displayed. As a result of the goal points and the remaining victory points being displayed, the player can grasp victory points to be earned in the current turn segment.

Note that the victory points earned by the player are reset for each of the initial turn segment, the mid-turn segment, and the late turn segment. It should be noted, however, that the victory points earned by the player may be sequentially accumulated without being reset for each of the turn segments.

When the goal points are achieved in all of the initial turn segment, the mid-turn segment, and the late turn segment, the player can proceed to the nurturing game in the ending turn segment. In the ending turn segment, a total of three special races (first race, second race, and third race) are executed, and a championship is decided on the basis of the cumulative total value of victory points according to race results.

The further the special race proceeds, the larger the victory points that can be earned. More specifically, among all the three races, the value of victory points that can be earned when the first place is won in the second race is larger than the value of victory points that can be earned when the first place is won in the first race, and the value of victory points that can be earned when the first place is won in the third race is larger than the value of victory points that can be earned when the first place is won in the second race.

In addition, so-called non-player characters (hereinafter, referred to as NPCs) that run in all the three races to compete with the nurturing-target character are NPCs having the same character ID. It should be noted, however, that parameters of NPCs are set so that the further the special race proceeds, the higher the parameters of the NPCs become. For example, a correction value applied to the ability parameters of the NPCs is made to become larger in the order of the first race, the second race, and the third race, thereby enhancing the ability parameters of the NPCs in that order. Note that in the ending turn segment, even if the place in a special race is a predetermined place or lower (e.g., second place or lower), the special race can be continued without ending the nurturing game.

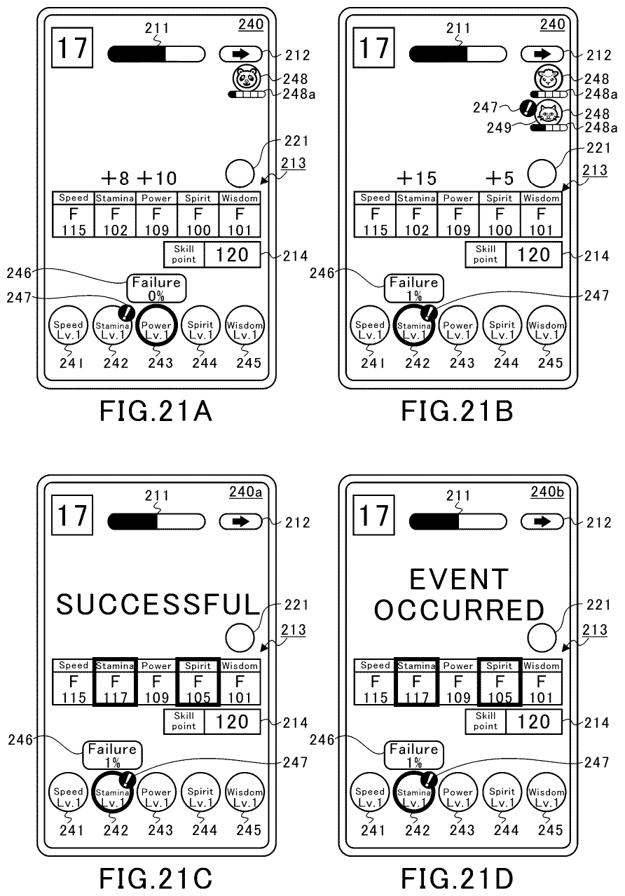

FIG. 21A is a first drawing for illustrating a training screen 240. FIG. 21B is a second drawing for illustrating the training screen 240. When the training operation section 216 on the game screen 210 is operated, the training screen 240 is displayed on the display 26.

As shown in FIG. 21A, training courses are displayed in the lower section of the training screen 240. Here, a speed operation section 241 captioned “Speed”, a stamina operation section 242 captioned “Stamina”, a power operation section 243 captioned “Power”, a spirit operation section 244 captioned “Spirit”, and a wisdom operation section 245 captioned “Wisdom” are displayed.

When the player taps one of the operation sections 241 to 245 once, the training course corresponding to the tapped one of the operation sections 241 to 245 is temporarily selected. At this time, the one of the operation sections 241 to 245 corresponding to the temporarily selected training course is highlighted. FIG. 21A shows that the power operation section 243 is temporarily selected. In addition, FIG. 21B shows that the stamina operation section 242 is temporarily selected.

Training levels for the training courses are also displayed in the respective operation sections 241 to 245. A training level is a parameter that increases on the basis of the number of times the training course is selected, and the higher the training level, the larger the increase values of ability parameters when the training is executed. A training level is initially set to level 1 and increases to a maximum of level 5.

In addition, a failure rate display section 246 captioned “Failure” is displayed in the temporarily selected one of the operation sections 241 to 245. The failure rate numerically displayed in the failure rate display section 246 is set to increase inversely proportionally to the remaining amount of physical strength displayed in the physical strength display section 211.

In addition, the status display section 213 displays the values by which the ability parameters are increased in the case where the training corresponding to the temporarily selected one of the operation sections 241 to 245 is successfully executed. For example, in the example shown in FIG. 21A, the power operation section 243 is temporarily selected, and “+8” and “+10” are displayed for “Stamina” and “Power”, respectively, in the status display section 213. In addition, in the example shown in FIG. 21B, the stamina operation section 242 is temporarily selected, and “+15” and “+5” are displayed for “Stamina” and “Spirit”, respectively, in the status display section 213.

In addition, an event report indicator 247 is displayed in any of the operation sections 241 to 245 corresponding to a training course in which a predetermined event occurs in the case where the training is successfully executed. Note that the event report indicator 247 can be displayed in different manners depending on the event type.

Here, in turns (other than the 74th, 76th, and 78th turns in which a special race is executed) of the ending turn segment, whether the support characters tied to the support cards organized in the deck are to be placed in training is decided when a turn starts. In other words, whether or not to tie a support card or a support character to a training course is decided.

Also, in the case where a support character is tied to a training course, the support character is tied to any one of the five training courses. As shown in FIG. 21B, placement character icons 248 indicating the support characters placed in the training course corresponding to the temporarily selected one of the operation sections 241 to 245 are displayed in the upper right section of the training screen 240. When a support character is placed, the increase values of ability parameters at the time the training is successful become large.

Here, a bond gauge is set for each of the support characters. A bond gauge is a value of, for example, 0 to 100. The current value of a bond gauge is visually recognizable in a bond gauge display section 248a displayed for each placement character icon 248.

A bond gauge has an initial value of 0 and a maximum value of 100. However, some support cards have a support effect set therefor for increasing the initial values of the bond gauges, such as increasing the initial values by +10. In this case, as for support characters tied to support cards having this support effect, the initial values of the bond gauges are larger than 0 from the beginning of the nurturing main game.

In addition, a bond gauge increases when an increase condition set in advance is satisfied. An example of the increase condition is training in which the support character is placed being selected (successful here). Another example of the increase condition also includes a predetermined item purchased in a shop (described below) being used or a first event or a second event (described below) occurring.

The increase values of ability parameters at the time of successful training in which a support character is placed (hereinafter, referred to as joint training) become larger as the value of the bond gauge of the placed support character becomes larger. Furthermore, friendship training may occur in joint training in which a support character is placed. When friendship training occurs, the increase values of ability parameters at the time of successful training increase by, for example, 10 to 50%.

Friendship training can occur simultaneously for a plurality of support characters. Therefore, when friendship training occurs, for example, in one turn simultaneously for a plurality of support characters, ability parameters can be greatly increased with a single session of training.

It should be noted, however, that friendship training has an occurrence condition set therefor. Although described below in detail, the occurrence condition of friendship training differs for group support cards and other support cards. The friendship training occurrence condition set for a support card other than group support cards includes the value of the bond gauge of the support character being equal to or larger than a predetermined value (e.g., 80) and the support character being placed in a predetermined training set for the support card.

Here, for support cards other than group support cards, favorite training is set as the predetermined training constituting the friendship training occurrence condition. Namely, with a support card having only one support character tied thereto, friendship training can occur only in the case where the one support character is placed in the favorite training thereof. Regarding a support card having, for example, the speed training set therefor as favorite training, friendship training can occur only in the case where the support character tied to that support card is placed in the speed training.

In contrast, a group support card to which a plurality of support characters are tied has, set therefor, a different friendship training occurrence condition from that for the other support cards. Although described below in detail, a privilege zone may be set during the nurturing main game. While this privilege zone exists, friendship training based on a group support card can occur. While a privilege zone exists, friendship training occurs, regardless of the training type in which a group support card is placed. Namely, while a privilege zone exists, friendship training based on a group support card occurs by executing training in which the group support card is placed, regardless of the training type.

Note that, as described above, a group support card has a plurality of characters tied thereto as support characters. However, it is not that each of the plurality of support characters is tied to one training course but that one group support card is tied to one training course.

Furthermore, in the case where joint training is successful, a predetermined event may occur corresponding to the character displayed on a placement character icon 248. If this is the case, an event report indicator 247 is displayed on the corresponding placement character icon 248. Hereinafter, a placement character icon 248 on which the event report indicator 247 is displayed is referred to as an event placement character icon 249.

Note that characters to be placed in training may include a character other than the support characters corresponding to the support cards registered by the player in the preparatory-stage process. For example, a character to be placed in training may be a character randomly selected by lottery from among all the support characters implemented in the game. In this case, a character icon 248 indicating a character other than the registered support characters is displayed on the training screen 240.

In addition, when joint training is executed, an event tied to a character other than the support characters registered by the player may occur. Here, the probability that an event tied to a character not registered by the player occurs is lower than the probability that an event tied to a support character registered by the player occurs. Also in this case, an event report indicator 247 may be displayed on the character icon 248 displayed on the training screen 240.

FIG. 21C is a drawing for illustrating a training result report screen 240a. When a temporarily selected one of the operation sections 241 to 245 is tapped again, the training corresponding to the tapped one of the operation sections 241 to 245 is executed. When the training is executed, the training result report screen 240a is displayed on the display 26 to report success or failure in the training. Here, the word “success” is displayed to inform the player of success in the training.

Also at this time, on the basis of the success in the training, the ability parameters in the status display section 213 are updated and displayed. Namely, the ability parameters that belong to the nurturing-target character and that correspond to the training course selected by the player are updated.

Here, the values of the ability parameters that are displayed in the status display section 213 in FIG. 21A or FIG. 21B and that will add to the ability parameters in the case where the training is successful are added. In addition, the display in the physical strength display section 211 is also updated according to the training course executed. In the case where the speed, stamina, power, or spirit training is successful, the physical strength is decreased. On the other hand, in the case where the wisdom training is executed, the physical strength is recovered.

In addition, in the case where the training fails, a predetermined penalty may be given. Specific penalties include a decrease in physical strength, a decrease in the numerical value of an ability parameter, a decrease in physical condition, etc. For example, a penalty given when the failure rate is high can be more disadvantageous (e.g., a greater decrease in the numerical value of the physical strength, a greater decrease in the numerical value of an ability parameter, or a greater decrease in the stage of the physical condition) than a penalty given when the failure rate is low.

The details of a penalty may also be decided depending on the training course. For example, a failure in speed training may result in a decrease in the value of the speed ability parameter, and a failure in power training may result in a decrease in the value of the power ability parameter. Also, for some of the training courses (e.g., wisdom), no penalty may be given even if the training fails.

FIG. 21D is a drawing for illustrating an event screen 240b. When the display of the training result report screen 240a ends, the event screen 240b may be displayed on the display 26. Various events are executed on the event screen 240b. Note that in some cases, a plurality of events may occur in one turn.

For example, in the case where a first hint event or a second hint event occurs, a hint for a skill is obtained. Once a skill is hinted, the player can earn the skill by consuming skill points. A plurality of kinds of skills are provided, and a predetermined ability may be invoked for each of the skills. Each of the skills has an invoking condition and an effect defined therefor, so that in the case where an invoking condition is satisfied, the effect defined in advance is invoked. In some cases, a skill may be invoked while an individual race or a special race is being executed, as described below.

Events include, apart from a first hint event and a second hint event for possessing skills: an event for recovering the physical strength; an event for decreasing the physical strength; a first ability event and a second ability event for increasing or decreasing ability parameters; an event for increasing the physical condition; an event for decreasing the physical condition; etc. Although described below in detail, events include an event the occurrence turn of which is defined in advance and an event that occurs in the case where a predetermined lottery is won. There are also an event occurring at the time a turn is started and an event occurring before a turn ends. When all events that have been decided to occur are completed, the game screen 210 related to the next turn is displayed.

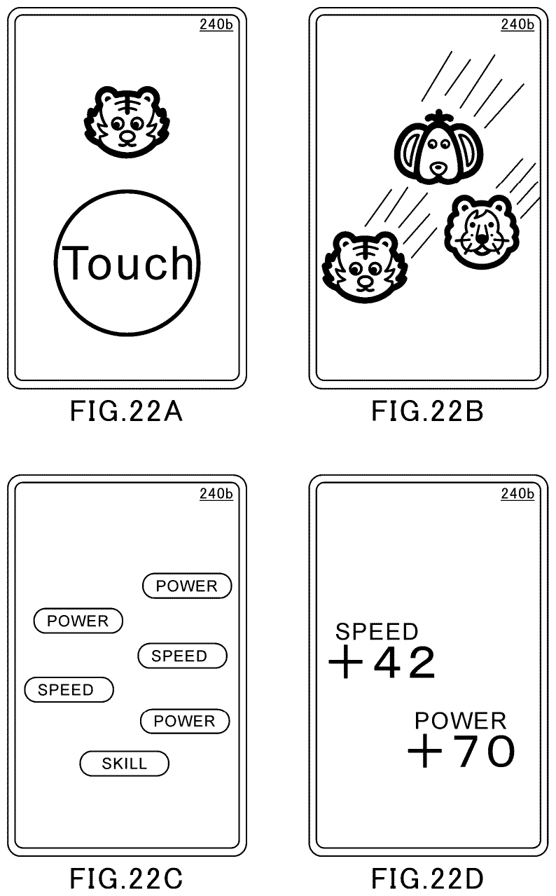

FIG. 22A is a first drawing for illustrating an inheritance event. FIG. 22B is a second drawing for illustrating an inheritance event. FIG. 22C is a third drawing for illustrating an inheritance event. FIG. 22D is a fourth drawing for illustrating an inheritance event. In the aforementioned factor-invoking turns, an inheritance event occurs when a turn is started. Note that this inheritance event is a scenario-common event (described below) and always occurs in the same turns, regardless of the scenario selected by the player. Although the first turn, the 31st turn, and the 55th turn are set as factor-invoking turns in this embodiment, a case where an inheritance event occurs in the 31st turn will be described here.

When the 31st turn is started, first the nurturing-target character and an operation section captioned “Touch” are displayed on the event screen 240b, as shown in FIG. 22A. When the operation section displayed on the event screen 240b is tapped, an animation image containing the nurturing-target character and the two inheritance characters is displayed, as shown in FIG. 22B. Also, when the operation section is tapped, a lottery for deciding whether or not to invoke every factor possessed by a total of six nurtured characters of the inheritance first generation and the inheritance second generation is drawn.

Then, the factors that have been decided to be invoked as a result of winning the lotteries for deciding whether or not to invoke the respective factors are displayed, as shown in FIG. 22C. Thereafter, the kinds of ability parameters or aptitude parameters that increase as a result of factors being invoked, as well as increase values thereof, are displayed, as shown in FIG. 22D, whereby the parameters are updated. When the inheritance event ends, the game screen 210 shown in FIG. 20A is displayed, allowing the player to select any of the electives. At this time, the increase values of the ability parameters and the aptitude parameters displayed due to the inheritance event are added in the status display section 213.

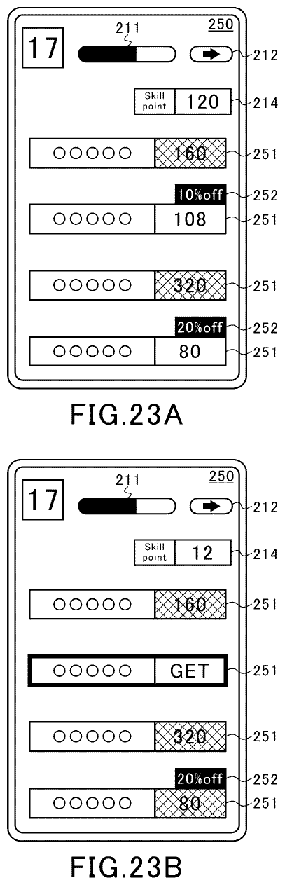

FIG. 23A is a first drawing for illustrating a skill screen 250. FIG. 23B is a second drawing for illustrating the skill screen 250. When the skill operation section 217 on the game screen 210 is operated, the skill screen 250 shown in FIG. 23A is displayed on the display 26.

Skill display fields 251 are displayed on the skill screen 250. An earned skill, a possessed skill that is set in advance for the nurturing-target character, a possessed skill that has been possessed due to the occurrence, etc. of various kinds of events, and so on are displayed in the skill display fields 251. In addition, in the case where a first hint event or a second hint event occurs for a possessed skill, skill points consumed to earn this possessed skill are discounted. Here, for a possessed skill that has been hinted, the skill points required to earn the possessed skill are displayed in terms of a discounted value. At this time, a discount rate display icon 252, which indicates the discount rate, is also displayed in the skill display field 251.

In addition, skills displayed on the skill screen 250 are also indicated with the respective skill invoking conditions and the respective effects that are produced when the skills are invoked. In addition, the physical strength display section 211, the physical condition display section 212, and the skill point display section 214 are displayed in the upper section of the skill screen 250. The current turn number is also displayed in the upper section of the skill screen 250.

When a possessed skill is earned by consuming skill points on the basis of a player operation, “GET” is displayed on the earned skill to report that the skill has been earned, as shown in FIG. 23B. Also, in the skill point display section 214, the consumed skill points are subtracted from the skill points displayed.

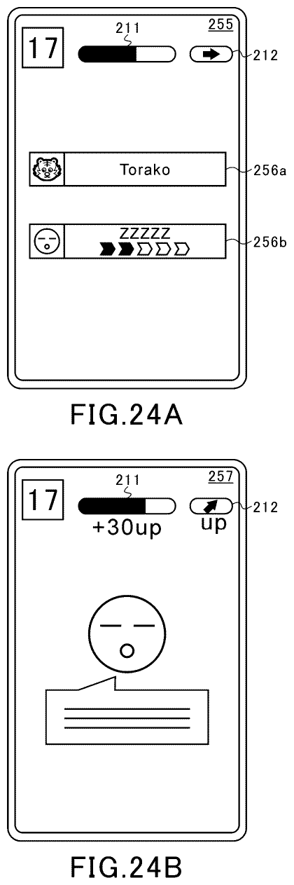

FIG. 24A is a first drawing for illustrating a going-out screen 255. When the going-out operation section 218 of the game screen 210 is operated, the going-out screen 255 shown in FIG. 24A is displayed on the display 26. Here, as an example, a nurturing-target-character selection operation section 256a and a support character selection operation section 256b are displayed on the going-out screen 255.

Here, support cards other than group support cards are classified into a normal character type and a friend character type. Support cards of the normal character type are support cards to which characters that can be set as a nurturing-target character are tied. On the other hand, support cards of the friend character type are support cards to which characters different from characters that can be set as a nurturing-target character are tied. In other words, characters that cannot be set as a nurturing-target character are tied to support cards of the friend character type. Hereinafter, characters that are tied to support cards of the friend character type and that thus cannot be set as a nurturing-target character are referred to as friend characters.

In the case where a support card of the friend character type is organized in the deck, the going-out screen 255 is displayed, as shown in FIG. 24A. The nurturing-target-character selection operation section 256a displayed on the going-out screen 255 corresponds to the nurturing-target character. When the nurturing-target-character selection operation section 256a is tapped, a solo going-out event in which the nurturing-target character goes out by itself occurs. When a solo going-out event occurs, a solo going-out screen (not shown in the figure) is displayed.

There are a plurality of (e.g., three) execution patterns of a solo going-out event. When the nurturing-target-character selection operation section 256a is tapped, an execution pattern of a solo going-out event is decided by, for example, lottery, and a solo going-out screen corresponding to the decided execution pattern is displayed. On the solo going-out screens, the nurturing-target character goes to destinations different from one another.

When a solo going-out event occurs as described above, parameters of the nurturing-target character increase. The kinds and values of parameters increased due to a solo going-out event are set for each of the execution patterns of a solo going-out event. Here, the execution patterns include: an execution pattern in which the physical condition of the nurturing-target character increases in two stages; and an execution pattern in which the physical condition of the nurturing-target character increases in one stage and the physical strength increases by a predetermined value. Note that there may be many execution patterns in which the increase values of the physical condition and the physical strength differ from one another. In addition, in the case where a solo going-out event occurs, the increase values of the physical condition and the physical strength may be decided by lottery.

FIG. 24B is a drawing for illustrating a friend going-out event screen 257. When the support character selection operation section 256b is tapped on the going-out screen 255, a friend going-out event occurs. When a friend going-out event occurs, the friend going-out event screen 257 is displayed, as shown in FIG. 24B. A friend character is displayed on the friend going-out event screen 257.

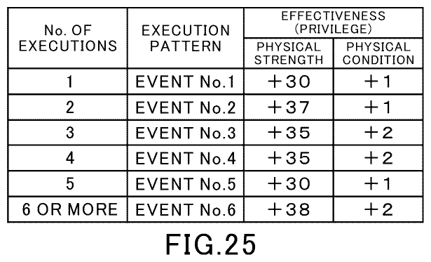

FIG. 25 is a drawing for illustrating execution patterns of a friend going-out event. Here, execution patterns of a friend going-out event are defined such that an execution pattern is decided according to the number of times a friend going-out event occurred, i.e., the number of times the nurturing-target character went out with the friend character. Furthermore, effectiveness (privilege) is defined for each of the execution patterns of a friend going-out event, as illustrated. The parameters affected by the effectiveness of this friend going-out event are the physical strength and the physical condition, just as in the case of a solo going-out event.

It should be noted, however, that the effectiveness achieved by a friend going-out event is more profound than the effectiveness achieved by a solo going-out event. Note that the effectiveness achieved by a friend going-out event and a solo going-out event is nothing more than an example. For example, the parameters affected by the effectiveness of the two events may differ from each other. Alternatively, the effectiveness of the two events may be the same. Furthermore, the effectiveness achieved by a friend going-out event may be set to be less profound than the effectiveness achieved by a solo going-out event.

As shown in FIG. 24B, the friend character tied to a support card is displayed on the friend going-out event screen 257. Also, the effectiveness achieved as a result of a friend going-out event occurring is displayed on the friend going-out event screen 257 (“+30up” and “up”, here).

Note that there are a plurality of support cards of the friend character type. On the friend going-out event screen 257, a friend character that changes depending on the support card type is displayed. In addition, the execution pattern of an occurring friend going-out event differs depending on the support card type. It should be noted, however, that the effectiveness achieved by a friend going-out event may be common or different among all support cards.

Note that the player can organize a plurality of support cards of the friend character type into the deck. In this case, the support character selection operation section 256b is provided for each of the support cards of the friend character type on the going-out screen 255.

In addition, in the case where a group support card is organized in the deck, the player can select, from among the support characters tied to the group support card, the counterpart with whom the nurturing-target character goes out. Hereinafter, the support characters tied to a group support card are referred to as belonging characters. Also, five belonging characters are tied to one group support card. These five belonging characters are referred to as a first belonging character, a second belonging character, a third belonging character, a fourth belonging character, and a fifth belonging character, respectively.

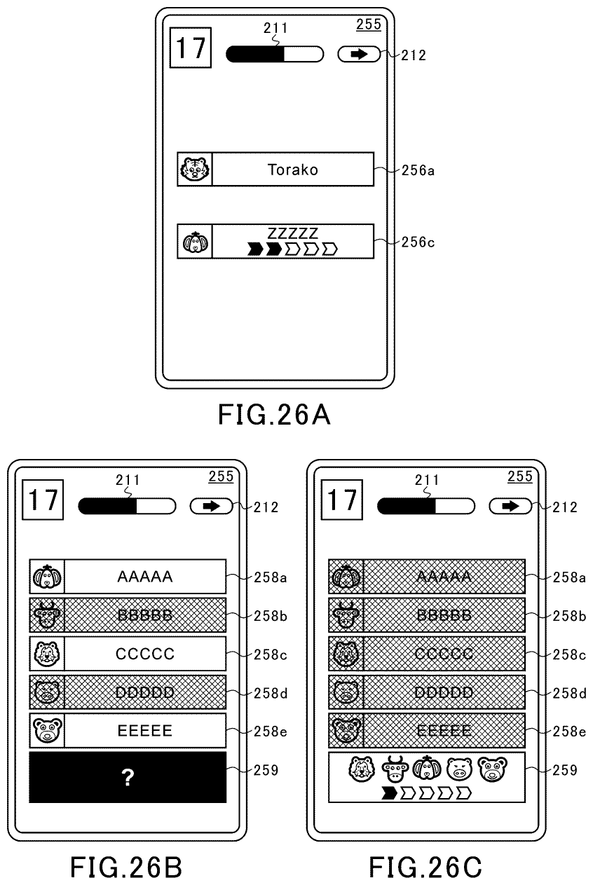

FIG. 26A is a second drawing for illustrating the going-out screen 255. FIG. 26B is a third drawing for illustrating the going-out screen 255. FIG. 26C is a fourth drawing for illustrating the going-out screen 255. FIG. 26A shows the going-out screen 255 in the case where no support cards of the friend character type are organized in the deck and a group support card is organized in the deck.

In the case where a group support card is organized in the deck, the nurturing-target-character selection operation section 256a and a group support card selection operation section 256c are displayed on the going-out screen 255, as shown in FIG. 26A. Also, when the group support card selection operation section 256c is tapped, a first belonging character selection operation section 258a, a second belonging character selection operation section 258b, a third belonging character selection operation section 258c, a fourth belonging character selection operation section 258d, a fifth belonging character selection operation section 258e, and an all-belonging-character selection operation section 259 are displayed on the going-out screen 255, as shown in FIG. 26B.

The first belonging character selection operation section 258a, the second belonging character selection operation section 258b, the third belonging character selection operation section 258c, the fourth belonging character selection operation section 258d, and the fifth belonging character selection operation section 258e correspond to the first belonging character, the second belonging character, the third belonging character, the fourth belonging character, and the fifth belonging character, respectively. On the other hand, the all-belonging-character selection operation section 259 corresponds to all belonging characters.

By tapping one of the first belonging character selection operation section 258a to the fifth belonging character selection operation section 258e, the player can select a belonging-character-specific event to be made to occur. In a belonging-character-specific event, a belonging character goes out with the nurturing-target character. It should be noted, however, that one belonging character can be selected only once in one nurturing game. In the case where the nurturing-target character went out with, for example, the second belonging character and the fourth belonging character, the second belonging character selection operation section 258b and the fourth belonging character selection operation section 258d appear grayed out, as shown in FIG. 26B. Operation sections appearing grayed out do not accept a player operation.

It should be noted, however, that the number of times each of the belonging characters can be selected is not limited to one but may be two or more. In addition, the number of times a belonging character can be selected may differ depending on the belonging character.

Furthermore, this embodiment has a specific condition set therefor for allowing the selection of the all-belonging-character selection operation section 259. Here, the specific condition is that all belonging-character-specific events have occurred, i.e., the nurturing-target character went out with all of the belonging characters. In a state in which the specific condition is not satisfied, the all-belonging-character selection operation section 259 is indicated with “?”, as shown in FIG. 26B. In this state, the all-belonging-character selection operation section 259 does not accept a player operation.

Also, when the specific condition is satisfied, all belonging characters are displayed in the all-belonging-character selection operation section 259, as shown in FIG. 26C. In this state, an operation input to the all-belonging-character selection operation section 259 is enabled. Note that the player can repeatedly select the all-belonging-character selection operation section 259. Namely, first the player needs to go out with the first belonging character to the fifth belonging character, once with each of the belonging characters. Then, after the player goes out all belonging characters once with every belonging character, the player can go out with all of the belonging characters as many times as desired.

In the all-belonging-character selection operation section 259, the number of times the all-belonging-character selection operation section 259 is selected, i.e., the number of times the player went out with any of the belonging characters, is indicated with right arrows. Note that, as described above, in the case where each of the belonging characters can be selected two or more times, it is preferable that the number of times the player went out with each of the belonging characters be also displayed in the first belonging character selection operation section 258a to the fifth belonging character selection operation section 258e, just as in the case of the all-belonging-character selection operation section 259.

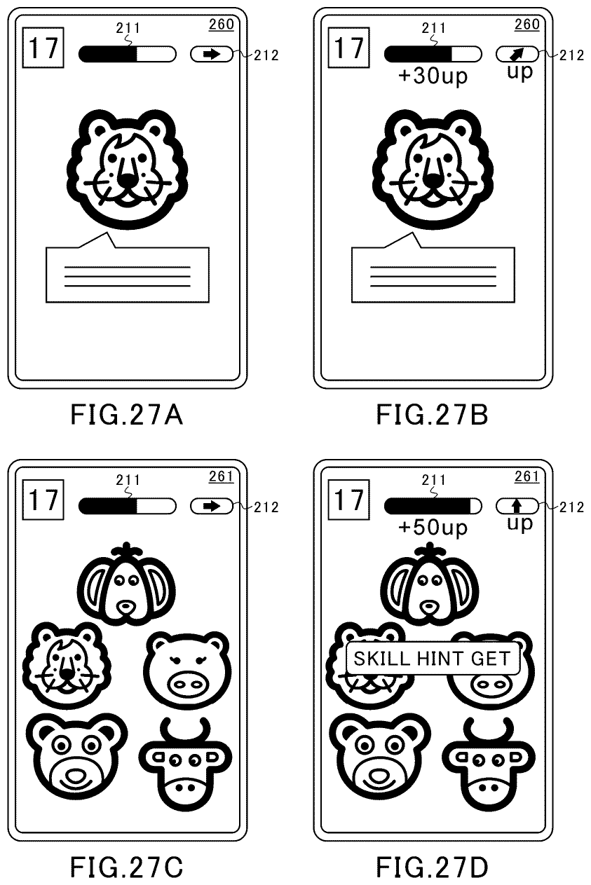

FIG. 27A is a first drawing for illustrating a belonging-character-specific event screen 260. FIG. 27B is a second drawing for illustrating the belonging-character-specific event screen 260. It is assumed that, for example, the third belonging character is selected as a result of the third belonging character selection operation section 258c being tapped. In this case, the third belonging character selected by the player is displayed on the belonging-character-specific event screen 260, as shown in FIG. 27A. In addition, the effectiveness achieved as a result of the belonging-character-specific event occurring is displayed on the belonging-character-specific event screen 260, as shown in FIG. 27B (“+30up” and “up”, here).

Note that because a plurality of belonging characters are provided, the same number of belonging-character-specific event screens 260 as the number of belonging characters are provided. Namely, the execution pattern of an occurring belonging-character-specific event changes depending on the belonging character selected by the player.

FIG. 27C is a first drawing for illustrating an all-belonging-character event screen 261. FIG. 27D is a second drawing for illustrating an all-belonging-character event screen 261. It is assumed that all belonging characters are selected as a result of the all-belonging-character selection operation section 259 being tapped. In this case, an all-belonging-character event occurs. When an all-belonging-character event occurs, the all-belonging-character event screen 261 is displayed, as shown in FIG. 27C. All the belonging characters tied to the group support card are displayed on the all-belonging-character event screen 261.

In addition, the effectiveness achieved as a result of the all-belonging-character event occurring is displayed on the all-belonging-character event screen 261, as shown in FIG. 27D (“+50up”, “up”, and “skill hint GET”, here). Here, although the embodiment has been described by way of an example where the nurturing-target character earns a skill hint as effectiveness due to an all-belonging-character event, the nurturing-target character may possess or earn a skill.

Note that, here, all the belonging characters are displayed on the all-belonging-character event screen 261. It should be noted, however, that the content of the all-belonging-character event screen 261 is not particularly limited. For example, only some of the belonging characters may be displayed on the all-belonging-character event screen 261, or alternatively, two or more belonging characters may be displayed.

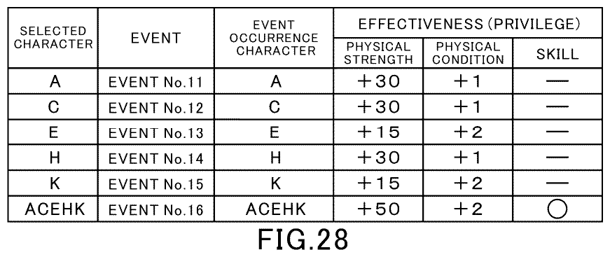

FIG. 28 is a drawing for illustrating execution patterns of belonging-character-specific events and an all-belonging-character event. With a belonging-character-specific event, the belonging character selected by the player is displayed on the belonging-character-specific event screen 260, as shown in FIG. 28. In addition, with an all-belonging-character event, all the belonging characters are displayed on the all-belonging-character event screen 261.

Furthermore, effectiveness (privilege) is defined for each of the execution patterns of belonging-character-specific events and all-belonging-character events, as illustrated. Although effectiveness that differs depending on the execution pattern is achieved here, effectiveness that is common to all execution patterns may be achieved. Moreover, when an all-belonging-character event occurs, a predetermined skill can be possessed. Here, the first time an all-belonging-character event occurs, a predetermined possessed skill is granted. Thus, the effectiveness achieved by an all-belonging-character event is more profound than the effectiveness achieved by a belonging-character-specific event. It should be noted, however, that the effectiveness achieved by an all-belonging-character event may be as profound as or less profound than the effectiveness achieved by a belonging-character-specific event.

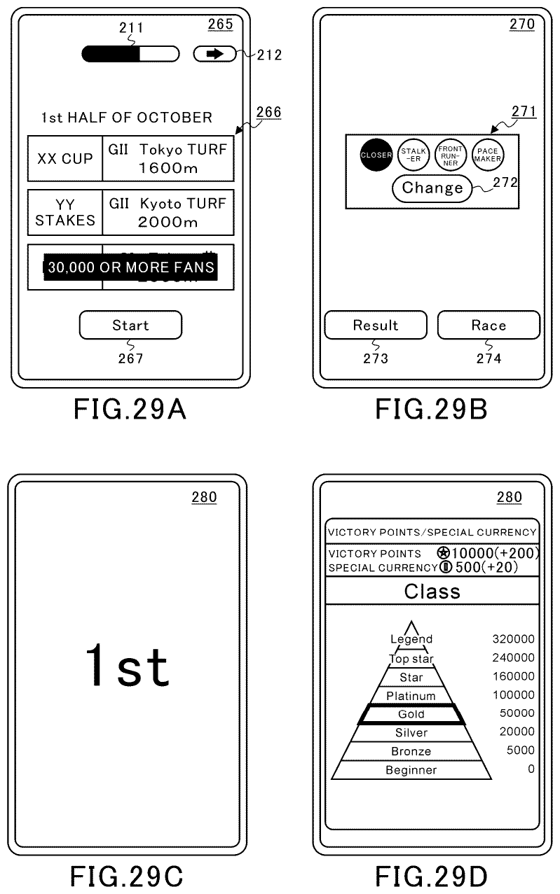

FIG. 29A is a first drawing for illustrating an individual race selection screen 265. When the individual race operation section 219 on the game screen 210 is operated, the individual race selection screen 265 shown in FIG. 29A is displayed. An individual race has gameplay in which the nurturing-target character races against NPCs.

In the upper section of the individual race selection screen 265, the physical strength display section 211 and the physical condition display section 212 are displayed. Also, an individual race selection operation section 266 for selecting a race category in which the nurturing-target character is made to run is displayed in the center of the individual race selection screen 265. In the case where a plurality of individual race selection operation sections (sub-commands) 266 are displayed on the individual race selection screen 265, individual races different from one another are set for the plurality of individual race selection operation sections 266. In addition, in the lower section of the individual race selection screen 265, a start operation section 267 captioned “Start” is displayed. Note that races that can be selected with the individual race selection operation sections 266 on the individual race selection screen 265 are set in advance for each of the turns.

In addition, each of the races has a race-participating condition set therefor in advance, so that the player is allowed to cause the nurturing-target character to run only in races satisfying the respective race-participating conditions thereof. As described above, earning a certain number of fans is specified as a race-participating condition in some races. A race-participating condition is displayed in the individual race selection operation section 266 for a race that does not satisfy the specified number of fans, as shown in FIG. 29A, thereby informing the player that the race cannot be selected. Also, in a turn having a target race serving as a clearance goal set therefor, the individual race selection screen 265 is displayed such that only the target race can be selected.

FIG. 29B is a drawing for illustrating an individual race start screen 270. When the start operation section 267 is operated while the race category of an individual race in which the nurturing-target character will run is selected in the individual race selection operation section 266, the individual race start screen 270 shown in FIG. 29B is displayed. A strategy display section 271 is displayed in the center of the individual race start screen 270. In the strategy display section 271, not only is the currently selected strategy (closer, stalker, front runner, or pace maker) highlighted but also a change operation section 272 captioned “Change” is displayed. When the change operation section 272 is operated, a strategy change screen (not shown in the figure) is displayed on the display 26. The player can change the strategy in the individual race to any strategy via an operation on the strategy change screen.

A result operation section 273 captioned “Result” and a race operation section 274 captioned “Race” are also displayed in the lower section of the individual race start screen 270.

In the case where the race operation section 274 is operated, a race screen (not shown in the figure) is displayed on the display 26. On the display 26, a video showing the proceeding of the race (hereinafter, also referred to as a race video) appears.

FIG. 29C is a first drawing for illustrating an individual race result screen 280. FIG. 29D is a second drawing for illustrating the individual race result screen 280. In the case where playback of the aforementioned race video is completed and in the case where the result operation section 273 is operated, the individual race result screen 280 is displayed on the display 26. On the individual race result screen 280, the finish place of the nurturing-target character in the individual race is displayed, as shown in FIG. 29C. On the individual race result screen 280, the current class of the nurturing-target character is also displayed, as shown in FIG. 29D.

In this embodiment, the nurturing-target character is categorized into classes according to the number of earned fans. Each of the classes has a range of the number of fans set therefor, and here, the nurturing-target character is categorized as one of eight classes according to the number of fans. The number of fans, victory points, and special currency earned in this individual race are displayed on the individual race result screen 280. In addition, the total number of fans obtained by adding the number of newly earned fans to the number of fans that were earned before is displayed on the individual race result screen 280. Also, the current class corresponding to the total number of fans is identifiably displayed. In addition, the total number of victory points obtained by adding the number of newly earned victory points to the number of victory points that were earned before and the total amount of special currency obtained by adding the newly earned special currency to the special currency that were earned before are numerically displayed on the individual race result screen 280.

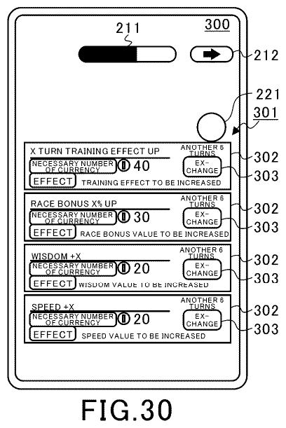

FIG. 30 is a drawing for illustrating an example of an item exchange screen 300. For example, when the shop operation section 220 on the game screen 210 shown in FIG. 20A is tapped, the item exchange screen 300 shown in FIG. 30 is displayed. By consuming special currency earned by the player on the item exchange screen 300, the player can exchange special currency for a predetermined item displayed on the item exchange screen 300. Note that on the game screen 210 shown in FIG. 20A, the total amount of special currency possessed by the player may be superimposed in the lower section of the shop operation section 220.

As shown in FIG. 30, the item operation section 221 and an item exchange list 301 are displayed on the item exchange screen 300. At least one item exchange tab 302 is displayed in the item exchange list 301.

In the item exchange tab 302, the name of an item (item name) that can be obtained by the player in exchange, the effect of the item, the amount of special currency needed to obtain the item in exchange, indication of exchange deadline, and an item exchange operation section 303 are displayed. An exchange deadline is indicated on each of the item exchange tabs 302 in the form of, for example, the number of remaining turns from the current turn to the turn in which the player can obtain the item in exchange. On the item exchange screen 300, items are replaced at regular intervals (predetermined turns). The exchange deadline for an item is the number of turns remaining before this item is replaced. Also, in item exchange, a sale may be held at a certain rate by drawing a lottery in each of the turns during the nurturing game. The period during which a sale continues is, for example, from the turn in which the sale has occurred to the turn in which the next replacement of the item is performed. During a sale period, the amount of special currency required to obtain the item in exchange is smaller than outside the sale period.

Examples of items that can be obtained by the player in exchange include: a parameter change item; a status granting item; a training level change item; a skill-hint earning item; a character re-placement item; a training effect change item; a physical strength consumption item; a failure rate change item; and an event parameter change item.

A parameter change item is an item for changing parameters of the nurturing-target character. For example, a parameter change item increases, by a predetermined value, the value of a target parameter of the nurturing-target character among speed, stamina, power, spirit, wisdom, physical strength, physical strength upper limit, physical condition, skill points, and the number of fans.

A status granting item is an item for granting a status to the nurturing-target character. For example, a status granting item grants an advantageous status or a disadvantageous status to the nurturing-target character. Examples of an advantageous status include a status for increasing the amount of increase in various kinds of parameters of the nurturing-target character, a status for decreasing the consumption of skill points needed to earn a skill, etc. In addition, examples of a disadvantageous status include a status for causing an event that decreases, etc. various kinds of parameters of the nurturing-target character to occur, a status for inhibiting an increase in various kinds of parameters, etc.

A training level change item is an item for changing the training level of each of the training courses. For example, a training level change item increases, by a predetermined value, the training level of a target training course among speed, stamina, power, spirit, and wisdom.

A skill-hint earning item is an item for allowing the nurturing-target character to possess or earn a skill by causing a skill event to occur. For example, a skill-hint earning item allows the nurturing-target character to possess or earn various skills shown in FIG. 6C.

A character re-placement item is an item for re-placing, into other training, a character placed in predetermined training, as shown in FIGS. 21A and 21B. Re-placement of a character will be described below.

A training effect change item is an item for changing a training effect resulting from training during a certain time period. More specifically, a training effect change item increases, by a predetermined value, an increase-fixed value (described below) of an ability parameter of the nurturing-target character resulting from training during a certain time period. For example, for X turns, a training effect change item increases, by X %, an increase-fixed value of an ability parameter resulting from target training among the training courses (speed, power, spirit, stamina, and wisdom).

A physical strength consumption item is an item for increasing a training effect by increasing the consumption of the physical strength in training. More specifically, a physical strength consumption item increases, by a predetermined value, an increase-fixed value (described below) of an ability parameter of the nurturing-target character resulting from training. A physical strength consumption item can increase a training increase effect when used in combination with a training effect change item.

A failure rate change item is an item for changing the failure rate of a target training course. For example, a failure rate change item decreases, by a predetermined value, the failure rate of target training among the training courses (speed, power, spirit, stamina, and wisdom).

An event parameter change item is an item for changing a parameter change value of the nurturing-target character that is granted when an event occurs after a race. For example, an event parameter change item increases, by a predetermined value, a target parameter change value among speed, stamina, power, spirit, wisdom, physical strength, physical strength upper limit, physical condition, skill points, and the number of fans of the nurturing-target character.

Examples of a training effect change item, an event parameter change item, and a parameter change item are displayed in the item exchange list 301 shown in FIG. 30. When the item exchange operation section 303 of each of the item exchange tabs 302 is tapped, the necessary amount of special currency indicated on the item exchange tab 302 are subtracted from the cumulative total value of special currency earned by the player. At the same time, the player is granted the item indicated on the item exchange tab 302.

Note that the items that can be obtained in exchange on the item exchange tab 302 include items the number of exchanges (i.e., number of purchases) of which is limited to a predetermined number or less. In the case where the number of finite items granted reaches the upper limit, the player cannot obtain the finite item in exchange even though he/she has special currency.

In addition, when the item operation section 221 is tapped, an item use screen (not shown in the figure) is displayed on the display 26. On the item use screen, the items possessed by the player are listed. The list of items includes items obtained in exchange on the item exchange screen 300. Namely, items granted to the player in exchange for special currency are displayed on the item use screen. Note that items obtained in various kinds of events may be displayed on the item use screen. The player can use various kinds of items by tapping an item displayed on the item use screen.

In this embodiment, by operating the item operation section 221, the player can use various items he/she has obtained in exchange for special currency. When each of the items is used, an icon indicating an effect currently produced as a result of the item being used may be displayed on the training screen 240 shown in, for example, FIG. 21A. At this time, the number of effect-produced turns for which an effect is produced as a result of the item being used may be additionally displayed in the lower section of the icon. Note that each of the items has an exchangeable time period set therefor, as shown in FIG. 30. The player can exchange each of the items for special currency in an exchangeable time period set for each item. Note that each of the items does not need to have an exchangeable time period set therefor.

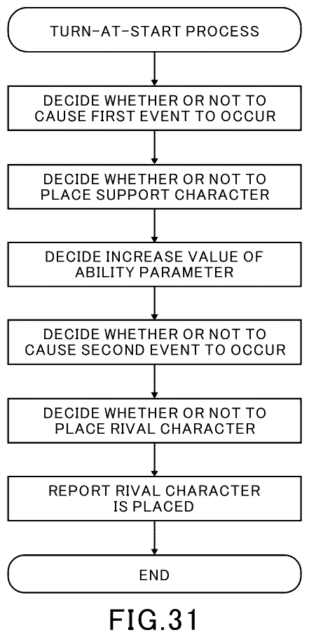

FIG. 31 is a drawing for illustrating the general flow of a turn-at-start process. The nurturing-stage process includes the turn-at-start process, which is executed at the start of each of the turns of the nurturing game. Details of the turn-at-start process are described below. Here, the general flow of the turn-at-start process will be described instead.

During the nurturing main game, a process for deciding whether or not to cause various events to occur is executed in each of the turns. Events are roughly classified into three types: a scenario event, the aforementioned character-possessed event provided for each nurturing-target character, and a support event. Note that scenario events, character-possessed events, and support events that can occur during the nurturing main game are defined in advance for each scenario.

A scenario event is an event set for each scenario of the nurturing main game. In this embodiment, a plurality of scenarios are provided, and the player can select a scenario. A scenario event occurs for each scenario selected by the player. In other words, scenario events that occur in the nurturing main game are decided on the basis of the scenario selected by the player.

Note that scenario events may include a scenario-specific event and a scenario-common event. A scenario-specific event is an event that is tied to only one scenario. For example, a scenario-specific event tied to the first scenario will occur only in the case where the first scenario is selected, and will not occur in the case where any other scenario is selected.

Also, a scenario-common event is an event that commonly occurs in a plurality of scenarios. Therefore, a scenario-common event occurs both in the case where the first scenario is selected and in the case where the second scenario is selected.

Here, it is assumed that a scenario-specific event and a scenario-common event are provided as a scenario event. It should be noted, however, that only one of the scenario-specific event and the scenario-common event may be provided.

A character-possessed event is an event that is set in advance for each character, as described above. In the nurturing main game, there occur character-possessed events of the character that has been registered by the player as the nurturing-target character in the setting game, i.e., in the preparatory-stage process.

A support event is an event that is set in advance for each support card, as described above. In the nurturing main game, there occur support events that are tied to the support cards registered by the player in the setting game. Support events include a first event that can occur at the time a turn starts and a second event that can occur after the execution of training. Whether or not a first event occurs is decided on the basis of a randomly acquired random number and a first event table when a turn is started.

Whether or not a second event occurs is decided on the basis of a randomly acquired random number and a second event table after the execution of a process for deciding a support character to be placed in training. Note that only in the case where a support character is placed in training, it is decided whether or not a second event occurs in relation to the placed support character.

This embodiment assumes that a first event is selected by lottery from among the support events tied to the support cards registered in the deck by the player in the preparatory-stage process. Without limitation to this, however, it may be possible to select a support event tied to a support card selected by lottery from among all support cards implemented in the game. In this case, it is preferable that the probability of selecting a support event tied to a support card registered in the deck is set higher than the probability of selecting a support card event tied to a support card not registered in the deck.

Thus, whether or not a scenario event occurs, etc., is decided on the basis of the scenario. In addition, whether or not a character-possessed event and a support event occur, etc. is decided on the basis of the nurturing-target character and support cards, respectively. These event types are categorized according to information that is referenced when it is decided whether or not the event occurs, etc.

In contrast, in this embodiment, each event is categorized as one of the six event classifications according to the content produced by the occurrence of the event. Here, each event is categorized as one of the following event classifications: a first hint event, a second hint event, a first ability event, a second ability event, an aptitude event, and a story event.

As described above, a first hint event and a second hint event are an event that enables a skill to be possessed or earned. In addition, a first ability event and a second ability event are an event that increases or decreases ability parameters of the nurturing-target character. An aptitude event is an event that increases or decreases aptitude parameters of the nurturing-target character. A story event is an event that displays a story related to a character appearing in the nurturing game. In addition to displaying a story, some story events change ability parameters or aptitude parameters. The aforementioned going-out events (solo going-out event, friend going-out event, belonging-character-specific event, and all-belonging-character event) correspond to story events.

In this embodiment, the turn-at-start process includes, in addition to a process for deciding a scenario event and a process for deciding a character-possessed event: a “process for deciding whether or not to cause a first event to occur”; a “process for deciding whether or not to place a support character”; a “process for deciding an increase value of an ability parameter”; a “process for deciding whether or not to cause a second event to occur”; a “process for deciding whether or not to place a rival character”; and a “process for reporting placement of a rival character”, as shown in FIG. 31. Although various other processes are executed in the turn-at-start process, the processes shown in FIG. 31 will be described in order here.

### <Process for Deciding Whether or not to Cause First Event to Occur>

A first event is selected by lottery from among the support events (first events) tied to the support cards registered by the player in the preparatory-stage process. More specifically, when a turn is started, a random number is randomly acquired, and whether or not to cause a first event to occur and the content of the first event are decided on the basis of the acquired random number and the first event table.

### <Process for Deciding Whether or not to Place Support Character>

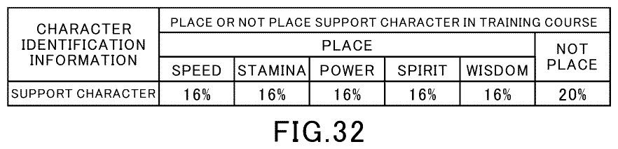

FIG. 32 is a drawing for illustrating a placement probability table. As shown in FIG. 32, the selection ratio of whether or not to place a support character in a training course (“place” or “not place” a support character in any of the training courses) is set in the placement probability table. In this embodiment, whether or not to place each of all support cards (support characters) registered by the player in the preparatory-stage process is decided on the basis of the placement probability table shown in FIG. 32.

More specifically, in this embodiment, the probability of “placing” a support character in any of the speed, stamina, power, spirit, and wisdom training courses is 16%, and the probability of “not placing” a support character in any of the training courses is 20%, as shown in FIG. 32. Note that, as described above, placement of a support card having favorite training set therefor is corrected so that the support card is more likely placed in the favorite training thereof than in other training courses.

Note that when a training course in which a support character is placed is decided, the support character decided to be placed and the decided training course may be stored in the server 1000 so as to be tied to each other. More specifically, tying information in which the training ID indicating the type of the training course is tied to the character ID of the support character or the support card ID of the support card tied to the support character may be stored in the server 1000.

### <Process for Deciding Increase Value of Ability Parameter>

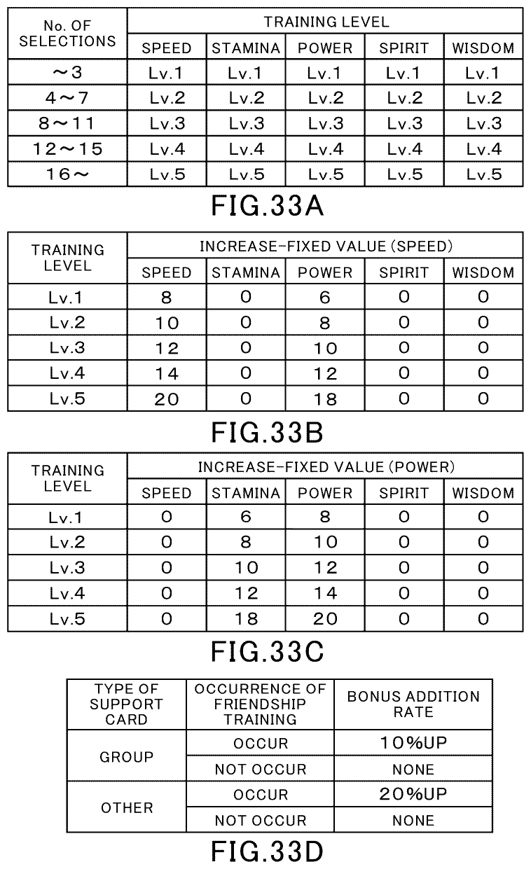

FIG. 33A is a drawing for illustrating a training level table. As shown in FIG. 33A, the training level of each of the training courses is set to increase according to the number of times the training course is selected. More specifically, each of the training levels related to “Speed”, “Stamina”, “Power”, “Spirit”, and “Wisdom” is set to “level 1” in the case where the number of times the training is selected is three or less, each of the training levels is set to “level 2” in the case where the number of times the training is selected is four to seven, each of the training levels is set to “level 3” in the case where the number of times the training is selected is eight to 11, each of the training levels is set to “level 4” in the case where the number of times the training is selected is 12 to 15, and each of the training levels is set to “level 5” in the case where the number of times the training is selected is 16 or more.

In this embodiment, in the case where the training selected by the player is successfully executed, the values of predetermined ability parameters are increased according to the executed training course.

More specifically, in this embodiment, in the case where “Speed” training is successfully executed, the values of the “Speed” and “Power” ability parameters are increased.

In addition, in the case where “Stamina” training is successfully executed, the values of the “Stamina” and “Spirit” ability parameters are increased.

Furthermore, in the case where “Power” training is successfully executed, the values of the “Stamina” and “Power” ability parameters are increased.

Also, in the case where “Spirit” training is successfully executed, the values of the “Speed”, “Power”, and “Spirit” ability parameters are increased.

In addition, in the case where “Wisdom” training is successfully executed, the values of the “Speed” and “Wisdom” ability parameters are increased.

In this embodiment, the value of an ability parameter that increases in the case where training is successful is calculated by adding, to an increase-fixed value that is decided in accordance with the executed training course and the training level, a value obtained by multiplying the increase-fixed value by a bonus addition rate described below.

FIG. 33B is a drawing for illustrating an increase-fixed value (speed) table. In addition, FIG. 33C is a drawing for illustrating an increase-fixed value table (power). Namely, FIG. 33B shows increase-fixed values in the case where the training course is “Speed”. Also, FIG. 33C shows increase-fixed values in the case where the training course is “Power”.

As shown in FIG. 33B and FIG. 33C, increase-fixed values decided corresponding to the executed training course and training level are stored in the increase-fixed value tables. In addition, in this embodiment, the higher the training level, the greater the increases in the ability parameters, as shown in FIG. 33B and FIG. 33C.

Although not described here, there are also increase-fixed value tables used in the case where “Stamina”, “Spirit”, and “Wisdom” are selected as training courses.

In addition to the aforementioned increase-fixed values, bonus addition rates are decided for each of the training courses on the basis of the placed support cards (support characters). A bonus addition rate is set in the case where the aforementioned friendship training occurs.

FIG. 33D is a drawing for illustrating bonus addition rates. In this embodiment, it is determined whether or not the friendship training occurrence condition has been satisfied for each of the support cards (support characters) that have been decided to be placed in training. Then, a bonus addition rate is decided for support cards that have been determined to satisfy the friendship training occurrence condition.

More specifically, when friendship training occurs for a group support card, the bonus addition rate is decided to be 10%. Also, the bonus addition rate is decided to be 20% for support cards other than group support cards. Note that the bonus addition rate may change depending on the support card type and the value of the bond gauge. For example, it is preferable that the larger the value of the bond gauge, the larger the bonus addition rate.

Also, a bonus addition value is derived by multiplying the increase-fixed value decided on the basis of the increase-fixed value table by the bonus addition rate. The value obtained by adding the bonus addition value to the increase-fixed value is decided to be the amount of increase in the value of the corresponding ability parameter in the case of successful training. Note that for training in which a plurality of support characters are placed, the bonus addition values for the respective placed support characters are added to the increase-fixed value. In this way, the amounts of increase in ability parameters of the nurturing-target character in the case of successful training are decided for all training types.

### <Process for Deciding Whether or not to Cause Second Event to Occur>

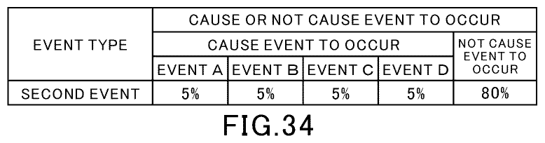

FIG. 34 is a drawing for illustrating a second event table. A second event is selected by lottery from among the support events (second events) tied to the support cards corresponding to the support characters placed in each of the training courses. More specifically, after the “process for deciding whether or not to place a support character”, a random number is randomly acquired, and whether or not to cause a second event to occur is decided on the basis of the acquired random number and the second event table. The selection ratio of whether a second event is made to “occur” or “not to occur” is set in the second event table.

For example, as shown in FIG. 34, second events tied to a predetermined support card include four types of events: event A, event B, event C, and event D. For example, in the second event table, the probability of causing each of the events (events A to D) to “occur” is set to 5%, and the probability of causing a second event “not to occur” is set to 80%. Note that the selection ratio of second events may be set individually for each of the support cards, namely, support characters.

In this embodiment, after the “process for deciding whether or not to place a support character”, a process for deciding whether or not to cause a second event to occur is executed for all support characters placed in each of the training courses. Then, on the basis of a decision as to the occurrence of a second event, an event report indicator 247 is displayed on the training screen 240.

In the case where the player selects training in which a support character whose second event is decided to occur is placed, the second event occurs after the execution of training. For example, when the speed training is executed in the case where the occurrence of a second hint event of a support character placed in the speed training is decided, the second hint event always occurs after the execution of the training.

However, when training other than the speed training is executed, this second hint event does not occur after the execution of the training. In addition, in the case where the occurrence of second events has been decided for at least two support characters placed in the same training, which of the second events is made to occur is decided by lottery or on the basis of priorities, etc. of the support events set in advance. Namely, the second event does not occur more than once in one turn.

For example, which of the plurality of second events is made to occur is decided at equal probabilities. Without limitation to this, however, weightings may be set according to the type of second event, so that which of the plurality of second events is made to occur can be decided according to the set weightings. Note that in the case where the occurrence of second events has been decided for at least two characters, all of the decided second events may be made to occur.

For example, when the occurrence of a second event is decided here, occurrence information indicating whether or not to cause a support event to occur may be stored in the server 1000 so as to be tied to the support card or the support character tied to the second event. More specifically, tying information in which occurrence information is tied to the character ID of the support character or the support card ID of the support card tied to the support character may be stored in the server 1000.

When the aforementioned “process for deciding whether or not to cause a first event to occur”, “process for deciding whether or not to place a support character”, “process for deciding an increase value of an ability parameter”, and “process for deciding whether or not to cause a second event to occur” are executed and the training operation section 216 is then operated, the training screen 240 shown in, for example, FIG. 21B is displayed on the display 26.

As described above, two kinds of placement character icons 248 that have been placed in the stamina training course through the “process for deciding whether or not to place a support character” are displayed on the training screen 240 shown in FIG. 21B.

In addition, on the training screen 240, increase values of ability value parameters decided through the “process for deciding an increase value of an ability parameter” are displayed in the status display section 213. Also, an event report indicator 247 for reporting a second event decided through the “process for deciding whether or not to cause a second event to occur” is also displayed on the training screen 240.

As described above, each of the support cards includes at least a first event and a second event as a support event. It should be noted, however, that some support cards also include other events, in addition to a first event and a second event, depending on the support card type. In this embodiment, the following events are tied to a group support card.

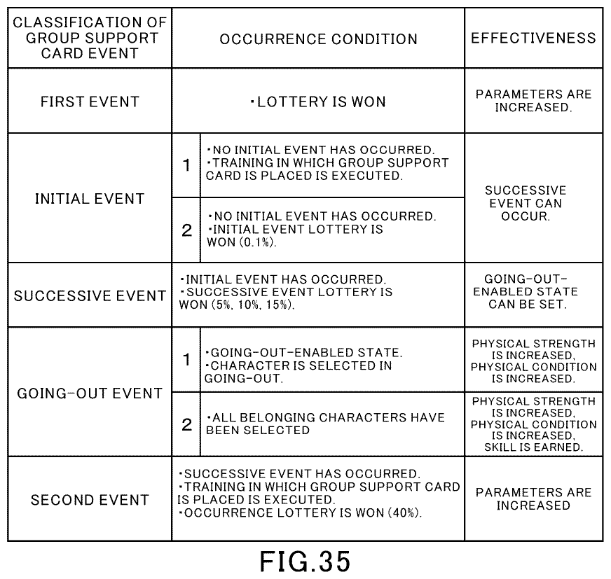

FIG. 35 is a drawing for illustrating events tied to a group support card. Events tied to a group support card are classified into a first event, an initial event, a successive event, a going-out event, and a second event. Note that an occurrence condition and effectiveness of each of the events shown in FIG. 35 are nothing more than an example.

The first event of a group support card occurs as a result of winning a lottery at the time a turn starts, just as in the case of other support cards. In the case where this first event occurs, various kinds of parameters, such as ability parameters, increase. Although not described in detail, the first event of a group support card is roughly classified into a repetitive event and a single-shot event. A repetitive event is an event that can occur multiple times in one nurturing game. A single-shot event is an event that can occur only once in one nurturing game.

The initial event of a group support card is an event that allows a successive event (described below) to occur. An initial event is provided with two occurrence conditions: a first occurrence condition and a second occurrence condition. The first occurrence condition is that no initial events have occurred and the training in which the group support card is placed is executed. The second occurrence condition is that no initial events have occurred and an initial event lottery is won.

Namely, an initial event occurs in the case where joint training in which the group support card is placed is executed or an initial event lottery is won in a state in which no initial events occur in the nurturing main game. Therefore, the initial event occurs only once in one nurturing game. Note that according to the first occurrence condition, an initial event always occurs the first time joint training is executed. In addition, an initial event lottery is drawn in every turn in a state in which no initial events occur. Furthermore, an initial event lottery is also drawn in the case where no group support cards are organized in the deck.

Note that an initial event lottery may be drawn only in the case where the group support card is organized in the deck. In addition, a group support card, even if not organized in the deck, may be placed in any training on condition that a predetermined lottery is won.

The successive event of a group support card is an event that allows setting of a going-out-enabled state, in which the nurturing-target character can go out with belonging characters tied to the group support card. The occurrence condition of a successive event is that an initial event has occurred and a successive event lottery is won. Note that, here, the winning probability of a successive event lottery differs depending on the value of the bond gauge of the group support card. For example, the winning probability of the successive event lottery is 5% if the value of the bond gauge is less than 40, 10% if the value of the bond gauge is 40 inclusive to 80 exclusive, and 15% if the value of the bond gauge is 80 or more.

Although not described in detail, a successive event is a story event, and causes the player to select one of a plurality of choices in a story. At this time, when a predetermined choice is selected, the going-out-enabled state is set thereafter until the nurturing main game being played ends.

It should be noted, however, that the content of a successive event is not limited to the above. For example, in the case where a successive event occurs, the going-out-enabled state may be always set. Furthermore, a successive event may occur repeatedly or may occur only once. In the case where a successive event can occur only once, if the player does not select a predetermined choice when a successive event occurs, the going-out-enabled state will not be set thereafter.

The going-out event of a group support card is the aforementioned belonging-character-specific event and all-belonging-character event. The occurrence condition of a belonging-character-specific event is that one of the first belonging character selection operation section 258a to the fifth belonging character selection operation section 258e of the going-out screen 255 is selected in the going-out-enabled state. Namely, a belonging-character-specific event occurs in the case where any belonging character is selected after the going-out-enabled state has been set. As a result of a belonging-character-specific event occurring, the physical strength and the physical condition of the nurturing-target character increase.

In addition, the occurrence condition set for an all-belonging-character event is that all belonging characters have been selected, i.e., the nurturing-target character went out with all the belonging characters. As a result of an all-belonging-character event occurring, the physical strength and the physical condition of the nurturing-target character increase. Also, in the case where an all-belonging-character event occurs for the first time, the nurturing-target character possesses a possessed skill.

As described above, in order to cause a going-out event of a group support card to occur, it is necessary to cause an initial event and a successive event to successively occur. Then, when the going-out-enabled state is set as a result of the occurrence of a successive event, the nurturing-target character can go out with a belonging character thereafter.

Note that, here, in order to cause a going-out event to occur, it is necessary to cause an initial event and a successive event to occur and then set the going-out-enabled state. It should be noted, however, that, for example, in the case where a group support card is organized in the deck, a going-out event tied to the group support card may be allowed to occur from the beginning of the nurturing main game or from a predetermined turn number.

The second event of a group support card has an occurrence condition different from those of other support cards. More specifically, the occurrence condition set for a second event is that a successive event has occurred, the training in which the group support card is placed has been executed, and an occurrence lottery has been won. Note that the occurrence condition may include the going-out-enabled state being set, instead of, or in addition to, a successive event having occurred. As a result of a second event occurring, various kinds of parameters, such as ability parameters, increase. Just as the first event, the second event is also roughly classified into a repetitive event and a single-shot event.

As described above, support events of a group support card include an initial event, a successive event, and a going-out event, unlike other support cards. Also, the going-out event includes a belonging-character-specific event provided for each of the belonging characters, so that the player can select any one of the belonging-character-specific events. Because of this, the player can display his/her favorite belonging character in a belonging-character-specific event. In particular, a plurality of belonging characters are tied to a group support card. For this reason, despite a limit being imposed on the number of support cards that can be organized in the deck, it becomes possible to display a larger number of characters. This ensures that game proceeding becomes more diverse, thereby enhancing the desire to play a game.

In addition, when the nurturing-target character goes out with all the belonging characters, an all-belonging-character event can occur. This motivates the player to cause all belonging-character-specific events to occur, further enhancing the pleasure of the game.

Furthermore, in this embodiment, a privilege zone (privilege segment) can be set on the basis of a group support card. While a privilege zone exists, the player can proceed with the nurturing game advantageously. A privilege zone will be described below.

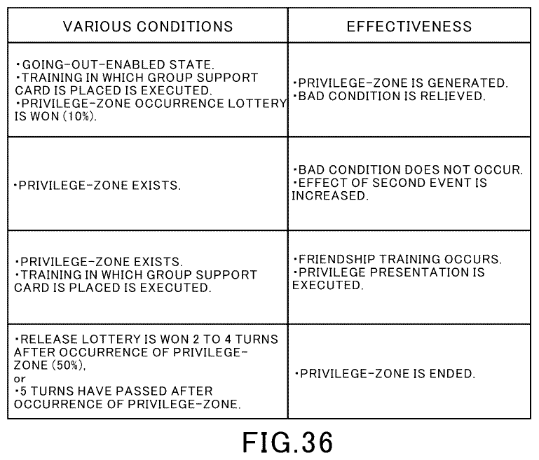

FIG. 36 is a drawing for illustrating a privilege zone. In the case where the going-out-enabled state is set, when training in which a group support card is placed is executed, a privilege-zone occurrence lottery is drawn. When the privilege-zone occurrence lottery is won, a privilege zone occurs. It should be noted, however, that no privilege-zone occurrence lottery is drawn while a privilege zone exists. Therefore, it can be said that non-existence of privilege zone also constitutes an occurrence condition of a privilege zone.

Here, in the case where joint training in which a group support card is placed is executed after the going-out-enabled state has been set, a privilege zone occurs at a probability of 1/10. A privilege zone occurs in the turn subsequent to a turn in which joint training tied to a group support card is executed. When a privilege zone occurs, effectiveness is achieved to relieve the nurturing-target character of a bad condition. Although not described in detail, a bad condition is a state that is set for the nurturing-target character to cause the nurturing main game to proceed disadvantageously.

Note that a privilege zone is basically set assuming that a group support card is organized in the deck. It should be noted, however, that even in the case where no group support cards are organized in the deck, an initial event occurs when an initial event lottery is won, subsequently allowing a successive event to occur and the going-out-enabled state to be set, as described above. Thus, in the case where the going-out-enabled state is set and a group support card not organized in the deck is placed, there is a possibility that a privilege zone occurs. Although the winning probability of the privilege-zone occurrence lottery is 10% here, the winning probability can be set as appropriate.

Also, while a privilege zone exists, effectiveness, such as preventing the nurturing-target character from being placed into a bad condition and further enhancing the effect of increasing ability parameters, etc. due to the occurrence of a second event, is achieved. In addition, when training in which a group support card is placed is executed while a privilege zone exists, friendship training based on the group support card occurs, further enhancing the effect of increasing ability parameters, etc. Furthermore, at this time, a privilege presentation that occurs only while a privilege zone exists is executed. In other words, occurrence of friendship training and an increase in training effect are reported as a result of occurrence of a privilege presentation.

A privilege zone has an end condition, so that the setting of the privilege zone is released when the end condition is satisfied. The end condition set here is that: a release lottery is won; and five turns pass after the occurrence of the privilege zone. A release lottery is drawn two to four turns after the occurrence of the privilege zone. Therefore, the privilege zone continues to exist for a maximum of five turns and ends after at least one turn.

Note that although the winning probability of a release lottery is 50% here, the winning probability can be set as appropriate. Furthermore, the release lottery is not essential. For example, only the number of turns remaining until the end of a privilege zone may be provided as the end condition of the privilege zone.

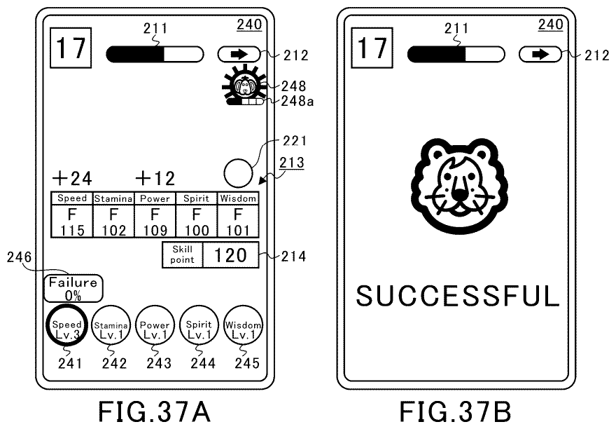

FIG. 37A is a drawing for illustrating the placement character icon 248 of a group support card. FIG. 37B is a drawing for illustrating a privilege presentation. Although a plurality of belonging characters are tied to a group support card as described above, there is only one kind of placement character icon 248 corresponding to the group support card. Here, the first belonging character is displayed on the placement character icon 248 corresponding to the group support card.

Also, when a group support card is placed in training while a privilege zone exists, friendship training based on the group support card can occur by selecting and executing the training in which the group support card is placed. At this time, friendship training can occur in any of the training courses. In a state in which friendship training can occur, the placement character icon 248 is highlighted by effect, as shown in FIG. 37A. FIG. 37A shows a case where a group support card is placed in the speed training. At this time, increase values of ability parameters in the case of successful speed training are displayed near the status display section 213. Here, increase values counting the bonus addition values resulting from the occurrence of friendship training are displayed.

Also, when the speed training is selected in the state shown in FIG. 37A, friendship training based on the group support card occurs. At this time, a privilege presentation is executed when training is successful. In the privilege presentation, a belonging character is displayed as shown in FIG. 37B, reporting successful training.

Here, there are a plurality of execution patterns of privilege presentation. In this embodiment, an execution pattern of privilege presentation is provided for each of the belonging characters. Because five belonging characters are tied to one group support card, there are five execution patterns of privilege presentation. In each of the execution patterns, one belonging character is always displayed, and voice of the belonging character is output.

In the case where friendship training based on a group support card occurs, an execution pattern of privilege presentation is decided by lottery. That is, in the case where friendship training (privilege event) occurs, any one of the plurality of belonging characters tied to the group support card (predetermined game medium) is decided to be a character to be displayed in the privilege presentation. By doing so, the decided belonging character is displayed in the privilege presentation.

It should be noted, however, that an execution pattern of privilege presentation may be selected not by lottery but according to, for example, the order set in advance. Also, although an execution pattern of privilege presentation is provided for each of the belonging characters here, only execution patterns of privilege presentation corresponding to some of the belonging characters may be provided. Alternatively, an execution pattern of privilege presentation in which a plurality of belonging characters are displayed may be provided.

As described above, in a privilege presentation, any of the plurality of belonging characters is displayed. Because of this, despite a limit being imposed on the number of support cards that can be organized in the deck, game proceeding becomes more diverse, thereby enhancing the pleasure of the game. In addition, while a privilege zone exists, a presentation that is different from the one while no privilege zone exists can be executed as a privilege presentation, which grants a privilege such as enhancement in the increase values of parameters. This further enhances the pleasure of the game.

### <Process for Deciding Whether or not to Place Rival Character>

In the turn-at-start process, whether or not to place a rival character is decided. A rival character is an NPC that appears in an individual race and competes with the nurturing-target character for a win in the individual race. A rival character is constituted from a character having the same character ID as a normal NPC that appears in a normal individual race in which no rival characters appear (hereinafter, referred to as a normal NPC).

It should be noted, however, that a rival character is a character having higher parameters than a normal NPC. For example, a rival character has ability parameters a predetermined number times (e.g., 1.1 times) the values of ability parameters of a normal NPC having the same character ID. For this reason, an individual race in which a rival character appears has basic gameplay in which the rival character and the nurturing-target character compete for a place (first place).

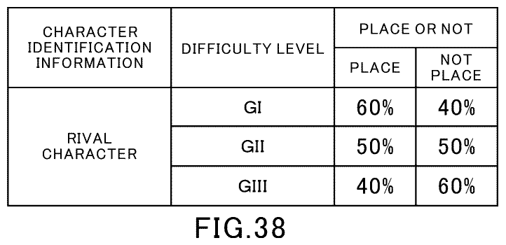

FIG. 38 is a drawing for illustrating a placement probability table. As shown in FIG. 38, the selection ratio of whether or not to place (“place” or “not place”) a rival character is set in the placement probability table. In this embodiment, whether or not to place a rival character is decided on the basis of the placement probability table shown in FIG. 38.

In this embodiment, the placement of a rival character is performed in the case where the individual races that occur in the current turn include a race in which the current aptitude parameters pertaining to the racetrack aptitude and the distance aptitude of the nurturing-target character are equal to or larger than a predetermined value (e.g., C or higher). Therefore, in the “process for deciding whether or not to place a rival character”, first it is determined whether or not the individual races (race categories) that occur in the current turn include a race in which the current aptitude parameters pertaining to the racetrack aptitude and the distance aptitude of the nurturing-target character are equal to or larger than a predetermined value (hereinafter referred to as a “suitable race”).

As shown in FIG. 38, in this embodiment, the selection ratio of a rival character differs depending on the difficulty level of the suitable race. More specifically, as shown in FIG. 38, in the case where the difficulty level (grade) of the suitable race is GI, a rival character “being placed” is selected at a probability of 60%, and a rival character “not being placed” is selected at a probability of 40%.

In addition, in the case where the difficulty level (grade) of the suitable race is GII, a rival character “being placed” is selected at a probability of 50%, and a rival character “not being placed” is selected at a probability of 50%. Also, in the case where the difficulty level (grade) of the suitable race is GIII, a rival character “being placed” is selected at a probability of 40%, and a rival character “not being placed” is selected at a probability of 60%. It should be noted, however, that the selection ratio of a rival character does not need to differ depending on the difficulty level of the suitable race. For example, the selection ratio of a rival character may be uniform regardless of the difficulty level of the suitable race.

When the placement of a rival character is decided, the type (character ID) of the rival character to be placed is randomly selected by lottery. At this time, one character is randomly selected by lottery as a rival character from among the characters whose aptitude parameters pertaining to the racetrack aptitude and the distance aptitude are equal to or larger than a predetermined value (e.g., C or higher) with respect to the racetrack, such as turf and dirt, and the distance, such as short distance, mile, intermediate distance, and long distance, set for the suitable race. It should be noted, however, that in the case where there are multiple suitable races in a turn, rival characters are randomly selected by lottery such that the same rival character (character ID) is not selected in duplicate among the multiple suitable races. In addition, the random selection of a rival character by lottery is performed excluding the nurturing-target character to be nurtured.

Here, parameters of the rival character may be changed according to the difficulty level of the suitable race. For example, the rival character may have higher parameters as the difficulty level of the suitable race increases. Alternatively, the parameters of the rival character may be constant values regardless of the difficulty level of the suitable race.

The parameters of the rival character are set higher as the turn in the nurturing game proceeds. More specifically, the parameters of the rival character may be set higher in the order of the initial turn segment, mid-turn segment, and late turn segment. More specifically, ability parameters of the rival character are 1.1 times the ability parameters of a normal NPC with the same character ID in the initial turn segment, ability parameters of the rival character are 1.3 times the ability parameters of a normal NPC with the same character ID in the mid-turn segment, and ability parameters of the rival character are 1.5 times the ability parameters of a normal NPC with the same character ID in the late turn segment.

When the nurturing-target character runs in the suitable race, a basic reward is granted to the player. In addition to the basic reward, an additional reward is granted to the player when the nurturing-target character wins against the rival character in the suitable race. However, an additional reward may be granted when the nurturing-target character runs in a suitable race, regardless of whether he/she wins against or loses to the rival character. A basic reward is a reward that can be obtained by the player regardless of whether the nurturing-target character wins against or loses to the rival character. An additional reward is granted to the nurturing-target character separately from the basic reward and is, for example, a skill hint related to the racetrack of the suitable race, a skill hint related to the distance of the suitable race, and a skill hint related to the running style of the nurturing-target character.

An additional reward may also be a reward that displays a predetermined event on the display 26. In the predetermined event, the rival character is displayed, for example. Additional rewards also include a skill hint and a parameter that are tied to the nurturing-target character. This skill hint may be decided on the basis of parameters, such as the racetrack aptitude, distance aptitude, running-style aptitude, etc., of the nurturing-target character.

### <Process for Reporting Placement of Rival Character>

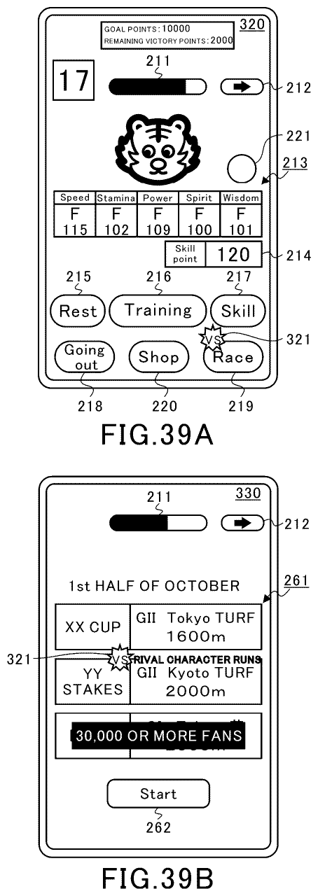

FIG. 39A is a drawing for illustrating the reporting of placement of a rival character on a game screen 320. FIG. 39B is a drawing for illustrating the reporting of placement of a rival character on an individual race selection screen 330.

When the placement of a rival character is decided through the “process for deciding whether or not to place a rival character”, a rival character report indicator 321 is superimposed in the individual race operation section 219 on the game screen 320, as shown in FIG. 39A.

When the individual race operation section 219 indicated with the rival character report indicator 321 is tapped, the individual race selection screen 330 shown in FIG. 39B is displayed on the display 26. Among the race categories in the individual race selection operation sections 266 on the individual race selection screen 330, the race categories (suitable races) in which a decision has been made to place a rival character have a rival character report indicator 321 captioned “rival character running” superimposed thereon.

Although this embodiment has been described by way of an example where the rival character report indicator 321 shown in FIGS. 39A and 39B is displayed on the display 26 in the case where the placement of a rival character is decided, the present invention is not limited to this embodiment. The rival character report indicator 321 may include, for example, text or an image that allows the kind of the rival character to be identified.

In this embodiment, a bonus event occurs in the case where the nurturing-target character achieves a predetermined condition when the last turn of each of the initial turn segment, mid-turn segment, and late turn segment is ended. The predetermined condition includes, for example, the victory points exceeding the goal points by a certain amount, the first place in a race of a predetermined difficulty level (e.g., GI) being won a predetermined number of times or more, the nurturing-target character winning against the rival character a predetermined number of times or more, etc.

Bonus events include a low bonus event and a high bonus event, and the type of bonus event that will occur changes according to the achievement of the predetermined condition. A low bonus event is, for example, an event that levels up a unique skill set for the nurturing-target character. A high bonus event is, for example, an event that increases a parameter of the nurturing-target character by a predetermined value and skill points by a predetermined value, in addition to an event that levels up a unique skill set for the nurturing-target character.

In this embodiment, a low bonus event occurs in the case where only a basic condition of the predetermined condition is achieved, and a high bonus event occurs in the case where an additional condition, in addition to the basic condition, of the predetermined condition is achieved. The content of a high bonus event changes on the basis of the type of turn segment.

For example, in the case where the type of turn segment is the initial turn segment, a high bonus event that will occur levels up a unique skill set for the nurturing-target character, increases, by a predetermined value (e.g., +10), one kind of parameter randomly selected from among the parameters of the nurturing-target character, and increases skill points by a predetermined value (e.g., +20).

Also, in the case where the type of turn segment is the mid-turn segment, a high bonus event that will occur levels up a unique skill set for the nurturing-target character, increases, by a predetermined value (e.g., +5), all parameters of the nurturing-target character, and increases skill points by a predetermined value (e.g., +30).

Also, in the case where the type of turn segment is the late turn segment, a high bonus event that will occur levels up a unique skill set for the nurturing-target character, increases, by a predetermined value (e.g., +10), all parameters of the nurturing-target character, and increases skill points by a predetermined value (e.g., +30).

In this embodiment, apart from a bonus event that occurs at the end of a turn segment described above, a bonus event also occurs in the case where the nurturing-target character achieves a special condition. The special condition is, for example, the nurturing-target character winning the first place in a specific race among the individual races. More specifically, the special condition includes winning the first place a predetermined number of times in an individual race in which a specific racetrack and a specific distance are set, winning the first place a predetermined number of times in an individual race in a specific region, winning the first place in a particular race among GI races with a high difficulty level, etc. A bonus event is, for example, an event that increases parameters of the nurturing-target character by a predetermined value.

In the aforementioned nurturing main game, the nurturing game ends when all turns are completed. In the case where, in the course of the nurturing main game, the player fails to achieve the goals set for each character or the goal points set for each of the specified turn segments, the nurturing game ends at that point.

Here, when the nurturing game ends, the nurturing-target character that has been nurtured in the nurturing game is stored as a nurtured character. More precisely, information concerning the nurtured character that has been nurtured in the nurturing game (hereinafter, referred to as “nurtured character information”) is stored so as to be tied to the player ID. Note that the nurtured character information is stored in both the player terminal 1 and the server 1000. Nurtured character information stored so as to be tied to the player ID includes ability parameters, aptitude parameters, earned skills, inheritance information, etc.

In addition, when the nurturing game ends, an evaluation score of the nurtured character that has been nurtured is calculated. Here, an evaluation score is calculated on the basis of the ability parameters, aptitude parameters, earned skills, individual race records, etc. as of the end of the nurturing game. Note that the method of calculating the evaluation score, in other words, a calculation formula for obtaining the evaluation score, is prepared in advance, and the evaluation score is calculated on the basis of the predetermined calculation formula. Note that the method and calculation formula for calculating the evaluation score are not particularly limited. For example, an evaluation score may be calculated on the basis of only parameters that affect the result of a race in a team competition game or another race game when the nurtured character runs in the race, such as ability parameters, aptitude parameters, earned skills, etc. as of the end of the nurturing game.

In addition, a nurturing rank is set for the nurtured character on the basis of the evaluation score. The nurturing rank is an indicator of the strength of the nurtured character, and each nurturing rank is tied to a range of evaluation scores. For example, a nurtured character with an evaluation score between 13000 and 14499 is assigned an “A+” nurturing rank, and a nurtured character with an evaluation score between 14500 and 15499 is assigned an “S” nurturing rank. In this way, it is easier to understand the general strength of a nurtured character as a result of a nurturing rank being assigned on the basis of the evaluation score. Note that the evaluation score and the nurturing rank are also included in the nurtured character information.

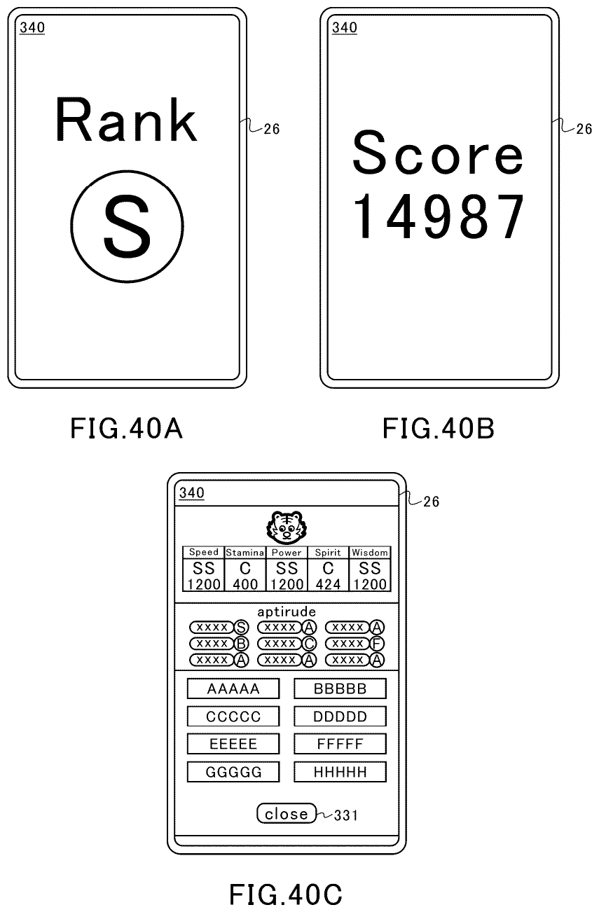

FIG. 40A is a first drawing for illustrating a nurturing completion screen 340. FIG. 40B is a second drawing for illustrating the nurturing completion screen 340. FIG. 40C is a third drawing for illustrating the nurturing completion screen 340. When the nurturing game is completed, the nurturing completion screen 340 is displayed on the display 26, as shown in FIG. 40A. On the nurturing completion screen 340, the nurturing rank of the nurtured character that has been nurtured is displayed first, followed by the display of the evaluation score as shown in FIG. 40B.

In addition, a predetermined amount of time after the display of the evaluation score, the ability parameters, aptitude parameters, and earned skills of the nurtured character are displayed on the nurturing completion screen 340, as shown in FIG. 40C. At this time, a close operation section 331 is provided on the nurturing completion screen 340. When the close operation section 331 is tapped, the nurturing completion screen 340 is hidden, and the home screen 100 is displayed on the display 26.

When the nurturing game is completed, a lottery is drawn for factors to be earned by the nurturing-target character, and the factor information is stored so as to be tied to the nurtured character. Although not shown in the figure, the player can display the factor information earned by the nurtured character on the nurturing completion screen 340.

Here, in this embodiment, a time-limited event is held on an irregular basis, as described above. When the aforementioned nurturing game is played while a time-limited event is being held, the player is granted event points. More specifically, when the nurturing game is completed, event points are calculated according to a calculation condition set in advance. Note that even in the case where the nurturing game ends partway, i.e., even in the case where the player retires form the nurturing game, event points may be calculated on the basis of ability parameters, etc. at that time. While a time-limited event is being held, event points earned by the player are accumulated.

In addition, in a time-limited event, rewards, such as items and in-game currency, are tied to the value of event points. Each time the cumulative total value of event points earned by the player reaches a predetermined value, rewards are granted to the player.

Event points are roughly classified into base points and bonus points. Base points are calculated according to a calculation condition mainly based on results of the nurturing game, such as the evaluation score, earned skills, nickname, and the number of wins in races. Bonus points are points calculated by multiplying a predetermined factor by the base points. Here, bonus points are calculated on the basis of characters possessed by the player, more strictly, character cards to which the characters (character IDs) are tied, support cards possessed by the player, and a rental support card organized in the deck. Calculation of bonus points will be described below in detail.

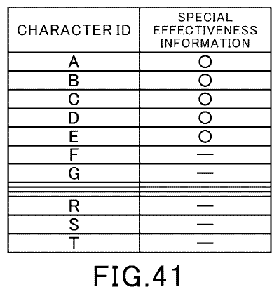

FIG. 41 is a drawing for illustrating special effectiveness information. In a time-limited event, special effectiveness characters are set for the nurturing game. A plurality of kinds of time-limited events are provided, and any of the time-limited events is held on an irregular basis. Special effectiveness characters are set for each of the kinds of time-limited events. As described above, the player possesses characters that can be set as a nurturing-target character. More specifically, the player can possess a plurality of character cards to which characters (character IDs) that will serve as a nurturing-target character are tied. The player can possess a character card won by lottery that is drawn by consuming in-game currency. Furthermore, a character card may be distributed to the player by the game administrator for free or for a fee.

A character card has a character ID tied thereto, just as a support card does. In the preparatory-stage process of the nurturing game, the player selects a character card. At this time, the character with the character ID tied to the character card selected by the player serves as a nurturing-target character.

When a time-limited event is held, special effectiveness information data is stored in the player terminal 1 and the server 1000. In the special effectiveness information data, special effectiveness information indicating special effectiveness characters is tied to character IDs. Namely, in the player terminal 1 and the server 1000, special effectiveness characters of the nurturing game can be identified by referring to the special effectiveness information data.

In this embodiment, five characters A, B, C, D, and E are set as special effectiveness characters. Therefore, in the special effectiveness information data, special effectiveness information is tied to the character ID corresponding to each of the characters A, B, C, D, and E, and no special effectiveness information is tied to the other character IDs.

Here, although a character ID is indicated by a letter that is used as a character type, such as the character A and the character B, for the sake of ease of understanding, an actual character ID is composed of a numerical value having a predetermined number of digits.

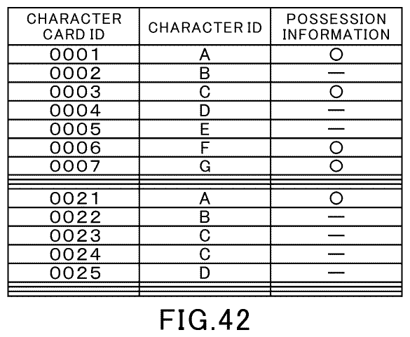

FIG. 42 is a drawing for illustrating character cards. Character cards provided by the game administrator have mutually different character card IDs tied thereto. Also, one character ID is always tied to each of the character cards. The character corresponding to the character ID tied to any of the character cards can be a nurturing-target character in the nurturing game. Here, as an example, it is assumed that 20 kinds of character IDs are provided, and 20 kinds of characters can be a nurturing-target character.

On the other hand, a larger number of character cards are provided than the number of character IDs. Namely, the character cards include a plurality of character cards to which the same character ID is tied. For example, as shown in FIG. 42, the character cards to which the character card IDs 0001 and 0021 are tied both have a character ID=A tied thereto. Similarly, the character cards to which the character card IDs 0003, 0023, and 0024 are tied all have a character ID=C tied thereto.

In the case where the player selects one of the character cards to which the character card IDs 0001 and 0021 are tied in the nurturing game, the nurturing-target character is the character A, whichever character card is selected. It should be noted, however, that the initial values of ability parameters, etc. and possessed skills are tied to character cards. Therefore, even if the same character is set as a nurturing-target character, nurtured characters finally created from different character cards selected by the player will have different abilities.

Also, character card possession data is provided in the player terminal 1 and the server 1000. In the character card possession data, possession information is tied to each character card ID. Possession information is information for identifying whether or not the character card is possessed by the player. In the example shown in FIG. 42, the player possesses the character cards to which the character card IDs 0001, 0003, 0006, 0007, and 0021 are tied.

Although not shown in the figure here, character card level data is provided in the player terminal 1 and the server 1000. In the character card level data, the current level is tied to each of the character card IDs. As described above, the player can increase the level of a character card by consuming a predetermined item and in-game currency. A character card has one of the five levels from 1 to 5. The higher the level of a character card, the larger the initial values of ability parameters and the larger the number of possessed skills.

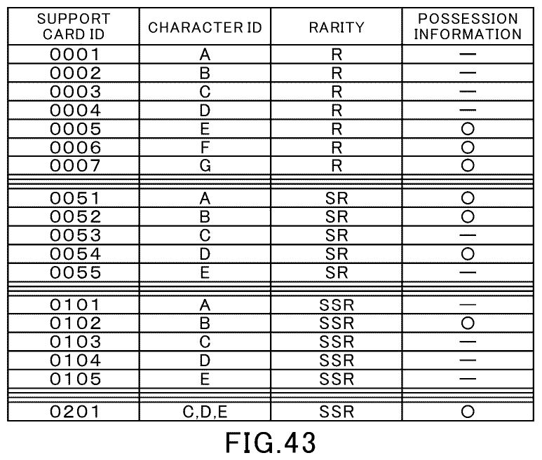

FIG. 43 is a drawing for illustrating support cards. Support cards provided by the game administrator have mutually different support card IDs tied thereto. Also, at least one character ID is tied to each of the support cards, as described above. A larger number of support cards are provided than the number of character IDs. Namely, the support cards include a plurality of support cards to which the same character ID is tied.

For example, as shown in FIG. 43, the support cards to which the support card IDs 0001, 0051, and 0101 are tied all have a character ID=A tied thereto. Here, there are three support cards to which a character ID=A is tied, having respective rarities R, SR, and SSR set therefor. In addition, the support card to which the support card ID 0201 is tied has the character IDs C, D, and E tied thereto. Namely, the support card with a support card ID=0201 is the aforementioned group support card.

Also, support card possession data is provided in the player terminal 1 and the server 1000. In the support card possession data, possession information is tied to each support card ID. Possession information is information for identifying whether or not the support card is possessed by the player. In FIG. 43, possession information of the support cards possessed by the player is indicated with a circle as an example.

Although not shown in the figure here, support-card-upper-limit-release data and support card level data are provided in the player terminal 1 and the server 1000. In the support-card-upper-limit-release data, the current upper-limit release number is tied to each support card ID. In addition, in the support card level data, the current level is tied to each support card ID.

As described above, levels 20, 25, and 30 are defined as the upper limits for the support cards with rarities R, SR, and SSR, respectively. The player can increase the level of a support card within the range up to the upper limit by consuming items or the like. In addition, the player can release the upper limit of each of the support cards by consuming items or the like. The upper limit of the level of a support card increases by “5” with one release of the upper limit. It should be noted, however, that the number of times the upper limit can be released is limited to four per support card. Therefore, four releases of the upper limit cause the support cards with rarities R, SR, and SSR to have upper limit levels of 40, 45, and 50, respectively.

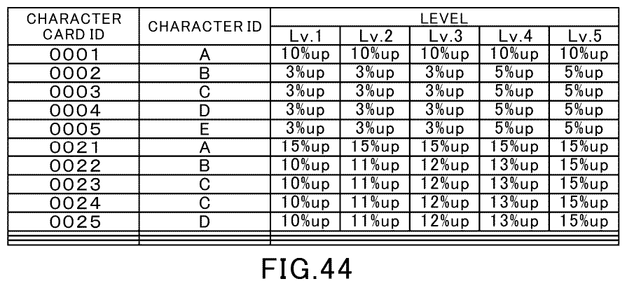

FIG. 44 is a drawing for illustrating effect values set for character cards. In a time-limited event, special effectiveness characters are set as described above. Also, effect values for changing event points are set for character cards having special effectiveness characters tied thereto, in other words, character card IDs to which character IDs having special effectiveness information set therefor are tied. These effect values are values multiplied by base points in order to calculate bonus points.

An effect value is set for each level of each of the character cards. For example, an effect value of 10% is set for all levels of the character card with the character card ID 0001. In addition, as for the character card with the character card ID 0002, the effect value is 3% for a level of 3 or lower, and the effect value is 5% for a level of 4 or higher. Thus, there are some character cards having a common effect value set therefor regardless of the level, and other character cards having effect values different depending on the level set therefor.

In addition, here, different effect values are set for a plurality of character card IDs having the same character ID tied thereto, as shown in FIG. 44. It should be noted, however, that the effect values shown in FIG. 44 are nothing more than an example. Therefore, for example, a common effect value may be set for all support card IDs to which character IDs having special effectiveness information set therefor are tied. Furthermore, here, an effect value is larger in the case of a higher level than in the case of a lower level. On the contrary, however, an effect value may be set so as to be larger in the case of a lower level than in the case of a higher level.

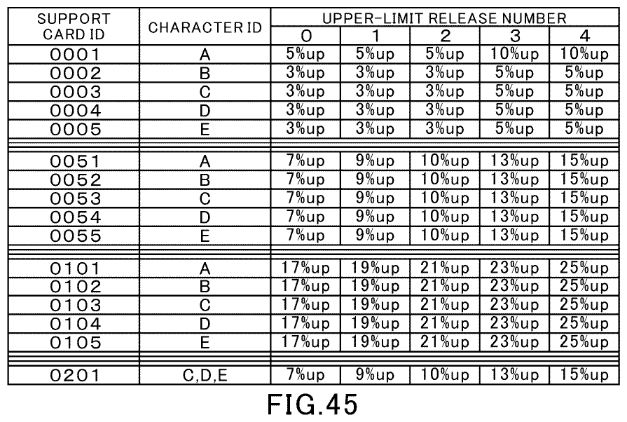

FIG. 45 is a drawing for illustrating effect values set for support cards. Also, effect values as described above are set for support cards having special effectiveness characters tied thereto, i.e., support card IDs to which character IDs having special effectiveness information set therefor are tied. Here, an effect value to be set for each of the support card IDs is set for each upper-limit release number of the support card.

For example, as for the support card with the support card ID 0001, the effect value is 5% for an upper-limit release number of 2 or smaller, and the effect value is 10% for an upper-limit release number of 3 or larger. Here, for all support cards, effect values are set larger in the case where the upper-limit release number is large than in the case where the upper-limit release number is small. It should be noted, however, that one effect value may be set for one support card ID, regardless of the upper-limit release number. Alternatively, effect values may be set larger in the case where the upper-limit release number is small than in the case where the upper-limit release number is large.

Here, a larger effect value is set for a support card with a higher rarity than for a support card with a lower rarity. It should be noted, however, that an effect value may be set regardless of the rarity. Furthermore, a common effect value may be set for all support card IDs. Also, an effect value may be set according not to the upper-limit release number but to the level.

In addition, special effectiveness information is set for character IDs tied to a group support card, here. In other words, the characters corresponding to a group support card are set as special effectiveness characters. In this embodiment, the three characters corresponding to the group support card with a support card ID=0201 are all set as special effectiveness characters. It should be noted, however, that some of the plurality of characters corresponding to a group support card may be set as special effectiveness characters.

As described above, when a nurturing game is started in a state in which a character card and a support card having effect values set therefor are possessed, bonus points are calculated on the basis of the possessed character card and support card. More specifically, one effect value is identified for each of the special effectiveness characters on the basis of the possessed character cards and support cards. Because five special effectiveness characters are set here, a maximum of five effect values are defined.

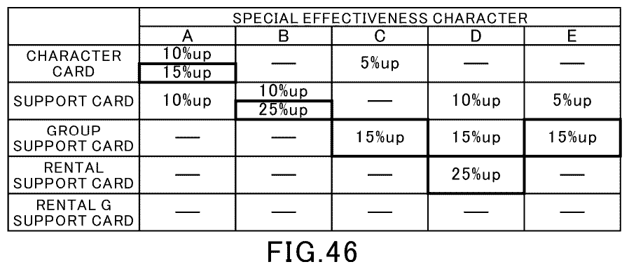

FIG. 46 is a drawing for illustrating a method for identifying effect values. When the nurturing main game is started (when the preparatory-stage process ends), all character cards and support cards having the characters A, B, C, D, and E, serving as special effectiveness characters, tied thereto are extracted from the possessed cards. In other words, character cards and support cards to which character IDs with special effectiveness information are tied are extracted.

Here, first, character cards having special effectiveness characters tied thereto are extracted from the possessed character cards. In the example shown in FIG. 46, two character cards having the character A tied thereto and one character card having the character C tied thereto are extracted. When the character cards are extracted, an effect value is identified for each of the character cards on the basis of the current levels of the extracted character cards.

In the example shown in FIG. 46, the effect values of the two character cards having the character A tied thereto are identified as 10% and 15%, respectively. Also, the effect value of the character card having the character C tied thereto is identified as 5%.

Next, support cards having special effectiveness characters tied thereto are extracted from the possessed support cards, excluding the group support cards. Also, in the same manner as above, an effect value is identified for each of the extracted support cards on the basis of the upper-limit release number.

Next, support cards having special effectiveness characters tied thereto are extracted from the possessed group support cards, and an effect value is identified in the same manner as above for each of the extracted group support cards on the basis of the upper-limit release number.

In addition, in the case where a support card having a special effectiveness character tied thereto is organized in the deck as a rental support card, that rental card is also extracted in the same manner as above, and an effect value is identified. Note that in the case where a group support card is organized in the deck as a rental support card and a special effectiveness character is tied to that rental support card, the rental card is also extracted in the same manner as above, and an effect value is identified.

Note that, in the example shown in FIG. 46, a support card other than a group support card is organized in the deck as the rental support card. Because only one rental card can be organized in the deck, no group support card serving as a rental support card is extracted in the example shown in FIG. 46.

As described above, once character cards and support cards to which special effectiveness characters are tied are extracted, and an effect value is identified for each of the cards, one applicable target card is then decided for each of the special effectiveness characters. Here, in the case where a plurality of cards are extracted for one special effectiveness character, the card with the largest effect value among the extracted cards is decided to be an applicable target card.

For example, in the example shown in FIG. 46, the character card with an effect value of 15% among the cards to which the character A is tied is decided to be an applicable target card. Namely, the effect value is decided to be 15% for the character A. In addition, the support card with an effect value of 25% among the cards to which the character B is tied is decided to be an applicable target card. Namely, the effect value is decided to be 25% for the character B. Furthermore, for both characters C and E, the same group support card is decided to be an applicable target card. Here, the effect value is decided to be 15% for the characters C and E.

Also, the rental support card with an effect value of 25% among the cards to which the character D is tied is decided to be an applicable target card. Namely, the effect value is decided to be 25% for the character D.

Thus, in this embodiment, one applicable target card is decided for each of the special effectiveness characters. Also, as a result of the effect values set for all applicable target cards being summed, one applicable effect value that is finally applied is decided. In the example shown in FIG. 46, the applicable effect value is 95%, which is the value obtained by summing the five effect values enclosed by bold lines.

In the case where event points are calculated at the time the nurturing game ends, base points are calculated first. Then, the base points are multiplied by the applicable effect value to calculate bonus points. For example, in the case where base points are calculated as 10000 pt, 9500 pt, which is obtained by multiplying the base points by the applicable effect value, is calculated as bonus points. By doing so, the event points are calculated as 19500 pt, which is obtained by adding the bonus points to the base points.

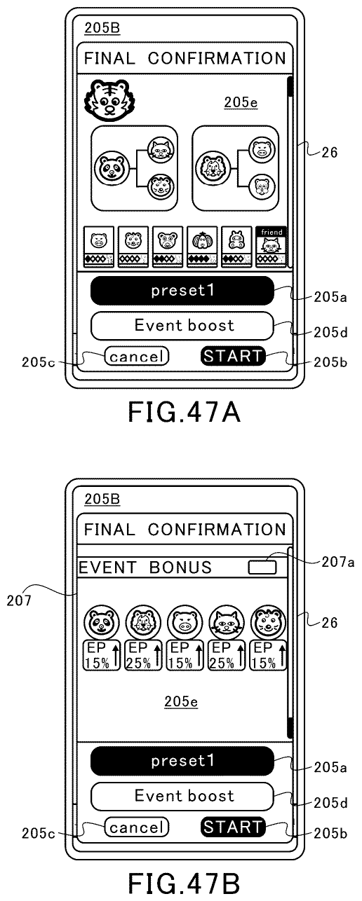

FIG. 47A is a first drawing for illustrating a final confirmation screen 205B while a time-limited event is being held. FIG. 47B is a second drawing for illustrating the final confirmation screen 205B while a time-limited event is being held. While a time-limited event is being held, when deck organization is completed in the nurturing game, the final confirmation screen 205B shown in FIG. 47A is displayed. The nurturing-target character selected by the player, the nurtured characters constituting the first inheritance group, the nurtured characters constituting the second inheritance group, the support cards organized in the deck, the preset display section 205a, the start operation section 205b, and the cancel operation section 205c are also displayed on the final confirmation screen 205B.

A boost operation section 205d is also displayed on the final confirmation screen 205B. When the boost operation section 205d is tapped, a confirmation screen (not shown in the figure) is displayed. On the confirmation screen, the player can turn on/off an event boost function. The event boost function is a function for doubling event points that are granted when the nurturing game is completed in exchange for doubling game points that are consumed in one nurturing main game.

In addition, on the final confirmation screen 205B, a region 205e that allows confirmation of the nurturing-target character and deck organization, i.e., the region above the preset display section 205a, is displayed so as to be scrollable. When the region 205e is scrolled, an event bonus information image 207 is displayed as shown in FIG. 47B. On the event bonus information image 207, the applicable target cards and effectiveness values resulting from the applicable target cards are displayed.

In addition, a details button 207a is provided on the event bonus information image 207. When the details button 207a is tapped, a bonus points details screen 208 is displayed.

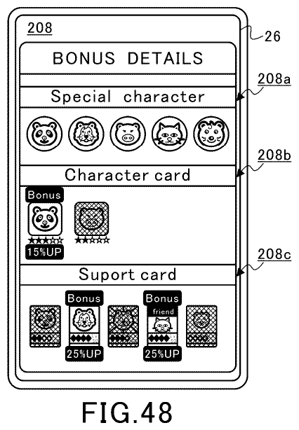

FIG. 48 is a drawing for illustrating the bonus points details screen 208. On the bonus points details screen 208, a special effectiveness character display region 208a is provided. In the special effectiveness character display region 208a, character icons corresponding to the special effectiveness characters are displayed. By virtue of the character icons displayed in the special effectiveness character display region 208a, the player can grasp the special effectiveness characters in the time-limited event.

Furthermore, on the bonus points details screen 208, a character card display region 208b is provided. In the character card display region 208b, the character cards that are possessed by the player and to which special effectiveness characters are tied are displayed. Namely, in the character card display region 208b, all character cards extracted as candidates for applicable target cards from the character cards possessed by the player are displayed.

Also, in the bonus points details screen 208, a support card display region 208c is provided. In the support card display region 208c, the support cards that are possessed by the player and to which special effectiveness characters are tied are displayed. Namely, in the support card display region 208c, all support cards extracted as candidates for applicable target cards from the support cards possessed by the player are displayed.

Some of the cards that are displayed in the character card display region 208b and the support card display region 208c and that have been extracted as candidates for applicable target cards are finally decided to be applicable target cards, whereas the others are not decided to be applicable target cards. On each of the cards finally decided to be applicable target cards, an identification mark captioned “Bonus” and an effectiveness value resulting from the card are displayed.

On the other hand, the cards that have not been decided to be applicable target cards among the cards displayed in the character card display region 208b and the support card display region 208c are displayed darker than applicable target cards. Thus, cards extracted as candidates for applicable target cards, as well as applicable target cards, are displayed identifiably in the bonus points details screen 208.

As described above, according to this embodiment, the player can earn event points as rewards by playing a nurturing game while a time-limited event is being held. Also, the amount of event points to be earned increases merely by possessing a character card or a support card corresponding to a special effectiveness character.

In order to increase the amount of event points to be earned, it has so far been necessary to organize a deck with, for example, a support card corresponding to a special effectiveness character. In this case, however, it becomes difficult for the player to freely organize a deck, thereby restricting the player to narrowed choices and discouraging the player from playing the game. According to this embodiment, because the amount of event points to be earned increases merely by possessing a character card or a support card corresponding to a special effectiveness character, the player can freely select a character card and a support card and is thus not discouraged from playing the game.

Furthermore, new character cards and support cards are added sequentially in the course where the game is administered. Therefore, it is expected that the number of cards possessed by the player increases gradually. As new cards with higher performance accumulate, it becomes less necessary to possess existing cards. Nevertheless, according to this embodiment, because event points that can be earned in a time-limited event, which is held on an irregular basis, increase by possessing a card corresponding to a special effectiveness character, the player is encouraged to possess a larger number of cards and consequently to earn cards.

Next, functional configurations of the player terminal 1 and the server 1000 for executing the aforementioned nurturing game will be described. Note that processes related particularly to a group support card of the nurturing game will be described below in detail, and descriptions of the other processes will be omitted.

### (Functional Configuration of Player Terminal 1)

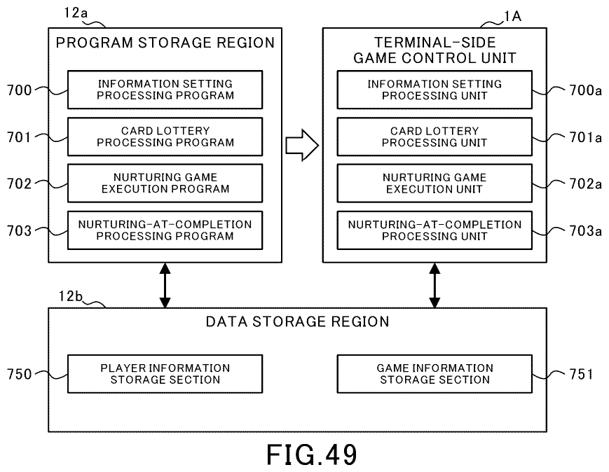

FIG. 49 is a drawing for illustrating the configuration of the memory 12 in the player terminal 1 and functions of the player terminal 1 as a computer. A program storage region 12a and a data storage region 12b are provided in the memory 12. When a game is started, the CPU 10 stores terminal-side game control programs (modules) in the program storage region 12a.

The terminal-side game control programs include: an information setting processing program 700; a card lottery processing program 701; a nurturing game execution program 702; and a nurturing-at-completion processing program 703. Note that the programs listed in FIG. 49 are examples, and many other programs are provided as the terminal-side game control programs.

In the data storage region 12b, a player information storage section 750 and a game information storage section 751 are provided as storage sections for storing data. Note that many other storage sections are provided in the data storage region 12b. Here, information directly related to a game (hereinafter, referred to as game information), such as the nurturing game, is stored in the game information storage section 751.

Note that various kinds of information while each game, such as the nurturing game, is proceeding are also temporarily stored in the game information storage section 751. Therefore, all information related to a nurtured character that has been nurtured in the nurturing game is stored in the game information storage section 751. In addition, all information other than the game information, such as information concerning the player or other players and setting information of the player terminal 1, is player information. The player information is stored in the player information storage section 750.

The CPU 10 runs the individual programs stored in the program storage region 12a and updates the data in the individual storage sections of the data storage region 12b. Furthermore, the CPU 10 runs the individual programs stored in the program storage region 12a, thereby causing the player terminal 1 (computer) to function as a terminal-side game control unit 1A. The terminal-side game control unit 1A includes: an information setting processing unit 700a; a card lottery processing unit 701a; a nurturing game execution unit 702a; and a nurturing-at-completion processing unit 703a.

More specifically, the CPU 10 runs the information setting processing program 700, thereby causing the computer to function as the information setting processing unit 700a. Similarly, the CPU 10 runs the card lottery processing program 701, the nurturing game execution program 702, and the nurturing-at-completion processing program 703, thereby causing the computer to function as the card lottery processing unit 701a, the nurturing game execution unit 702a, and the nurturing-at-completion processing unit 703a, respectively.

In the case where various kinds of information settings are made at the player terminal 1, the information setting processing unit 700a stores, in the player information storage section 750, information concerning the settings as player information. In addition, in the case where information in the player information storage section 750 is updated, the information setting processing unit 700a transmits update information to the server 1000.

The card lottery processing unit 701a requests, on the basis of an operation input made by the player, the server 1000 to draw a gacha lottery for selecting a character card or a support card. Upon receiving a result of the gacha lottery from the server 1000, the card lottery processing unit 701a also displays the lottery result and updates the possession information.

The nurturing game execution unit 702a executes all processes related to the nurturing game. More specifically, the nurturing game execution unit 702a executes the preparatory-stage process and the nurturing-stage process.

When the nurturing game is completed, the nurturing-at-completion processing unit 703a stores nurtured character information including ability parameters, aptitude parameters, earned skills, inheritance information, and factor information of the nurtured character, character types used to nurture the nurtured character, etc.

### (Functional Configuration of Server 1000)

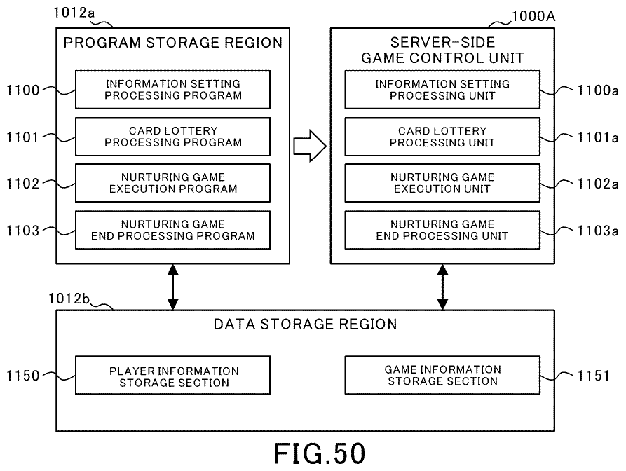

FIG. 50 is a drawing for illustrating the configuration of the memory 1012 in the server 1000 and functions of the server 1000 as a computer. A program storage region 1012a and a data storage region 1012b are provided in the memory 1012. When a game is started, the CPU 1010 stores server-side game control programs (modules) in the program storage region 1012a.

The server-side game control programs include: an information setting processing program 1100; a card lottery processing program 1101; a nurturing game execution program 1102; and a nurturing game end processing program 1103. The programs listed in FIG. 50 are examples, and many other programs are provided as the server-side game control programs.

In the data storage region 1012b, a player information storage section 1150 and a game information storage section 1151 are provided as storage sections for storing data. Note that many other storage sections are provided in the data storage region 1012b. Here, game information of all players is stored in the game information storage section 1151 so as to be tied to the respective player IDs. In addition, player information of all players is stored in the player information storage section 1150 so as to be tied to the respective player IDs.

The CPU 1010 runs the individual programs stored in the program storage region 1012a and updates data in the individual storage sections in the data storage region 1012b. Also, the CPU 1010 runs the individual programs stored in the program storage region 1012a, thereby causing the server 1000 (computer) to function as a server-side game control unit 1000A. The server-side game control unit 1000A includes: an information setting processing unit 1100a; a card lottery processing unit 1101a; a nurturing game execution unit 1102a; and a nurturing game end processing unit 1103a.

More specifically, the CPU 1010 runs the information setting processing program 1100, thereby causing the computer to function as the information setting processing unit 1100a. Similarly, the CPU 1010 runs the card lottery processing program 1101, the nurturing game execution program 1102, and the nurturing game end processing program 1103, thereby causing the computer to function as the card lottery processing unit 1101a, the nurturing game execution unit 1102a, and the nurturing game end processing unit 1103a, respectively.

In the case where various kinds of information settings are made at the player terminal 1, the information setting processing unit 1100a updates the player information in the player information storage section 1150 on the basis of the update information received from the player terminal 1. In addition, the information setting processing unit 1100a performs time keeping and updates game points of each player.

On the basis of a request for gacha lottery received from the player terminal 1, the card lottery processing unit 1101a decides, by lottery, a character card or a support card to be granted to the player. In addition, the card lottery processing unit 1101a updates the possession information on the basis of a lottery result.

The nurturing game execution unit 1102a executes all processes related to the nurturing game.

When the nurturing game ends, the nurturing game end processing unit 1103a derives an evaluation score, a nurturing rank, etc. for the nurtured character that has been nurtured. In addition, the nurturing game end processing unit 1103a decides factors to be earned by the nurtured character by lottery. The nurturing game end processing unit 1103a also stores nurtured character information including ability parameters, aptitude parameters, earned skills, inheritance information, and factor information of the nurtured character, character types used to nurture the nurtured character, etc. in the game information storage section 1151 so as to be tied to the player ID.

Although the information setting processing unit 700a in the player terminal 1 and the information setting processing unit 1100a in the server 1000 are common in that both units store player information, they differ in specific processing details and the scope of the player information to be stored. In addition, although the nurturing game execution unit 702a in the player terminal 1 and the nurturing game execution unit 1102a in the server 1000 are common in that both units execute processes related to the nurturing game, they differ in their roles, i.e., the scope of their responsibilities.

Processes to be executed by the aforementioned individual functional units in the player terminal 1 and server 1000 will be described below by using flowcharts.

### (Processes of Player Terminal 1 and Server 1000)

### <Processes Related to Nurturing Game>

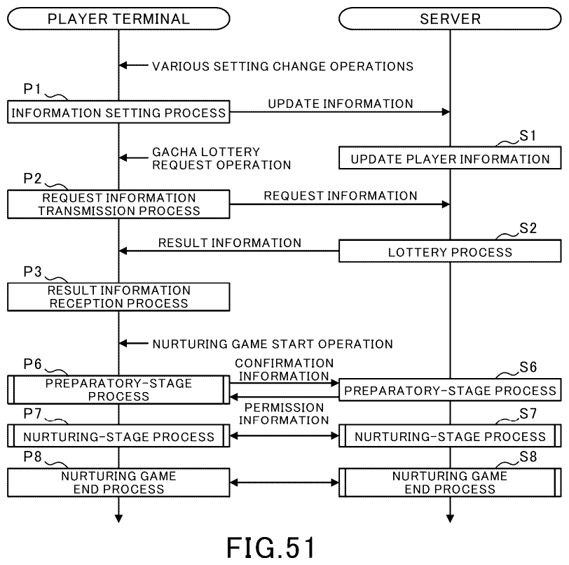

FIG. 51 is a sequence diagram for illustrating processes of the player terminal 1 and the server 1000 related to the nurturing game. Note that, in the following description, processes in the player terminal 1 are denoted as Pn (n is any integer). Furthermore, processes in the server 1000 are denoted as Sn (n is any integer).

When the player performs various setting change operations at the player terminal 1, the information setting processing unit 700a of the player terminal 1 executes an information setting process (P1) for updating the player information storage section 750 on the basis of the player operation inputs. In this information setting process, update information is transmitted to the server 1000. At the server 1000, upon receiving the update information, the information setting processing unit 1100a updates the player information in the player information storage section 1150 (S1).

Note that the player information updated in P1 and S1 includes, for example, profile information that can be set by the player. Also, for example, when an operation for adding another player as a friend or for unregistering a friend is input as a setting change operation, friend information indicating information concerning friends is updated. Note that, in P1 and S1, each of the information setting processing unit 700a and the information setting processing unit 1100a manages game points to be consumed to execute a nurturing game. In the case where the game points are below the upper limit, the information setting processing units 700a and 1100a perform time keeping and grant a predetermined value of game points to the player every predetermined time period.

When the gacha screen selection operation section 102e is tapped in the menu bar 102 at the player terminal 1, the gacha screen is displayed. The player can input, on the gacha screen, a gacha lottery request operation for requesting a gacha lottery for selecting a character card or a support card. On the gacha screen, it is possible to set the type of gacha lottery to be drawn and the number of times a gacha lottery is drawn. When a gacha lottery request operation is input, the card lottery processing unit 701a transmits request information to the server 1000 (P2). The request information includes information indicating the type of gacha lottery, i.e., the type of either character card or support card, and the number of times a gacha lottery is drawn.

Upon receiving the request information, the card lottery processing unit 1101a executes a lottery process at the server 1000 (S2). Here, the card lottery processing unit 1101a draws a gacha lottery the same number of times as requested. Then, the card lottery processing unit 1101a stores possession information concerning the won character card or support card in the player information storage section 1150. In addition, the card lottery processing unit 1101a causes the player terminal 1 to receive result information indicating the result of the gacha lottery.

Upon receiving the result information, the card lottery processing unit 701a executes a result information reception process at the player terminal 1 (P3). Here, the card lottery processing unit 701a reports the result of the gacha lottery on the basis of the received result information. Furthermore, the card lottery processing unit 701a stores possession information concerning the won character card or support card in the player information storage section 750.

When a nurturing game start operation for starting a nurturing game is input at the player terminal 1, the nurturing game execution unit 702a executes the preparatory-stage process (P6). In addition, during this preparatory-stage process, communication processes are executed between the player terminal 1 and the server 1000. At the server 1000, the nurturing game execution unit 1102a executes the preparatory-stage process (S6) on the basis of information received from the player terminal 1.

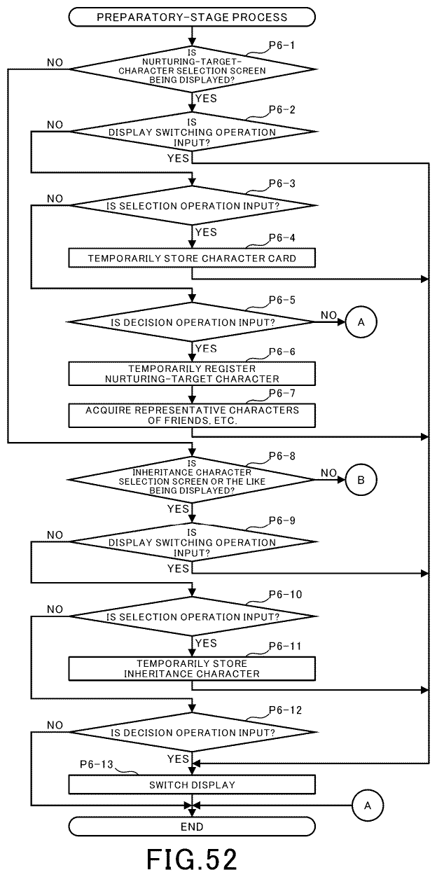

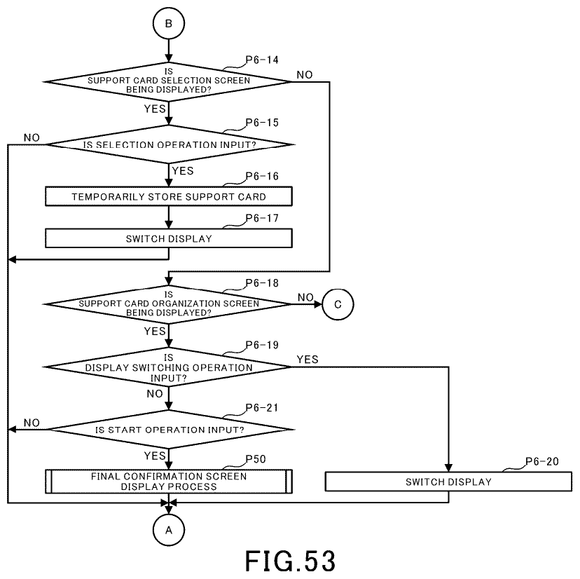

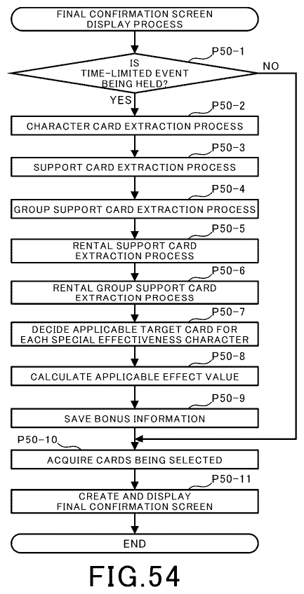

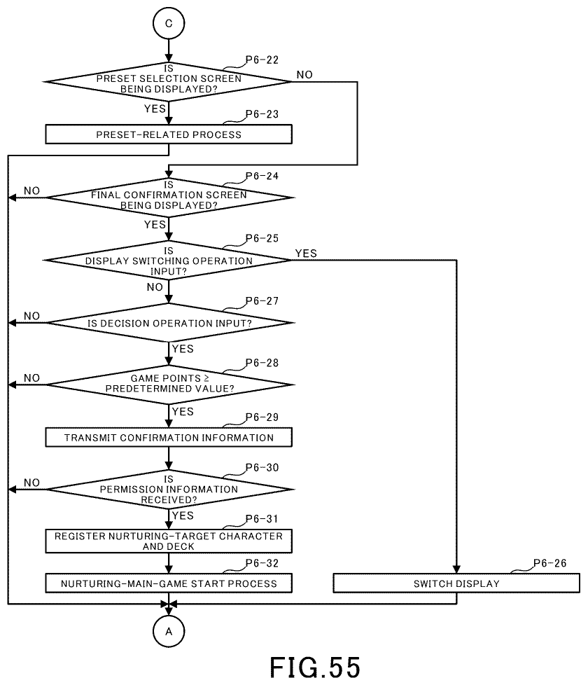

FIG. 52 is a first flowchart for illustrating the preparatory-stage process (P6) at the player terminal 1. FIG. 53 is a second flowchart for illustrating the preparatory-stage process (P6) at the player terminal 1. FIG. 54 is a flowchart for illustrating a final confirmation screen display process (P50) at the player terminal 1. FIG. 55 is a third flowchart for illustrating the preparatory-stage process (P6) at the player terminal 1. The nurturing game execution unit 702a of the player terminal 1 determines whether or not the nurturing-target-character selection screen 150 is being displayed on the display 26 (P6-1).

In the case where the nurturing-target-character selection screen 150 is being displayed (YES in P6-1) and a display switching operation for switching the screen display is input (YES in P6-2), the nurturing game execution unit 702a switches the display screen of the display 26 (P6-13).

In addition, when a selection operation (tapping a character icon 151) is input on the nurturing-target-character selection screen 150 (YES in P6-3), the nurturing game execution unit 702a temporarily stores the character card corresponding to the selected character icon 151 (P6-4) and switches the display screen (P6-13).

In addition, when a decision operation (tapping the next operation section 154) is input on the nurturing-target-character selection screen 150 (YES in P6-5), the nurturing game execution unit 702a temporarily registers, as the nurturing-target character, the character tied to the character card that has been temporarily stored in P6-4 above (P6-6). Also, the nurturing game execution unit 702a acquires, from the server 1000, information concerning representative characters extracted according to a predetermined extraction condition, such as the representative characters of the friends (P6-7), and switches the display screen (P6-13).

Also, in the case where the inheritance character selection screen 170 or the nurtured character list screen 180 is being displayed (YES in P6-8) and a display switching operation for switching the screen display is input (YES in P6-9), the nurturing game execution unit 702a switches the display screen on the display 26 (P6-13).

Here, the display switching operation on the inheritance character selection screen 170 or the nurtured character list screen 180 includes: tapping the skill display button 172 and pressing and holding a nurtured character icon 182 shown in FIG. 7B; and tapping the nickname change button 186a, the memo input button 186b, the skill display tab 188a, the inheritance information display tab 188b, the nurturing information display tab 188c, and the close operation section 188d in the character details dialog 185A shown in FIG. 12.

For example, in the case where the skill display button 172 is tapped on the nurtured character list screen 180, the nurturing game execution unit 702a displays the skill display dialog 185B in P6-13. In addition, in the case where a nurtured character icon 182 is pressed and held on the nurtured character list screen 180, the nurturing game execution unit 702a displays the character details dialog 185A in P6-13. Note that in the case where the nickname change button 186a, the memo input button 186b, the skill display tab 188a, the inheritance information display tab 188b, the nurturing information display tab 188c, or the close operation section 188d is tapped in the character details dialog 185A, the current screen switches to the screen corresponding to the tapped operation section.

In addition, when a selection operation (tapping a nurtured character icon 182) is input on the nurtured character list screen 180 (YES in P6-10), the nurturing game execution unit 702a temporarily stores the character corresponding to the selected nurtured character icon 182 as an inheritance character (P6-11) and switches the display screen (P6-13).

Also, when a decision operation (tapping the next operation section 154) is input on the inheritance character selection screen 170 (YES in P6-12), the nurturing game execution unit 702a displays the support card organization screen 190 on the display 26 (P6-13).

In addition, when the support card selection screen 200 is being displayed (YES in P6-14 in FIG. 53) and a selection operation (tapping the card icon 201 of a support card) is input on the support card selection screen 200 (YES in P6-15), the nurturing game execution unit 702a temporarily stores the support card corresponding to the selected card icon 201 (P6-16) and switches the display screen (P6-17).

Also, in the case where the support card organization screen 190 is being displayed (YES in P6-18) and a display switching operation for switching the screen display is input (YES in P6-19), the nurturing game execution unit 702a switches the display screen of the display 26 (P6-20).

In addition, when a start operation (tapping the start operation section 193) is input on the support card organization screen 190 (YES in P6-21), the nurturing game execution unit 702a executes a final confirmation screen display process (P50) shown in FIG. 54.

As shown in FIG. 54, in the final confirmation screen display process, the nurturing game execution unit 702a determines whether or not a time-limited event is now being held (P50-1). If a time-limited event is being held, the nurturing game execution unit 702a executes a character card extraction process (P50-2). Here, the nurturing game execution unit 702a identifies character IDs having special effectiveness information set therefor and extracts all character cards to which both the identified character IDs and possession information are tied.

Next, the nurturing game execution unit 702a executes a support card extraction process (P50-3). Here, the nurturing game execution unit 702a extracts all support cards, excluding group support cards, to which both character IDs having special effectiveness information set therefor and possession information are tied.

Next, the nurturing game execution unit 702a executes a group support card extraction process (P50-4). Here, the nurturing game execution unit 702a extracts all group support cards to which both character IDs having special effectiveness information set therefor and possession information are tied.

Next, the nurturing game execution unit 702a executes a rental support card extraction process (P50-5). Here, in the case where the rental support card organized in the deck is not a group support card and is tied to a character ID having special effectiveness information set therefor, the nurturing game execution unit 702a extracts the rental support card.

Next, the nurturing game execution unit 702a executes a rental group support card extraction process (P50-6). Here, in the case where the rental support card organized in the deck is a group support card and is tied to a character ID having special effectiveness information set therefor, the nurturing game execution unit 702a extracts the group support card.

Next, the nurturing game execution unit 702a decides an applicable target card for each of the special effectiveness characters among the cards extracted in P50-2 to P50-6 (P50-7). Here, for example, an effect value is identified for each of the extracted cards. Then, the cards are classified by special effectiveness character, and the card with the maximum effect value identified among the cards corresponding to the same special effectiveness character is decided to be an applicable target card.

Next, the nurturing game execution unit 702a calculates an applicable effect value by summing the effect values of the applicable target cards decided in P50-7 (P50-8). Next, the nurturing game execution unit 702a saves, as bonus information, each item of information indicating all the extracted cards, the effect value of each of all the cards, applicable target cards, and the applicable effect value (P50-9).

Next, the nurturing game execution unit 702a acquires information concerning the character card and support cards selected by the player (P50-10) and creates and displays the final confirmation screens 205 and 205B (P50-11).

Through the aforementioned final confirmation screen display process, the final confirmation screen 205B is displayed while a time-limited event is being held, and the final confirmation screen 205 is displayed while no time-limited event is being held.

In addition, as shown in FIG. 55, while the preset selection screen 205A is being displayed (YES in P6-22), the nurturing game execution unit 702a executes a preset-related process for temporarily storing reservation selection information corresponding to a preset, etc. (P6-23).

Furthermore, in the case where the final confirmation screen 205 or 205B is being displayed (YES in P6-24) and a display switching operation for switching the screen display is input (YES in P6-25), the nurturing game execution unit 702a switches the display screen of the display 26 (P6-26).

Also, when a decision operation (tapping the start operation section 205b) is input on the final confirmation screen 205 or 205B (YES in P6-27), the nurturing game execution unit 702a determines whether or not game points are equal to or larger than a predetermined value (e.g., 30) (P6-28). If the game points are equal to or larger than the predetermined value (YES in P6-28), the nurturing game execution unit 702a transmits confirmation information to the server 1000 (P6-29).

Note that the confirmation information includes information for identifying the temporarily registered nurturing-target character, inheritance characters, and support cards. Upon receiving the confirmation information, it is determined in the preparatory-stage process (S6) at the server 1000 whether or not to permit execution of a nurturing main game by using the temporarily registered nurturing-target character, inheritance characters, and support cards.

Upon receiving permission information (YES in P6-30) after having transmitted confirmation information (P6-29) at the player terminal 1, the nurturing game execution unit 702a registers the nurturing-target character temporarily registered in P6-6 above (P6-31). Also, the nurturing game execution unit 702a registers, in the deck, the nurtured characters temporarily stored as inheritance characters in P6-11 above and the support cards temporarily stored in P6-16 above. Then, the nurturing game execution unit 702a displays the game screen 210 on the display 26 and executes a nurturing-main-game start process for starting a nurturing main game (P6-32).

Referring back to FIG. 51, when the preparatory-stage process (P6) ends, the nurturing game execution unit 702a executes the nurturing-stage process (P7). In addition, during this nurturing-stage process, communication processes are executed between the player terminal 1 and the server 1000. At the server 1000, the nurturing game execution unit 1102a executes the nurturing-stage process (S7) on the basis of information received from the player terminal 1.

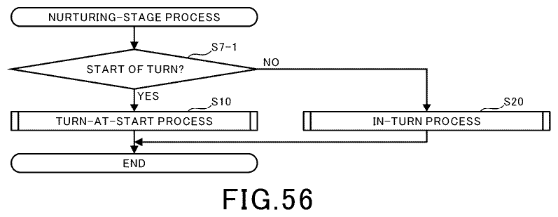

FIG. 56 is a flowchart for illustrating the nurturing-stage process at the server 1000. The nurturing game execution unit 1102a of the server 1000 executes the turn-at-start process (S10) when the player is at the start of a turn (YES in S7-1), and executes an in-turn process (S20) when the player is not at the start of a turn.

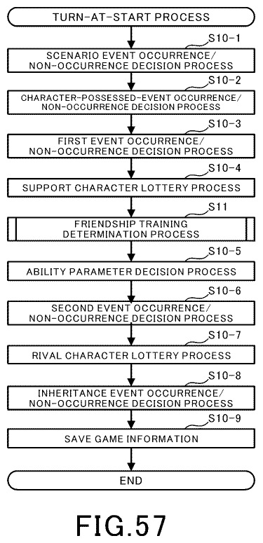

FIG. 57 is a flowchart for illustrating the turn-at-start process at the server 1000. As shown in FIG. 57, first the nurturing game execution unit 1102a of the server 1000 executes a scenario event occurrence/non-occurrence decision process (S10-1). Here, in the case where there is a scenario event that must be made to occur in the current turn number, the nurturing game execution unit 1102a decides that the scenario event will occur. In addition, in the case where there are no scenario events that must be made to occur in the current turn number, the nurturing game execution unit 1102a decides whether or not to cause a scenario event to occur and the type of the scenario event to be made to occur by lottery.

Furthermore, the nurturing game execution unit 1102a executes a character-possessed-event occurrence/non-occurrence decision process (S10-2). Here, in the case where there is a character-possessed event that must be made to occur in the current turn number, the nurturing game execution unit 1102a decides that the character-possessed event will occur. On the other hand, in the case where there are no character-possessed events that must be made to occur in the current turn number, the nurturing game execution unit 1102a decides whether or not to cause a character-possessed event to occur and the type of the character-possessed event to be made to occur by lottery.

In addition, the nurturing game execution unit 1102a executes a first event occurrence/non-occurrence decision process (S10-3). Here, when a turn is started, a random number is randomly acquired, and whether or not to cause a first event to occur and the type of the first event to be made to occur are decided on the basis of the acquired random number and the first event table.

In addition, the nurturing game execution unit 1102a executes a support character lottery process (S10-4). More specifically, the nurturing game execution unit 1102a decides, by lottery, whether or not to place a support character in a training course with reference to the placement probability table shown in FIG. 32. This process is executed for each of the support characters.

Note that in the case where it is decided that a support character is placed in a training course, the nurturing game execution unit 1102a ties the support card ID (or support character ID) to the training ID provided for the training course.

Furthermore, the nurturing game execution unit 1102a executes a friendship training determination process (S11) for determining whether or not friendship training occurs.

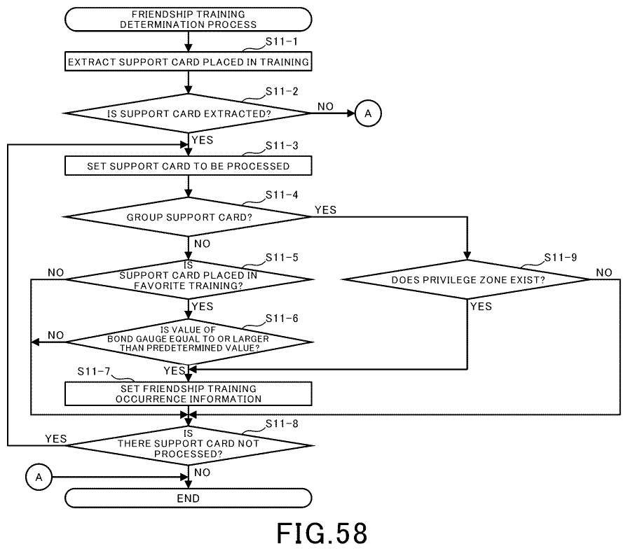

FIG. 58 is a flowchart for illustrating the friendship training determination process at the server 1000. The nurturing game execution unit 1102a extracts a support card tied to any of the training courses in S10-4 (S11-1). In the case where a support card is extracted (YES in S11-2), the nurturing game execution unit 1102a sets a support card for which it is determined whether or not friendship training occurs (S11-3).

In the case where the support card set in S11-3 is not a group support card (NO in S11-4), the nurturing game execution unit 1102a determines whether or not the training course in which the support card is placed is the favorite training set for the support card (S11-5). In the case where the support card is placed in the favorite training thereof (YES in S11-5) and the value of the bond gauge of the support card is equal to or larger than a predetermined value (80) (YES in S11-6), the nurturing game execution unit 1102a sets friendship training occurrence information indicating the occurrence of friendship training so as to be tied to the support card (S11-7).

On the other hand, in the case where the support card set in S11-3 is a group support card (YES in S11-4) and a privilege zone exists (YES in S11-9), the nurturing game execution unit 1102a also sets friendship training occurrence information (S11-7). Note that in the case where there is a support card not subjected to the processes in S11-3 to S11-9 among the support cards placed in training courses, the nurturing game execution unit 1102a repeats the processes from S11-3.

Referring back to FIG. 57, the nurturing game execution unit 1102a executes an ability parameter decision process (S10-5). In the ability parameter decision process, increase values of ability parameters of the nurturing-target character in the case where each of the training courses is successfully executed are decided. More specifically, the nurturing game execution unit 1102a decides increase values of ability parameters of the nurturing-target character in the case of successful training for all training courses, with reference to the training level table shown in FIG. 33A, the increase-fixed value tables shown in FIG. 33B and FIG. 33C, and the bonus addition rate table shown in FIG. 33D. Because of this, in the case where friendship training occurs, increase values of ability parameters become large.

In addition, here, with reference to a physical strength table (not shown in the figure), the nurturing game execution unit 1102a decides the amount of decrease in the physical strength or the amount of recovery of the physical strength in the case where each of the training courses is executed. Also, the nurturing game execution unit 1102a calculates a training failure rate for each of the training courses on the basis of the physical strength of the nurturing-target character.

In addition, the nurturing game execution unit 1102a executes a second event occurrence/non-occurrence decision process (S10-6). More specifically, the nurturing game execution unit 1102a decides, by lottery, whether or not to cause a second event to occur with reference to the second event table shown in FIG. 34. More specifically, after the support character lottery process (S10-4), a random number is randomly acquired, and whether or not to cause a second event to occur is decided on the basis of the acquired random number and the second event table. Here, for example, the nurturing game execution unit 1102a draws a granting lottery for deciding whether or not to enable granting of the support events set in advance for the support cards tied to the training courses in S10-4.

Note that, here, in the case where it is decided that a second event occurs, effectiveness resulting from occurrence of the second event is decided. At this time, if a privilege zone exists, the nurturing game execution unit 1102a executes computation so that effectiveness resulting from occurrence of the second event becomes high.

In addition, the nurturing game execution unit 1102a executes a rival character lottery process (S10-7). More specifically, the nurturing game execution unit 1102a decides, by lottery, whether or not to place a rival character in each of the suitable races with reference to the placement probability table shown in FIG. 38.

Also, the nurturing game execution unit 1102a executes an inheritance event occurrence/non-occurrence decision process (S10-8). More specifically, the nurturing game execution unit 1102a decides that an inheritance event occurs in the case where the current turn is a factor-invoking turn. In this case, the nurturing game execution unit 1102a decides whether or not each factor is invoked on the basis of the factor information of the inheritance characters registered in the deck in the preparatory-stage process in S6. By doing so, ability parameters or aptitude parameters increase, and skill hints are earned, according to a factor that is decided to be invoked.

The nurturing game execution unit 1102a saves game information including information concerning the lottery results in S10-1 to S10-8 in the game information storage section 1151 (S10-9). Furthermore, the nurturing game execution unit 1102a executes a process for causing the player terminal 1 to receive the game information saved in the game information storage section 1151.

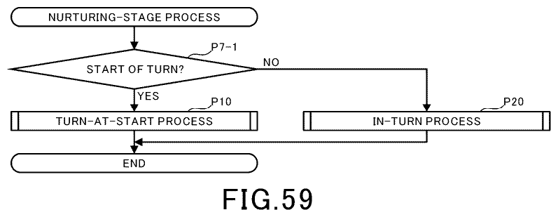

FIG. 59 is a flowchart for illustrating the nurturing-stage process at the player terminal 1. The nurturing game execution unit 702a of the player terminal 1 executes the turn-at-start process (P10) if the player is at the start of a turn (YES in P7-1) or the in-turn process (P20) if the player is not at the start of a turn.

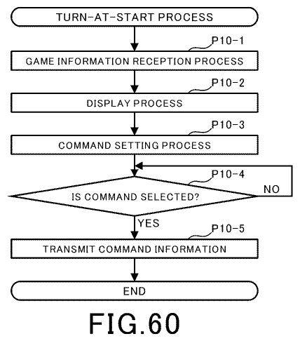

FIG. 60 is a flowchart for illustrating the turn-at-start process at the player terminal 1. The turn-at-start process (P10) in the player terminal 1 is started when the turn-at-start process (S10) is executed in the server 1000 and game information is set in S10-9.

The nurturing game execution unit 702a accesses the game information storage section 1151 of the server 1000 and receives, from the server 1000, the game information saved in S10-9 (P10-1). Also, the nurturing game execution unit 702a executes a display process for displaying the game screen 210, etc. on the basis of the received game information (P10-2). Then, the nurturing game execution unit 702a executes a command setting process for allowing the player to select various commands related to the nurturing-stage process (P10-3).

More specifically, on the basis of the current turn number and with reference to, for example, the elective table shown in FIG. 19, the nurturing game execution unit 702a executes a process for allowing the player to select various kinds of commands for the rest operation section 215, the training operation section 216, the skill operation section 217, the going-out operation section 218, the individual race operation section 219, the shop operation section 220, the item operation section 221, etc. The nurturing game execution unit 702a also executes a process for allowing the player to select a plurality of individual race selection operation sections 266 tied to the individual race operation section 219.

In addition, in the command setting process, the nurturing game execution unit 702a allows the player to select the commands for the speed operation section 241, the stamina operation section 242, the power operation section 243, the spirit operation section 244, and the wisdom operation section 245 corresponding to the respective training courses, as well as commands for a skill display field 251, the nurturing-target-character selection operation section 256a, a support character selection operation section 256b, the first belonging character selection operation section 258a to the fifth belonging character selection operation section 258e, the all-belonging-character selection operation section 259, the result operation section 273, the race operation section 274, an item exchange operation section 303, etc. The nurturing game execution unit 702a executes a process for allowing the player to select one of the plurality of commands.

Note that the nurturing game execution unit 702a allows the selection of the all-belonging-character selection operation section 259 only after receiving release information (described below) from the server 1000.

Subsequently, when any of the commands is selected by the player (YES in P10-4), the nurturing game execution unit 702a transmits, to the server 1000, command information that allows identification of the command selected by the player (P10-5).

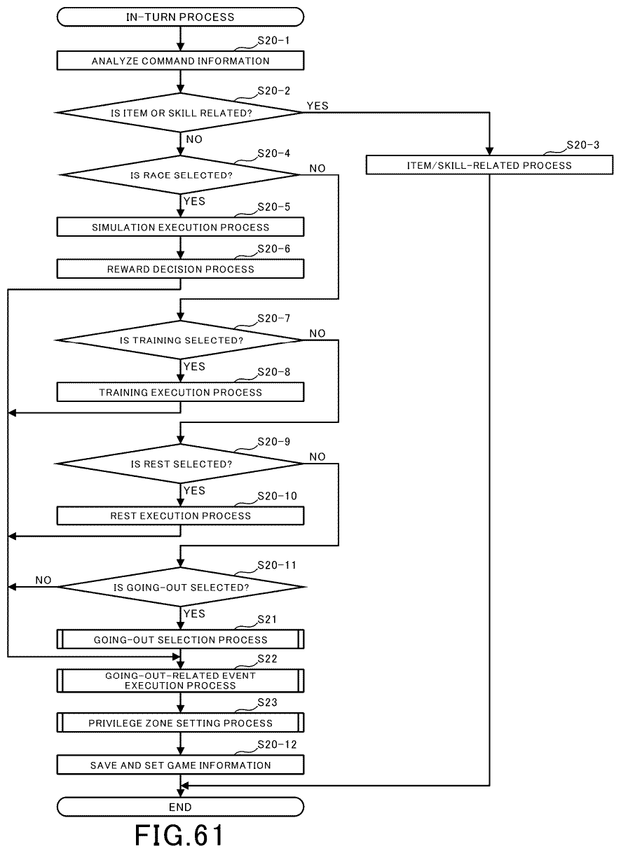

FIG. 61 is a flowchart for illustrating the in-turn process at the server 1000. The in-turn process (S20) in the server 1000 is started when the turn-at-start process (P10) is executed in the player terminal 1 and command information is transmitted in P10-5.

The nurturing game execution unit 1102a analyzes the transmitted command information (S20-1). In the case where command information concerning earning of an item or a skill is received (YES in S20-2), the nurturing game execution unit 1102a executes an item/skill-related process for allowing an item or a skill to be earned (S20-3).

In addition, in the case where command information concerning execution of a race is received (YES in S20-4), the nurturing game execution unit 1102a derives a race result through a simulation execution process (S20-5) and decides a reward (S20-6).

Furthermore, in the case where command information indicating any of the training courses is received (YES in S20-7), the nurturing game execution unit 1102a executes a training execution process (S20-8). Here, whether training has failed or succeeded is decided, and ability parameters are updated. Here, in the case where a support card is tied to the executed training, a process for updating the value of the bond gauge is also executed.

In addition, in the case where command information indicating the rest operation section 215 is received (YES in S20-9), the nurturing game execution unit 1102a executes a rest execution process (S20-10). Here, an increase value of the physical strength is decided, and the decided increase value is added to the current physical strength.

Also, in the case where going-out is selected, i.e., in the case where command information indicating the nurturing-target-character selection operation section 256a, a support character selection operation section 256b, the first belonging character selection operation section 258a to the fifth belonging character selection operation section 258e, or the all-belonging-character selection operation section 259 is received (YES in S20-11), the nurturing game execution unit 1102a executes a going-out selection process (S21).

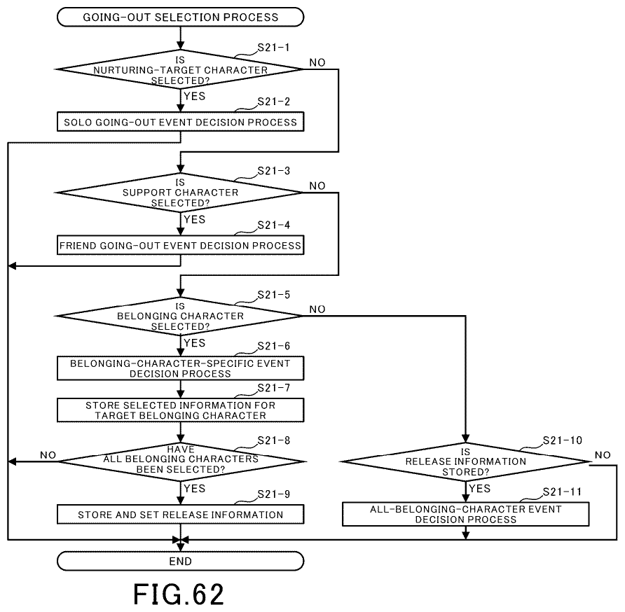

FIG. 62 is a flowchart for illustrating the going-out selection process at the server 1000. In the case where command information indicating the nurturing-target-character selection operation section 256a is received (YES in S21-1), the nurturing game execution unit 1102a executes a solo going-out event decision process (S21-2). Here, an execution pattern of solo going-out event is decided. Also, parameters are updated on the basis of the decided execution pattern.

In the case where command information indicating a support character selection operation section 256b is received (YES in S21-3), the nurturing game execution unit 1102a executes a friend going-out event decision process (S21-4). Here, an execution pattern of friend going-out event is decided. In addition, parameters are updated on the basis of the decided execution pattern.

Furthermore, in the case where any of the belonging characters is selected (YES in S21-5), the nurturing game execution unit 1102a decides an execution pattern of belonging-character-specific event (S21-6). Here, parameters are updated on the basis of the decided execution pattern.

Also, the nurturing game execution unit 1102a stores selected information for the belonging character selected by the player (S21-7). Then, in the case where selected information is stored for all the belonging characters tied to the group support card (YES in S21-8), the nurturing game execution unit 1102a stores and sets release information indicating the release of the all-belonging-character selection operation section 259 (S21-9).

Furthermore, in the case where the all-belonging-character selection operation section 259 is selected (NO in S21-5) and the release information is stored (YES in S21-10), the nurturing game execution unit 1102a decides an execution pattern of all-belonging-character event (S21-11). Here, parameters are updated on the basis of the decided execution pattern. Here, the first time the all-belonging-character event is decided, a process for granting a possessed skill is executed.

Referring back to FIG. 61, in the case where a process involving ending of a turn is executed, a going-out-related event execution process (S22) is executed.

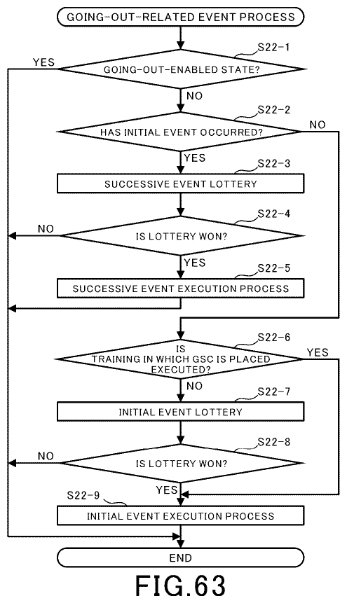

FIG. 63 is a flowchart for illustrating the going-out-related event execution process at the server 1000. In the case where the going-out-enabled state is not set (NO in S22-1) and an initial event has occurred (YES in S22-2), the nurturing game execution unit 1102a draws a successive event lottery (S22-3). Here, the winning probability of a successive event lottery is set on the basis of the current value of the bond gauge of the group support card. When the successive event lottery is won (YES in S22-4), the nurturing game execution unit 1102a executes a successive event execution process for executing a successive event (S22-5).

By doing so, a successive event is executed at the player terminal 1. Although descriptions of specific processes are omitted, when a predetermined choice is selected by the player at the player terminal 1 in the case where a successive event is executed, the going-out-enabled state is set in the player terminal 1 and the server 1000.

In addition, in the case where no initial event has occurred (NO in S22-2), the nurturing game execution unit 1102a determines whether or not the training in which the group support card is placed has been executed in S20-8 (S22-6). In the case where the training in which the group support card is placed is executed (YES in S22-6), the nurturing game execution unit 1102a executes an initial event execution process for executing an initial event (S22-9). By doing so, an initial event is executed at the player terminal 1.

Furthermore, in the case where the training in which the group support card is placed is not executed (NO in S22-6), the nurturing game execution unit 1102a draws an initial event lottery (S22-7). In the case where the initial event lottery is won (YES in S22-8), the nurturing game execution unit 1102a executes the initial event execution process (S22-9).

Referring back to FIG. 61, the nurturing game execution unit 1102a executes a privilege zone setting process (S23) subsequently to the going-out-related event execution process.

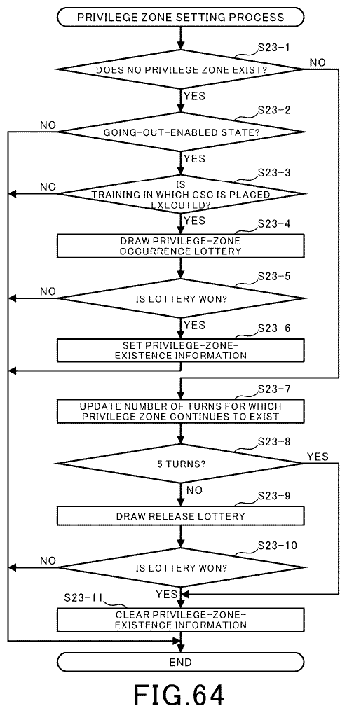

FIG. 64 is a flowchart for illustrating the privilege zone setting process at the server 1000. In the case where no privilege zone exists (YES in S23-1), the going-out-enabled state is set (YES in S23-2), and training in which a group support card is placed is executed (YES in S23-3), the nurturing game execution unit 1102a draws a privilege-zone occurrence lottery (S23-4). When the privilege-zone occurrence lottery is won (YES in S23-5), the nurturing game execution unit 1102a sets privilege-zone-existence information indicating that a privilege zone exists (S23-6). Note that the privilege-zone-existence information may be tied to any of the nurturing game, the nurturing-target character, and the group support card.

Furthermore, if a privilege zone exists (NO in S23-1), the nurturing game execution unit 1102a updates the number of turns for which the privilege zone continues to exist (S23-7). Here, the number of turns that have been processed after the occurrence of the privilege zone is counted. If the number of turns for which the privilege zone continues to exist is five (YES in S23-8), the nurturing game execution unit 1102a clears the privilege-zone-existence information (S23-11). By doing so, the privilege zone is released, i.e., ends.

Also, if the number of turns for which the privilege zone continues to exist is not five (NO in S23-8), the nurturing game execution unit 1102a draws a release lottery (S23-9). In the case where the release lottery is won (YES in S23-10), the nurturing game execution unit 1102a clears the privilege-zone-existence information (S23-11).

Referring back to FIG. 61, the nurturing game execution unit 1102a saves game information on the basis of the result of each of the aforementioned processes in the in-turn process (S20) and causes the player terminal 1 to receive the game information.

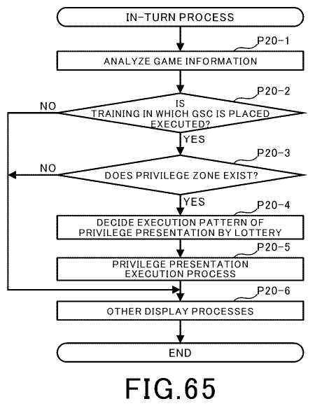

FIG. 65 is a flowchart for illustrating the in-turn process at the player terminal 1. The in-turn process (P20) in the player terminal 1 is started when the in-turn process (S20) is executed in the server 1000 and game information is set in S20-12. The nurturing game execution unit 702a analyzes the received game information (P20-1). Then, if training in which a group support card is placed is executed (YES in P20-2) and a privilege zone exists (YES in P20-3), the execution pattern of privilege presentation is decided by lottery (P20-4).

Also, the nurturing game execution unit 702a executes a privilege presentation in the execution pattern decided in P20-4 (P20-5). In addition, the nurturing game execution unit 702a displays various kinds of game screens, such as the event screen, on the basis of the result of analysis in P20-1 (P20-6). Here, in the case where execution patterns of various kinds of events are decided in the server 1000, the nurturing game execution unit 702a causes events to occur in the decided execution patterns.

The aforementioned nurturing game is realized through the aforementioned processes. Note that the aforementioned processes in the player terminal 1 and server 1000 are nothing more than an example. Furthermore, each of the aforementioned processes may be executed only in the player terminal 1 or may be executed only in the server 1000.

Referring back to FIG. 51, when the nurturing game ends, the nurturing game end processing unit 1103a executes a nurturing game end process (S8) in the server 1000.

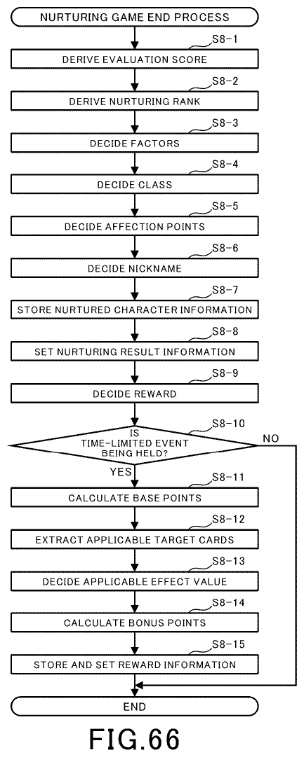

FIG. 66 is a flowchart for illustrating the nurturing game end process (S8) at the server 1000. The nurturing game end processing unit 1103a derives an evaluation score on the basis of the end information received from the player terminal 1 (S8-1). In addition, the nurturing game end processing unit 1103a derives a nurturing rank on the basis of the derived evaluation score (S8-2).

Furthermore, the nurturing game end processing unit 1103a decides factors to be earned by the nurtured character (S8-3). Also, the nurturing game end processing unit 1103a decides a class on the basis of the number of earned fans (S8-4). In addition, the nurturing game end processing unit 1103a decides affection points on the basis of a predetermined parameter, such as the nurturing rank or the number of fans (S8-5). Although not described in detail, affection points are points granted not to the nurtured character but to a character on which the nurtured character is based.

The story screen described above is provided in a plurality for each character, and a release condition is set for some of the story screens. There are some story screens in which affection points are set as a release condition therefor, so that the player is allowed to view such story screens when the affection points reach a threshold value.

In addition, the nurturing game end processing unit 1103a decides a nickname (S8-6). Here, conditions achieved in the nurturing main game are confirmed, and a nickname to be earned by the nurtured character is decided. Furthermore, the nurturing game end processing unit 1103a stores, in the game information storage section 1151, nurtured character information including the evaluation score, the nurturing rank, the ability parameters, the aptitude parameters, the earned skills, the inheritance information, the factor information, the class, the nickname, etc. so as to be tied to the player ID of the player (S8-7). Also, the nurturing game end processing unit 1103a sets nurturing result information, and causes the player terminal 1 to receive the nurturing result information (S8-8).

In addition, the nurturing game end processing unit 1103a decides a reward on the basis of the nurtured character information (S8-9). Then, if a time-limited event is being held (YES in S8-10), the nurturing game end processing unit 1103a calculates base points of event points on the basis of the nurtured character information (S8-11). Furthermore, the nurturing game end processing unit 1103a extracts applicable target cards (S8-12) and decides an applicable effect value (S8-13).

Note that extraction of applicable target cards and decision of an applicable effect value may be performed in the same manner as in P50-2 to P50-8. Alternatively, an applicable effect value may be decided by receiving the bonus information saved in P50-9 from the player terminal 1. Then, the nurturing game end processing unit 1103a calculates bonus points on the basis of the applicable effect value (S8-14). Thereafter, the nurturing game end processing unit 1103a stores reward information including the reward decided in S8-9, the base points calculated in S8-11, and the bonus points calculated in S8-14 and sets the reward information so that the player terminal 1 receives it (S8-15).

Referring back to FIG. 51, upon receiving the nurturing result information and the reward information, the nurturing-at-completion processing unit 703a executes the nurturing game end process (P8). Here, the nurturing-at-completion processing unit 703a stores the received nurturing result information and reward information in the game information storage section 751. Furthermore, the nurturing-at-completion processing unit 703a displays the nurturing completion screen 340 on the display 26 on the basis of the nurturing result information and reward information.

Although an aspect of an embodiment has been described with reference to the accompanying drawings, it goes without saying that the present invention is not limited to the aforementioned embodiment. It would be obvious that a person skilled in the art could conceive of various modifications and amendments within the scope recited in the claims, and it will be understood that those modifications and amendments obviously belong to the technical scope.

The gameplay and the processes in the player terminal 1 and the server 1000 described in the aforementioned embodiment are merely examples. In any case, an information processing program is acceptable if it causes a computer (at least one of the player terminal 1 and server 1000 in the embodiment) to execute the following processes.

### (Processes Executed by Computer)

A process for tying possession information to game media (e.g., character card and support card in the embodiment) that satisfy a possession condition set in advance (being distributed by the game administrator and being won in a gacha lottery in the embodiment) among game media for use in a predetermined game (e.g., nurturing game in the embodiment) (e.g., S2 and P3 in the embodiment).

A process for executing a target game (e.g., nurturing game in the embodiment) in which any of the game media are set as specific game media (e.g., character card and support card to which a character ID having special effectiveness information set therefor is tied in the embodiment) (e.g., P6, P7, S6, and S7 in the embodiment).

A process for extracting, as target game media, the game media that are set as the specific game media in the target game and to which the possession information is tied (e.g., P50-2 to P50-7 and S8-12 in the embodiment).

A process for deciding an applicable effect value on the basis of the extracted target game media (e.g., P50-8 and S8-13 in the embodiment).

A process for granting a reward to the player on the basis of the applicable effect value when the target game is executed (e.g., S8-15 in the embodiment).

Note that the aforementioned embodiment has been described by way of an example where the predetermined game that uses game media (character card and support card) and the target game in which specific game media are set are same. It should be noted, however, that the predetermined game and the target game may be games different from each other. For example, the predetermined game may be the aforementioned nurturing game that uses a character card and a support card, and the target game may be a team competition game that uses a nurtured character.

In addition, in the aforementioned embodiment, the target game is the predetermined game that uses game media, and the game media are classified as any one of a plurality of types including a first type (character card) and a second type (support card). Also, the process for executing a target game (e.g., process for executing the nurturing game in the embodiment) includes: a process for setting, on the basis of a player operation, game media of the first type and the second type used in the target game (e.g., preparatory-stage process in the embodiment); and a process for proceeding with the target game on the basis of the set game media of the first type and second type (e.g., nurturing-stage process in the embodiment).

It should be noted, however, that the type of the game media used in the predetermined game may be, for example, either one of the character card and the support card. In addition, specific content and the game genre of the predetermined game are not limited to those in the aforementioned embodiment. The predetermined game may be any game that is played by using game media possessed by the player, and the number of types, etc., of the game media is not particularly limited.

Furthermore, in the process for deciding an applicable effect value, an effect value is identified for each of the target game media (e.g., special effectiveness characters in the embodiment), and the applicable effect value is decided on the basis of the effect value identified for each of the target game media. It should be noted, however, that the method for deciding an applicable effect value is not limited to this.

For example, although the aforementioned embodiment has been described by way of an example where only the maximum effect value is applicable to one special effectiveness character, all cards corresponding to the special effectiveness characters may be decided to be applicable target cards. In this case, an applicable effect value may be calculated by summing the effect values of all possessed applicable target cards. In addition, for example, a plurality of applicable target cards may be decided for one special effectiveness character. In any case, the condition for deciding an applicable target card for one special effectiveness character and the number of applicable target cards decided for one special effectiveness character are not particularly limited.

Furthermore, instead of an applicable target card being decided for each of the special effectiveness characters, all cards corresponding to the special effectiveness characters may be extracted as candidates for applicable target cards, and a predetermined number of cards with large effect values among the extracted candidates may be decided to be applicable target cards. Also, for example, a predetermined number of applicable target cards may be decided separately for the character card and the support card.

Also, the aforementioned embodiment has been described by way of an example where the effect values set for the applicable target cards are summed to calculate a final applicable effect value. It should be noted, however, that the method for calculating an applicable effect value is not limited to this. For example, the effect values set for the applicable target cards may be input into a predetermined calculation expression to calculate an applicable effect value.

In addition, the aforementioned embodiment has been described by way of an example where the same effect value is set for a plurality of special effectiveness characters tied to one group support card. It should be noted, however, that different effect values may be set for a plurality of special effectiveness characters tied to one group support card.

Also, the aforementioned embodiment has been described by way of an example where event points are granted as a reward. It should be noted, however, that the content of a reward is not particularly limited, and, for example, an item that can be used in the game may be granted as a reward. In this case, the number of granted items or the content of a granted item may differ depending on, for example, the calculated applicable effect value.

In addition, the aforementioned embodiment has been described by way of an example where bonus points are calculated by multiplying base points by an applicable effect value. It should be noted, however, that an applicable effect value may be, for example, points, so that the applicable effect value itself may be granted to the player as points.

Also, although the aforementioned embodiment has been described by way of an example where an event bonus is granted only while a time-limited event is being held, the aforementioned time-limited event does not need to be provided with a particular time period. For example, in the case where a scenario in which an event bonus is granted is selected, an event bonus may be always granted.

In addition, the aforementioned embodiment has been described by way of an example where event points are always granted in the case where a nurturing game is played while a time-limited event is being held. It should be noted, however, that the player may be allowed to set an event point function to on/off. In this case, event points are granted only in the case where a nurturing game is started in a state in which the event point function is set to on. This assures the player of a degree of freedom.

Note that the information processing program for executing the processes in the aforementioned embodiment and various modifications may be stored in a computer-readable, non-transitory storage medium and may be provided as a storage medium. Furthermore, it is also acceptable to provide a game terminal device including this storage medium. In addition, the aforementioned embodiment and various modifications may also be an information processing method that realizes each of the functions and the steps shown in the flowcharts.

What is claimed is:

1. A non-transitory computer readable medium storing a program causing a computer to execute:
a process for tying possession information to a game medium that satisfies a possession condition set in advance, among at least one game medium for use in a predetermined game;
a process for executing a target game in which any of the at least one game medium is set as a specific game medium;
a process for extracting, as at least one target game medium, a game medium that is set as the specific game medium in the target game and to which the possession information is tied;
a process for deciding an applicable effect value on the basis of the at least one extracted target game medium; and
a process for granting a reward to a player on the basis of the applicable effect value when the target game is executed.

2. The non-transitory computer readable medium according to claim 1,
wherein, in the process for deciding an applicable effect value, an effect value is identified for each of the at least one target game medium, and the applicable effect value is decided on the basis of the effect value identified for each of the at least one target game medium.

3. The non-transitory computer readable medium according to claim 1,
wherein the target game is the predetermined game that uses the at least one game medium,
the at least one game medium is classified as any one of a plurality of types including a first type and a second type, and
the process for executing the target game includes:
a process for setting, on the basis of a player operation, a game medium of each of the first type and the second type used in the target game; and
a process for proceeding with the target game on the basis of the set game medium of each of the first type and the second type.

4. An information processing method executed by at least one computer, the at least one computer executes:
a process for tying possession information to a game medium that satisfies a possession condition set in advance, among at least one game medium for use in a predetermined game;
a process for executing a target game in which any of the at least one game medium is set as a specific game medium;
a process for extracting, as at least one target game medium, a game medium that is set as the specific game medium in the target game and to which the possession information is tied;
a process for deciding an applicable effect value on the basis of the at least one extracted target game medium; and
a process for granting a reward to a player on the basis of the applicable effect value when the target game is executed.

5. An information processing system comprising at least one computer that executes:
a process for tying possession information to a game medium that satisfies a possession condition set in advance, among at least one game medium for use in a predetermined game;
a process for executing a target game in which any of the at least one game medium is set as a specific game medium;
a process for extracting, as at least one target game medium, a game medium that is set as the specific game medium in the target game and to which the possession information is tied;
a process for deciding an applicable effect value on the basis of the at least one extracted target game medium; and
a process for granting a reward to a player on the basis of the applicable effect value when the target game is executed.
